(19) United States
(12) Patent Application Publication
(10) Pub. No.: US 2003/0235794 A1
(43) Pub. Date: Dec. 25, 2003

(54) Photothermographic material

(76) Inventor: Yasuhiro Yoshioka, Kanagawa (JP)

Correspondence Address: Sheldon J. Moss, c/o Yumi Yerks, 2111 Jefferson Davis Highway, Apartment #412-North, Arlington, VA, 22202, US

(21) Appl. No.: 10/456,629

(22) Filed: Jun. 9, 2003

(30) Foreign Application Priority Data
Jun. 12, 2002 (JP) 2002-171912

(51) Int. Cl. G03C 1/035; G03C 1/498

(52) U.S. Cl. 430/566; 430/619; 430/568

(57) ABSTRACT

A photothermographic material containing a photosensitive silver halide, a non-photosensitive organic silver salt, a reducing agent for thermal development, and a binder, and further includiing a fluorine compound containing a fluoroalkyl group having 2 or more carbon atoms and 13 or less fluorine atoms. The material is characterized in that the photosensitive silver halide contains silver iodide within a range of 40 mol % to 100 mol %.

### CROSS-REFERENCE TO RELATED APPLICATION

This application claims priority under 35USC 119 from Japanese Patent Application No. 2002-171912, the disclosure of which is incorporated by reference herein.

### BACKGROUND OF THE PRESENT INVENTION

1. Field of the Present Invention

The present invention relates to a photothermographic material and more particularly, to a photothermographic material reduced in the variations of photographic performance depending upon the storage conditions or the environment of use thereof.

2. Description of the Related Art

The recent years have seen a strong demand from the medical field for the reduction of waste processing solutions from the standpoint of environmental protection and space savings. This has created the need for technologies related to a photosensitive photothermographic material for medical diagnostic and photographic uses, the photothermographic material adapted for efficient light exposure by a laser image setter or laser imager and for the formation of a clear black image featuring a high resolution and sharpness. Such a photosensitive photothermographic material can provide users with a more simple and non-polluting thermal development system eliminating the use of solution type processing chemicals.

While a similar demand has been placed on the field of general image forming materials, a medical image must be a high-quality image having high sharpness and granularity in order to meet a demand for fine depiction. In addition, the preference in the medical image is toward a cold black tone image facilitating the medical diagnosis. At present, a variety of hard copy systems utilizing pigments or dyes, such as inkjet printers and electrophotographic machines, have become widespread as common image forming systems, but none of those systems can serve as a satisfactory output system for medical images.

On the other hand, photothermographic image forming systems using an organic silver salt have been known in, for example, U.S. Pat. Nos. 3,152,904 and 3,457,075; and “Thermally Processed Silver Systems” by D. Klosterboer, Imaging Processes and Materials, Neblette's 8th ed., edited by J. Sturge, V. Walworth and A. Shepp, Chapter 9, page 279 (1989). A photothermographic material, in particular, generally has an image formation layer comprising a catalytic amount of photocatalyst (e.g., silver halide), a reducing agent, a reducible silver salt (e.g., organic silver salt), and, as required, a color toning agent for controlling a color tone of silver image, all of which are dispersed in a binder matrix. The photothermographic material produces a black silver image as follows. After an imagewise exposure to light, the photothermographic material is heated to a high temperature (e.g., at least 80° C.) for effecting a redox reaction between the silver halide or reducible silver salt and the reducing agent for image formation. The redox reaction is accelerated by a catalytic action of a latent image of the silver halide developed by the light exposure. Therefore, the black silver image is formed in an exposed area of the material. Fuji Medical Dry Imager FM-DPL has been marketed as a medical image forming system which uses the photothermographic material and is disclosed in numbers of literatures including U.S. Pat. No. 2,910,377, JP-B No. 43-4924 and the like.

The photothermographic image forming system utilizing the organic silver salt may be produced by a method wherein a coating solution containing a solution of a polymer as a main binder in an organic solvent is applied and dried; or a method wherein a coating solution containing an aqueous dispersion of polymer fine particles as the main binder is applied and dried. The latter method obviates a step of recovering the solvent and hence, a production facilities for such a material are simple and advantageously suited for mass production.

By virtue of the above features, the photothermographic material is favorably accepted by the market and now finding a wider area of applications and an increasing number of uses.

Unfortunately, the image forming system based on the organic silver salt does not include a fixing step and hence, the resultant image suffers a serious deterioration of post-development image storability or in particular, the serious deterioration of the image storability as subjected to light (hereinafter, the image storability as subjected to light may sometimes be referred to as “printout”). As an approach to improve the printout, a method is disclosed in U.S. Pat. No. 6,143,488 and EP-A No. 0922995 wherein silver iodide obtained by converting the organic silver salt is used. Although a photothermographic material containing silver iodide is markedly improved in the post-development performances, such as printout, by the use of silver iodide, such a photothermographic material in an undeveloped state is susceptible to sensitivity variations when subjected to high humidity. Thus, the improvement in the storage stability in the high humidity environment has been desired.

### SUMMARY OF THE PRESENT INVENTION

It is therefore an object of the present invention is to reduce the variations of the photographic performances of the photothermographic material used in the high humidity/high temperature environment and to provide a photothermographic material reduced in the photographic performance variations.

The object of the present invention is achieved by the following photothermographic material.

A first aspect of the present invention is to provide a photothermographic material comprising a photosensitive silver halide, a non-photosensitive organic silver salt, a reducing agent for thermal development, and a binder, and further comprising a fluorine compound containing a fluoroalkyl group having 2 or more carbon atoms and 13 or less fluorine atoms,

wherein the photosensitive silver halide contains silver iodide within a range of 40 mol % to 100 mol %.

A second aspect of the present invention is to provide a photothermographic material comprising a photosensitive silver halide, a non-photosensitive organic silver salt, a reducing agent for thermal development, and a binder, and further comprising a fluorine compound containing a fluoroalkyl group having 2 or more carbon atoms and 12 or less fluorine atoms,

wherein the photosensitive silver halide contains silver iodide within a range of 40 mol % to 100 mol %.

### DETAILED DESCRIPTION OF THE PRESENT INVENTION

The photothermographic material of the present invention comprises a photosensitive silver halide, a non-photosensitive organic silver salt, a reducing agent for thermal development, and a binder, the material further comprises a fluorine compound containing a fluoroalkyl group having 2 or more carbon atoms and 13 or less fluorine atoms, and the photosensitive silver halide contains silver iodide within a range of 40 mol % to 100 mol %.

As other aspects of the present invention, third to twenty-ninth aspects thereof are described below.

A third aspect of the present invention is a photothermographic material according to the second aspect, wherein the fluoroalkyl group of the fluorine compound is represented by the following formula (A):

—Rc—Re—W Formula (A)

wherein Rc represents an alkylene group having 1 to 4 carbon atoms; Re represents a perfluoroalkylene group having 2 to 6 carbon atoms; and W represents a hydrogen atom, a fluorine atom or an alkyl group.

A fourth aspect of the present invention is a photothermographic material according to the third aspect, wherein the fluorine compound contains 2 or more fluoroalkyl groups represented by formula (A).

A fifth aspect of the present invention is a photothermographic material according to the second aspect, wherein the fluorine compound has a cationic hydrophilic group.

A sixth aspect of the present invention is a photothermographic material according to the second aspect, wherein the fluorine compound has an anionic hydrophilic group.

A seventh aspect of the present invention is a photothermographic material according to the second aspect, wherein the fluorine compound has a nonionic hydrophilic group.

A eighth aspect of the present invention is a photothermographic material according to the second aspect, wherein the reducing agent is a bisphenol-based reducing agent.

A ninth aspect of the present invention is a photothermographic material according to the second aspect, further comprising a compound represented by the following formula (D):

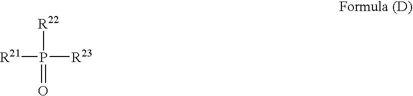

wherein R²¹ to R²³ each independently represent an alkyl group, an aryl group, an alkoxy group, an aryloxy group, an amino group or a heterocyclic group.

A tenth aspect of the present invention is a photothermographic material according to the second aspect, further comprising a compound represented by the following formula (B):

Q—(Y)n—C(Z₁)(Z₂)X Formula (B)

wherein Q represents an alkyl group, an aryl group or a heterocyclic group; Y represents a bivalent coupling group; n represents 0 or 1; Z¹ and Z² each represent a halogen atom; and X represents a hydrogen atom or an electron-attracting group.

A eleventh aspect of the present invention is a photothermographic material according to the second aspect, further comprising a hydrazine-based or naphthol-based development accelerator.

A twelfth aspect of the present invention is a photothermographic material according to the second aspect, wherein the non-photosensitive organic silver salt includes 40 mol % to 99 mol % of silver behenate.

A thirteenth aspect of the present invention is a photothermographic material according to the second aspect of the present invention comprises the non-photosensitive organic silver salt containing silver behenate within a range of 55 mol % to 80 mol %.

A fourteenth aspect of the present invention is a photothermographic material according to the third aspect, wherein the fluorine compound is a compound represented by the following formula (1):

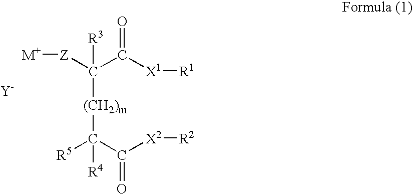

wherein R¹ and R² each independently represent an alkyl group; at least one of R¹ and R² is a fluoroalkyl group having 2 or more carbon atoms and 12 or less fluorine atoms or a fluoroalkyl group represented by formula (A); R³, R⁴ and R⁵ each independently represent a hydrogen atom or a substituent; X¹, X² and Z each independently represent a bivalent coupling group or a single bond; M⁺ represents a cationic substituent; Y⁻ represents a counter anion; and m represents 0 or 1.

A fifteenth aspect of the present invention is a photothermographic material according to the third aspect, wherein the fluorine compound is a compound represented by the following formula (1-a):

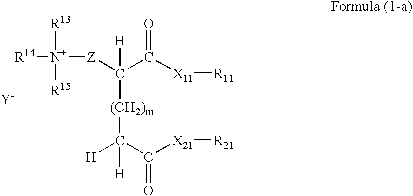

wherein R¹¹ and R¹² each independently represent an alkyl group; at least one of R¹¹ and R¹² is a fluoroalkyl group having 2 or more carbon atoms and 12 or less fluorine atoms or a fluoroalkyl group represented by formula (A); a total number of carbon atoms in R¹¹ and R²¹ is 19 or less; R¹³, R¹⁴ and R¹⁵ each independently represent an alkyl group; X¹¹ and X²¹ each independently represent —O—, —S—, or —NR³¹ — in which R³¹ represents a hydrogen atom or a substituent; Z represents a bivalent coupling group or a single bond; Y⁻ represents a counter anion; and m represents 0 or 1.

A sixteenth aspect of the present invention is a photothermographic material according to the third aspect, wherein the fluorine compound is a compound represented by the following formula (3):

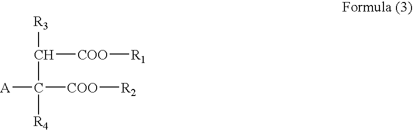

wherein R¹ and R² each independently represent an alkyl group; at least one of R¹ and R² is a fluoroalkyl group having 2 or more carbon atoms and 12 or less fluorine atoms or a fluoroalkyl group represented by the formula (A); R³ and R⁴ each independently represent a hydrogen atom or an alkyl group; and A represents —L^{b}—SO³M in which M represents a hydrogen atom or a cation and L^{b} represents a single bond or an alkylene group.

A seventeenth aspect of the present invention is a photothermographic material according to the third aspect, wherein the fluorine compound is a compound represented by the following formula (4):

Rf—X((CH²)ⁿ—)O^{m}R Formula (4)

wherein Rf represents a fluoroalkyl group having 2 or more carbon atoms and 12 or less fluorine atoms or a fluoroalkyl group represented by formula (A); n represents 2 or 3; m represents 1 to 30; X represents a bivalent coupling group; R represents a hydrogen atom, an aryl group, a heterocyclic group, Rf, or a group having 1 or more of Rf as a substituent.

A eighteenth aspect of the present invention is a photothermographic material according to the second aspect, wherein the photosensitive silver halide is chemically sensitized by at least one selected from the group consisting of chalcogen sensitization, gold sensitization and reduction sensitization.

A nineteenth aspect of the present invention is a photothermographic material according to the eighteenth mode of the invention comprises the photosensitive silver halide chemically sensitized at pAg of 7 or less.

A twentieth aspect of the present invention is a photothermographic material according to the seventeenth aspect, wherein the chalcogen sensitization includes at least one selected from the group consisting of tellurium sensitization, selenium sensitization and sulfur sensitization.

A twenty-first aspect of the present invention is a photothermographic material according to the second aspect, wherein the photosensitive silver halide contains silver iodide within a range of 80 mol % to 100 mol %.

A twenty-second aspect of the present invention is a photothermographic material according to the second aspect, wherein particles of the photosensitive silver halide have an epitaxially grown portion.

A twenty-third aspect of the present invention is a photothermographic material according to the second aspect, wherein the particles of the photosensitive silver halide include a dislocation line or a lattice defect.

A twenty-fourth aspect of the present invention is a photothermographic material according to the second aspect, wherein a particle size of the photosensitive silver halide is 5 nm to 70 nm.

A twenty-fifth aspect of the present invention is a photothermographic material according to the second aspect, wherein a coating amount of the photosensitive silver halide is within a range of 0.5 mol % to 10 mol % per mol of the non-photosensitive organic silver salt.

A twenty-sixth aspect of the present invention is a photothermographic material according to the second aspect, wherein the particles of the photosensitive silver halide are formed in the absence of the organic silver salt.

A twenty-seventh aspect of the present invention is a photothermographic material according to the second aspect, wherein laser light is used as a light exposure source for image formation.

A twenty-eighth aspect of the present invention is a photothermographic material according to the the twenty-seventh aspect, wherein the laser light has a peak wavelength of 600 nm to 900 nm.

A twenty-ninth aspect of the present invention is a photothermographic material according to the twenty-seventh aspect, wherein the laser light has a peak wavelength of 300 nm to 500 nm.

The details of components, compositions and image forming method of the present invention will hereinbelow be described.

### 1. Description of Fluorine Compound

The photothermographic material of the present invention contains the fluorine compound having at least one fluoroalkyl group having 2 or more carbon atoms and 13 or less fluorine atoms. The fluorine compound according to the present invention may be used as a surfactant.

The fluorine compound used by the present invention may have any structure so long as the compound contains the aforesaid fluoroalkyl group (hereinafter, an alkyl group substituted with a fluorine atom will be referred to as “Rf”). The fluorine compound only needs to have at least one Rf or may have 2 or more Rfs.

Specific examples of the Rf include but are not limited to the following groups:

—C₂F₅, —C₃F₇, —C₄F₉, —C₅F₁₁, —CH₂—C₄F₉, —C₄ F₈—H, —C₂H₄—C₄F₉, —C₄H₈—C₄F₉, —C₆H₁₂—C₄F₉, —C₈H₁₆—C₄F₉, —C₄H₈—C₂F₅, —C₄H₈—C₃F₇, —C₄H₈—C₅F₁₁, —C₈H₁₆—C₂F₅, —C₂H₄—C₄F₈—H, —C₄H₈—C₄F₈—H, —C₆H₁₂—C₄F₈—H, —C₆H₁₂—C₂F₄—H, —C₈H₁₆—C₂F₄—H, —C₆H₁₂—C₄F₈—CH₃, —C₂H₄—C₃F₇, —C₂H₄—C₅F₁₁, —C₄H₈—CF(CF₃)₂, —CH₂—CF₃, —C₄H₈—CH(C₂F₅)₂, —C₄H₈—CH(CF₃)₂, —C₄H₈—C(CF₃)₃, —CH₂—C₄F₈—H, —CH₂—C₆F₁₂—H, —CH₂—C₆F₁₃, —C₂H₄—C₆F₁₃, —C₄H₈—C₆F₁₃, —C₆H₁₂—C₆F₁₃, and —C₈H₁₀—C₆F₁₃.

The Rf having 13 or less fluorine atoms may preferably have 12 or less fluorine atoms or more preferably 3 to 11 fluorine atoms or particularly preferably 5 to 9 fluorine atoms. The Rf having 2 or more carbon atoms may preferably have 4 to 16 carbon atoms or more preferably 5 to 12 carbon atoms.

Although the Rf is not particularly limited in the structure so long as it contains 2 or more carbon atoms and 13 or less fluorine atoms, the Rf may preferably be a group represented by the following formula (A):

—Rc—Re—W Formula (A)

The fluorine compound according to the present invention may more preferably have 2 or more fluoroalkyl groups represented by the formula (A).

In the formula (A), Rc represents an alkylene group having 1 to 4 carbon atoms, preferably having 1 to 3 carbon atoms or more preferably having 1 to 2 carbon atoms. The alkylene group represented by Rc may be a linear group or a branched group.

Re represents a perfluoroalkylene group having 2 to 6 carbon atoms or preferably having 2 to 4 carbon atoms. The perfluoroalkylene group herein means an alkylene group having all the hydrogen atoms thereof substituted with fluorine atoms. The aforesaid perfluoroalkylene group may be a linear group or a branched group, or may have a cyclic structure.

W represents a hydrogen atom, a fluorine atom or an alkyl group. W preferably represents a hydrogen atom or a fluorine atom, or particularly preferably a fluorine atom.

The fluorine compound according to the present invention may have a cationic hydrophilic group.

The cationic hydrophilic group becomes cationic when dissolved in water. Specific examples of the cationic hydrophilic group include quaternary ammonium, alkylpyridium, alkylimidazolium, primary to tertiary aliphatic amines and the like.

A preferred cation is an organic cationic substituent. However, an organic cationic group containing a nitrogen or phosphorus atom is more preferred. A pyridinium cation or ammonium cation is still more preferred.

An anionic seed for salt formation may be inorganic or organic. Preferred examples of the inorganic anion include an iodine ion, a bromine ion, a chlorine ion and the like. Examples of a preferred organic anion include a p-toluensulfonic acid ion, a benzenesulfonic acid ion, a methanesulfonic acid ion, a trifluoromethanesulfonic acid ion and the like.

A preferred cationic fluorine compound according to the present invention is represented by the following formula (1):

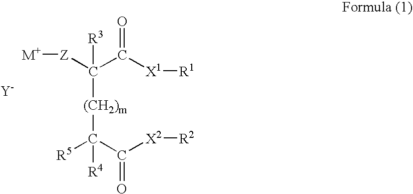

wherein R¹ and R² each independently represent a substituted or unsubstituted alkyl group, provided that at least one of R¹ and R² is the aforesaid fluoroalkyl group (Rf) or that both R¹ and R² are preferably Rfs; R³, R⁴ and R⁵ each independently represent a hydrogen atom or a substituent; X¹, X² and Z each independently represent a bivalent coupling group or a single bond; M⁺ represents a cationic substituent; Y⁻ represents a counter anion, provided that Y⁻ may be absent when the counter anion has no overall charge within the molecule; and m represents 0 or 1.

In a case where R¹ and R² in the formula (1) each independently represent a substituted or unsubstituted alkyl group other than Rf, the alkyl group may be any one of linear, branched and cyclic alkyl groups having 1 or more carbon atom. Examples of the substituent include a halogen atom, an alkenyl group, an aryl group, an alkoxy group, a halogen atom other than fluorine, a carboxylate group, a carbonamido group, a carbamoyl group, an oxycarbonyl group, a phosphate group and the like.

Where R¹ and R² represent an alkyl group other than Rf, or an alkyl group not substituted with a fluorine atom, the alkyl group includes a substituted or unsubstituted alkyl group having 1 to 24 carbon atoms, or more preferably a substituted or unsubstituted alkyl group having 6 to 24 carbon atoms. Preferred examples of the unsubstituted alkyl group having 6 to 24 carbon atoms include an n-hexyl group, an n-heptyl group, an n-octyl group, a tert-octyl group, a 2-ethylhexyl group, an n-nonyl group, 1,1,3-trimethylhexyl group, an n-decyl group, an n-dodecyl group, a cetyl group, a hexadecyl group, a 2-hexyldecyl group, an octadecyl group, an eicosyl group, a 2-octyldodecyl group, a docosyl group, a tetracosyl group, 2-decyltetradecyl group, a tricosyl group, a cyclohexyl group, a cycloheptyl group and the like. Preferred examples of the alkyl group having a substituent and 6 to 24 total carbon atoms include a 2-hexenyl group, an oleyl group, a linoleyl group, a linolenyl group, a benzyl group, a β-phenethyl group, a 2-methoxyethyl group, a 4-phenylbutyl group, a 4-acetoxyethyl group, a 6-phenoxyhexyl group, a 12-phenyldodecyl group, a 18-phenyloctadecyl group, a 12-(p-chlorophenyl)dodecyl group, a 2-(diphenylphosphate)ethyl group and the like.

Where R¹ and R² each independently represent the alkyl group other than Rf, a substituted or unsubstituted alkyl group having 6 to 18 carbon atoms is still more preferred. Preferred examples of the unsubstituted alkyl group having 6 to 18 carbon atoms include an n-hexyl group, a cyclohexyl group, an n-heptyl group, an n-octyl group, a 2-ethylhexyl group, an n-nonyl group, a 1,1,3-trimethylhexyl group, an n-decyl group, an n-dodecyl group, a cetyl group, a hexadecyl group, a 2-hexyldecyl group, an octadecyl group, a 4-tert-butylcyclohexyl group and the like. Preferred examples of the substituted alkyl group having a substituent and 6 to 18 total carbon atoms include a phenethyl group, a 6-phenoxyhexyl group, a 12-phenyldodecyl group, an oleyl group, a linoleyl group, a linolenyl group and the like.

Where R¹ and R² each independently represent the alkyl group other than Rf, a particularly preferred alkyl group include an n-hexyl group, a cyclohexyl group, an n-heptyl group, an n-octyl group, a 2-ethylhexyl group, an n-nonyl group, a 1,1,3-trimethylhexyl group, an n-decyl group, an n-dodecyl group, a cetyl group, a hexadecyl group, a 2-hexyldecyl group, an octadecyl group, an oleyl group, a linoleyl group and a linolenyl group. The most preferred is an unsubstituted linear, branched or cyclic alkyl group having 8 to 16 carbon atoms.

In the above formula (1), R³, R⁴ and R⁵ each independently represent a hydrogen atom or a substituent. Examples of the substituent include an alkyl group (preferably having 1 to 20 carbon atoms, more preferably having 1 to 12 carbon atoms or particularly preferably having 1 to 8 carbon atoms) such as a methyl group, an ethyl group, an isopropyl group, a tert-butyl group, an n-octyl group, an n-decyl group, an n-hexadecyl group, a cyclopropyl group, a cyclopentyl group, and a cyclohexyl group; an alkenyl group (preferably having 2 to 20 carbon atoms, more preferably having 2 to 12 carbon atoms or particularly preferably having 2 to 8 carbon atoms) such as a vinyl group, an allyl group, 2-butenyl group and 3-pentenyl group; an alkynyl group (preferably having 2 to 20 carbon atoms, more preferably having 2 to 12 carbon atoms or particularly preferably having 2 to 8 carbon atoms) such as a propargyl group and 3-pentinyl group; an aryl group (preferably having 6 to 30 carbon atoms, more preferably having 6 to 20 carbon atoms or particularly preferably having 6 to 12 carbon atoms) such as a phenyl group, a p-methylphenyl group and a naphthyl group; a substituted or unsubstituted amino group (preferably having 0 to 20 carbon atoms, more preferably having 0 to 10 carbon atoms or particularly preferably having 0 to 6 carbon atoms) such as an unsubstituted amino group, a methylamino group, a dimethylamino group, a diethylamino group and dibenzylamino group; an alkoxy group (preferably having 1 to 20 carbon atoms, more preferably having 1 to 12 carbon atoms or particularly preferably having 1 to 8 carbon atoms) such as a methoxy group, an ethoxy group and a butoxy group; an aryloxy group (preferably having 6 to 20 carbon atoms, more preferably having 6 to 16 carbon atoms or particularly preferably having 6 to 12 carbon atoms) such as a phenyloxy group and a 2-naphtyloxy group; an acyl group (preferably having 1 to 20 carbon atoms, more preferably having 1 to 16 carbon atoms or particularly preferably having 1 to 12 carbon atoms) such as an acetyl group, a benzoyl group, a formyl and a pivaloyl group; an alkoxycarbonyl group (preferably having 2 to 20 carbon atoms, more preferably having 2 to 16 carbon atoms or particularly preferably having 2 to 12 carbon atoms) such as a methoxycarbonyl group and an ethoxycarbonyl group; an aryloxycarbonyl group (preferably having 7 to 20 carbon atoms, more preferably having 7 to 16 carbon atoms or particularly preferably having 7 to 10 carbon atoms) such as a phenyloxycarbonyl group; an acyloxy group (preferably having 2 to 20 carbon atoms, more preferably having 2 to 16 carbon atoms or particularly preferably having 2 to 10 carbon atoms) such as an acetoxy group and a benzoyloxy group; an acylamino group (preferably having 2 to 20 carbon atoms, more preferably having 2 to 16 carbon atoms or particularly preferably having 2 to 10 carbon atoms) such as an acetylamino group and a benzoylamino group; an alkoxycarbonylamino group (preferably having 2 to 20 carbon atoms, more preferably having 2 to 16 carbon atoms or particularly preferably having 2 to 12 carbon atoms) such as a methoxycarbonylamino group; an aryloxycarbonylamino group (preferably having 7 to 20 carbon atoms, more preferably having 7 to 16 carbon atoms or particularly preferably having 7 to 12 carbon atoms) such as a phenyloxycarbonylamino group; a sulfonylamino group (preferably having 1 to 20 carbon atoms, more preferably having 1 to 16 carbon atoms or particularly preferably having 1 to 12 carbon atoms) such as a methanesulfonylamino group and a benzenesulfonylamino group; a sulfamoyl group (preferably having 0 to 20 carbon atoms, more preferably having 0 to 16 carbon atoms or particularly preferably having 0 to 12 carbon atoms) such as a sulfamoyl group, a methylsulfamoyl group, a dimethylsulfamoyl group and a phenylsulfamoyl group; a carbamoyl group (preferably having 1 to 20 carbon atoms, more preferably having 1 to 16 carbon atoms or particularly preferably having 1 to 12 carbon atoms) such as an unsubstituted carbamoyl group, a methylcarbamoyl group, a diethylcarbamoyl group and a phenylcarbamoyl group; an alkylthio group (preferably having 1 to 20 carbon atoms, more preferably having 1 to 16 carbon atoms or particularly preferably having 1 to 12 carbon atoms) such as a methylthio group and an ethylthio group; an arylthio group (preferably having 6 to 20 carbon atoms, more preferably having 6 to 16 carbon atoms or particularly preferably having 6 to 12 carbon atoms) such as a phenylthio group; a sulfonyl group (preferably having 1 to 20 carbon atoms, more preferably having 1 to 16 carbon atoms or particularly preferably having 1 to 12 carbon atoms) such as a mesyl group and a tosyl group; a sulfinyl group (preferably having 1 to 20 carbon atoms, more preferably having 1 to 16 carbon atoms or particularly preferably having 1 to 12 carbon atoms) such as a methanesulfinyl group and a benzenesulfinyl group; a ureido group (preferably having 1 to 20 carbon atoms, more preferably having 1 to 16 carbon atoms or particularly preferably having 1 to 12 carbon atoms) such as an unsubstituted ureido group, a methylureido group and a phenylureido group; a phosphoramide group (preferably having 1 to 20 carbon atoms, more preferably having 1 to 16 carbon atoms or particularly preferably having 1 to 12 carbon atoms) such as a diethylphosphoramide and a phenylphosphoramide; a hydroxy group; a mercapto group; halogen atoms such as a fluorine atom, a chlorine atom, a bromine atom and an iodine atom; a cyano group; a sulfo group; a carboxyl group; a nitro group, a hydroxam group; a sulfino group; a hydrazino group; an imino group; a heterocyclic group (preferably having 1 to 30 carbon atoms, or more preferably having 1 to 12 carbon atoms and exemplified by a heterocyclic group having a hetero atom including nitrogen atom, oxygen atom, sulfur atom and the like) such as an imidazolyl group, a pyridyl group, a quinolyl group, a furyl group, a piperidyl group, a morpholino group, a benzoxaxolyl group, a benzimidazolyl group and a benzthiazolyl group; a silyl group (preferably having 3 to 40 carbon atoms, more preferably having 3 to 30 carbon atoms or particularly preferably having 3 to 24 carbon atoms) such as a trimethylsilyl group and a triphenylsilyl group; and the like. These substituents may be further substituted. In a case where two or more substituents are present, they may be the same or different. If possible, the substituents may be combined with each other to form a ring structure.

R³, R⁴ and R⁵ may preferably be an alkyl group or a hydrogen atom, or more preferably a hydrogen atom.

In the above formula, X¹ and X² each independently represent a bivalent coupling group or a single bond. The bivalent coupling group is not particularly limited but may preferably include an arylene group, —O—, —S—, —NR³¹—(R³¹ representing a hydrogen atom or a substituent including the same as those represented by R³, R⁴ or R⁵, preferably representing an alkyl group, the aforesaid Rf or a hydrogen atom, or more preferably representing a hydrogen atom) and a group formed by combining any one of these or two or more of these. More preferably, the bivalent coupling group include —O—, —S— and NR³¹. X¹ and X² may more preferably be —O— or —NR³¹—, still more preferably be —O— or —NH—, or particularly preferably be —O—.

In the above formula, Z represents a bivalent coupling group or a single bond. The bivalent coupling group is not particularly limited but may preferably include an alkylene group, an arylene group, —C(═O)—, —O—, —S—, —S(═O)—, —S(═O)₂—, NR³² (R³² representing a hydrogen atom or a substituent including the same as those represented by R³, R⁴ or R⁵, preferably representing an alkyl group or a hydrogen atom, or more preferably representing a hydrogen atom) and a group formed by combining any one of these or two or more of these. More preferably, the bivalent coupling group may be any one of an alkylene group having 1 to 12 carbon atoms, an arylene group having 6 to 12 carbon atoms, —C(═O)—, —O—, —S—, —S(═O)—, —S(═O)₂—, —NR³²—, or a group formed by combining any one of these or two or more of these. Still more preferably, Z may include an alkylene group having 1 to 8 carbon atoms, —C(═O)—, —O—, —S—, —S(═O)—, —S(═O)₂—, —NR³²—, and a group formed by combining any one of these or two or more of these. Examples of such a group include the followings:

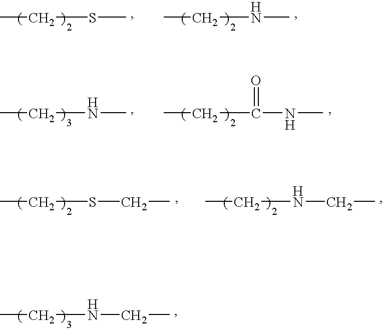

In the above formula, M⁺ represents a cationic substituent, preferably an organic cationic substituent or more preferably an organic cationic group containing a nitrogen or phosphorus atom. Still more preferred is a pyridinium cation or ammonium cation. Above all, a trialkylammonium cation represented by the following formula (2) is more preferred.

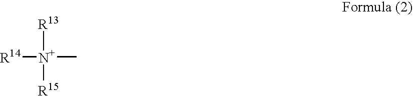

wherein R¹³, R¹⁴ and R¹⁵ each independently represent a substituted or unsubstituted alkyl group, an applicable substituent of which include the same as those represented by R³, R⁴ or R⁵. If possible, R¹³, R¹⁴ and R¹⁵ may be combined with each other to form a ring structure. R¹³, R¹⁴ and R¹⁵ may preferably include an alkyl group having 1 to 12 carbon atoms, more preferably an alkyl group having 1 to 6 carbon atoms, still more preferably a methyl group, an ethyl group and a methylcarboxyl group, or particularly preferably a methyl group.

In the foregoing formula, Y⁻ represents a counter anion, which may be inorganic or organic. Where the counter anion has no overall charge within the molecule, Y⁻ may be absent. Preferred examples of the inorganic anion include an iodine ion, a bromine ion, a chlorine ion and the like. Preferred examples of the organic anion include a p-toluenesulfonic acid ion, a benzenesulfonic acid ion, a methanesulfonic acid ion, a trifluoromethanesulfonic acid ion and the like. Y⁻ may more preferably include an iodine ion, a p-toluenesulfonic acid ion and a benzenesulfonic acid ion, or still more preferably a p-toluenesulfonic acid ion.

In the foregoing formula, m represents 0 or 1, or preferably 0.

Among the compounds represented by the formula (1), a compound represented by the following formula (1-a) is more preferred.

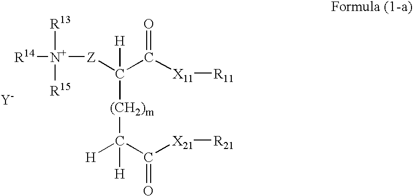

wherein R¹¹ and R²¹ each independently represent a substituted or unsubstitued alkyl group, provided that at least one of R¹¹ and R²¹ is the aforesaid Rf and that R¹¹ and R²¹ have a total carbon number of 19 or less; R¹³, R¹⁴ and R¹⁵ each independently represent a substituted or unsubstituted alkyl group and may be combined with each other to form a ring structure; X¹¹ and X²¹ each independently represent —O—, —S— or —NR³¹—, R³¹ representing a hydrogen atom or a substituent; Z represents a bivalent coupling group or a single bond; and Y⁻ represents a counter anion, provided that Y⁻ may be absent when having no overall charge within the molecule.

m represents 0 or 1. In the formula, Z and Y⁻ are each independently defined as the same as that in the foregoing formula (1) and each independently have the same preferred scope as the above. R¹³, R¹⁴, R¹⁵ and m are each independently defined as the same as that in the foregoing formula (1) and each independently have the same preferred scope as the above.

In the foregoing formula, X¹¹ and X¹² each independently represent —O—, —S— or —NR³¹—(R³¹ representing a hydrogen atom or a substituent including the same as those represented by the foregoing R³, R⁴ or R⁵, and preferably including an alkyl group, the aforesaid Rf and a hydrogen atom or more preferably a hydrogen atom). X¹¹ and X¹² more preferably include —O— and —NH—, or still more preferably —O—.

In the above formula, R¹¹ and R²¹ are each independently defined as the same as R¹ and R² in the foregoing formula (1) and each independently have the same preferred scope as the above, provided that R¹¹ and R²¹ have a total carbon number of 19 or less. m is 0 or 1.

While specific examples of the compound represented by the formula (1) are illustrated as below, it is to be noted that these specific examples do not limit the present invention. Unless a particular notation is added to the structure representation of the illustrative compound, the alkyl group and perfluoroalkyl group are defined herein to have a linear structure. Of the abbreviations in the following representations, 2EH means 2-ethylhexyl.

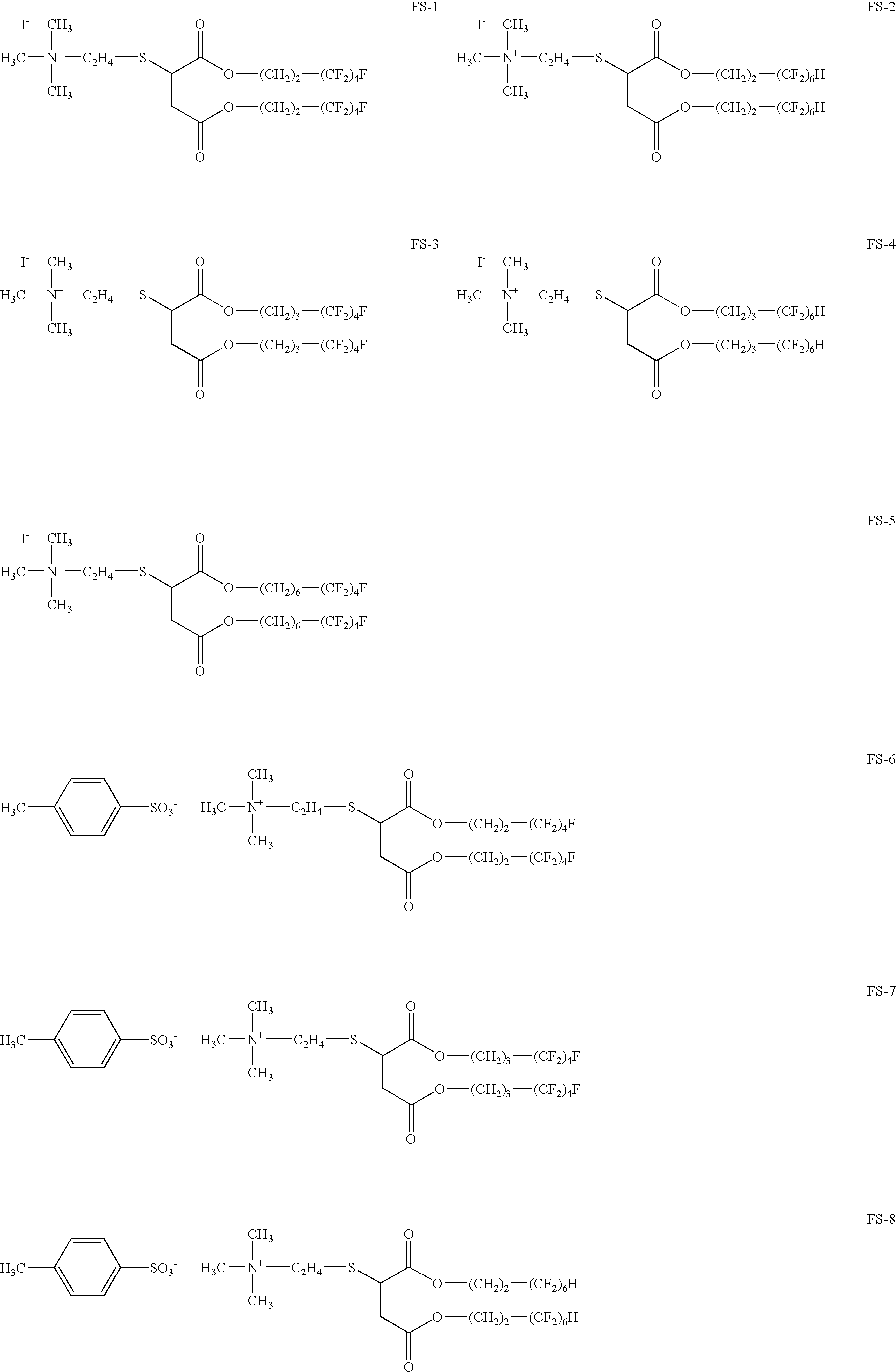

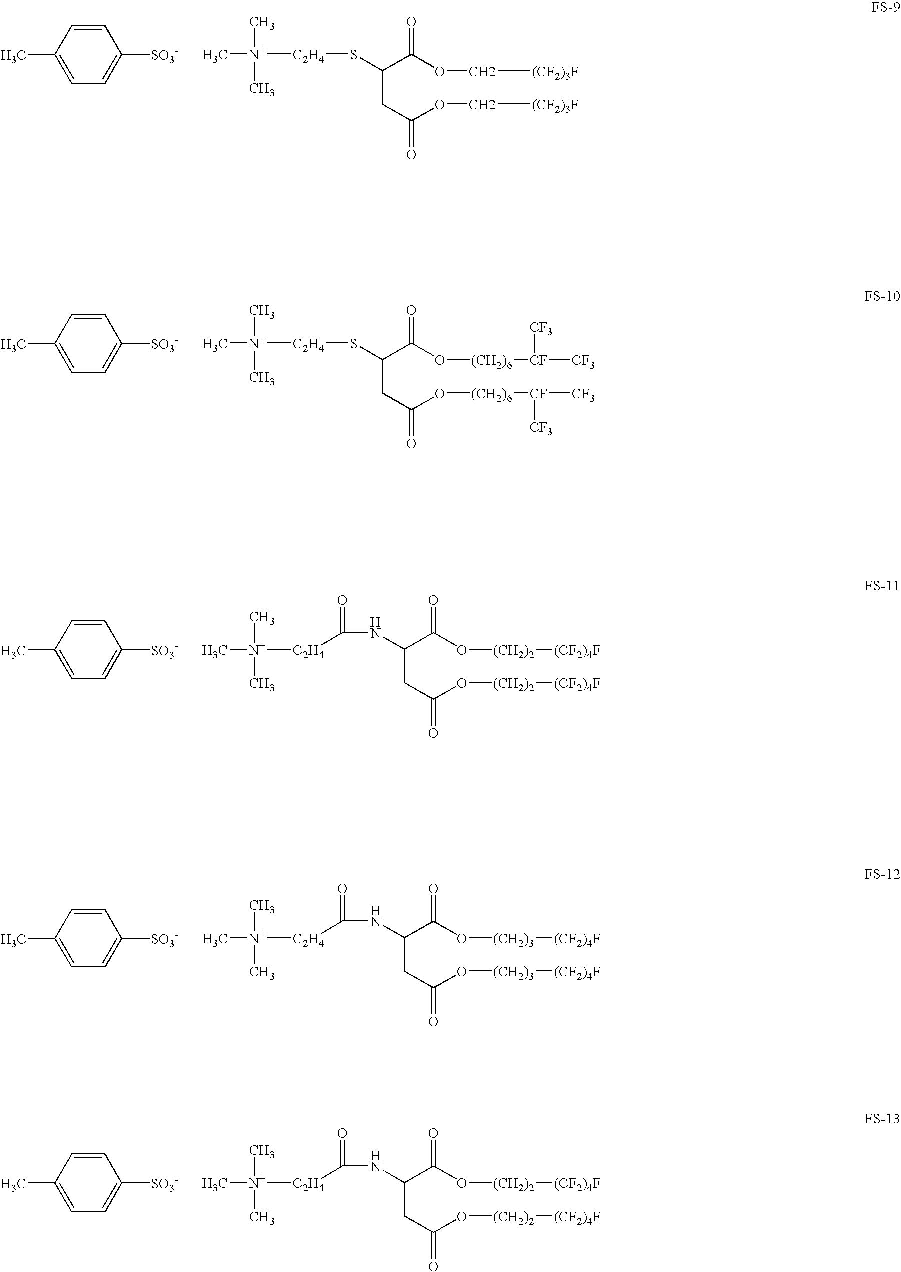

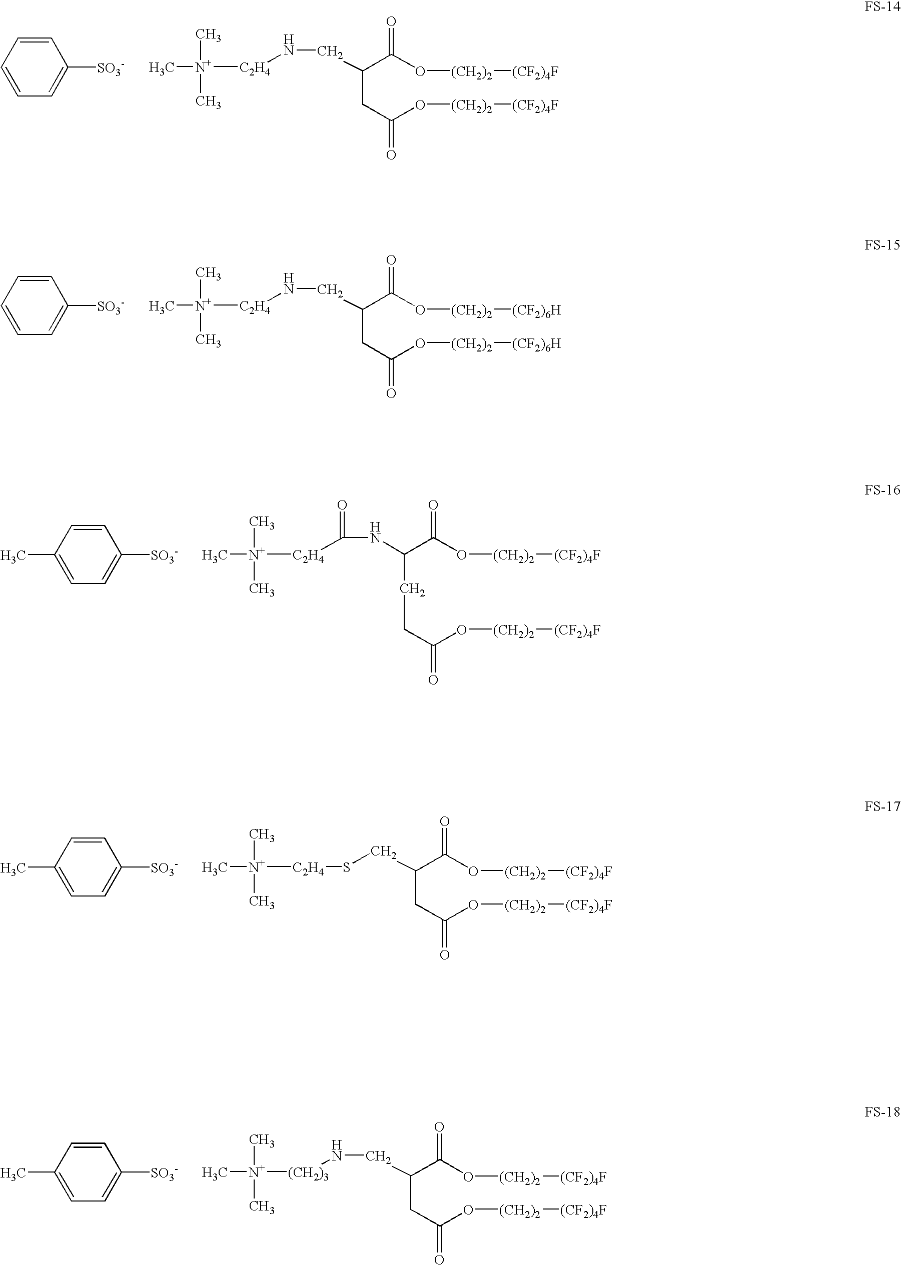

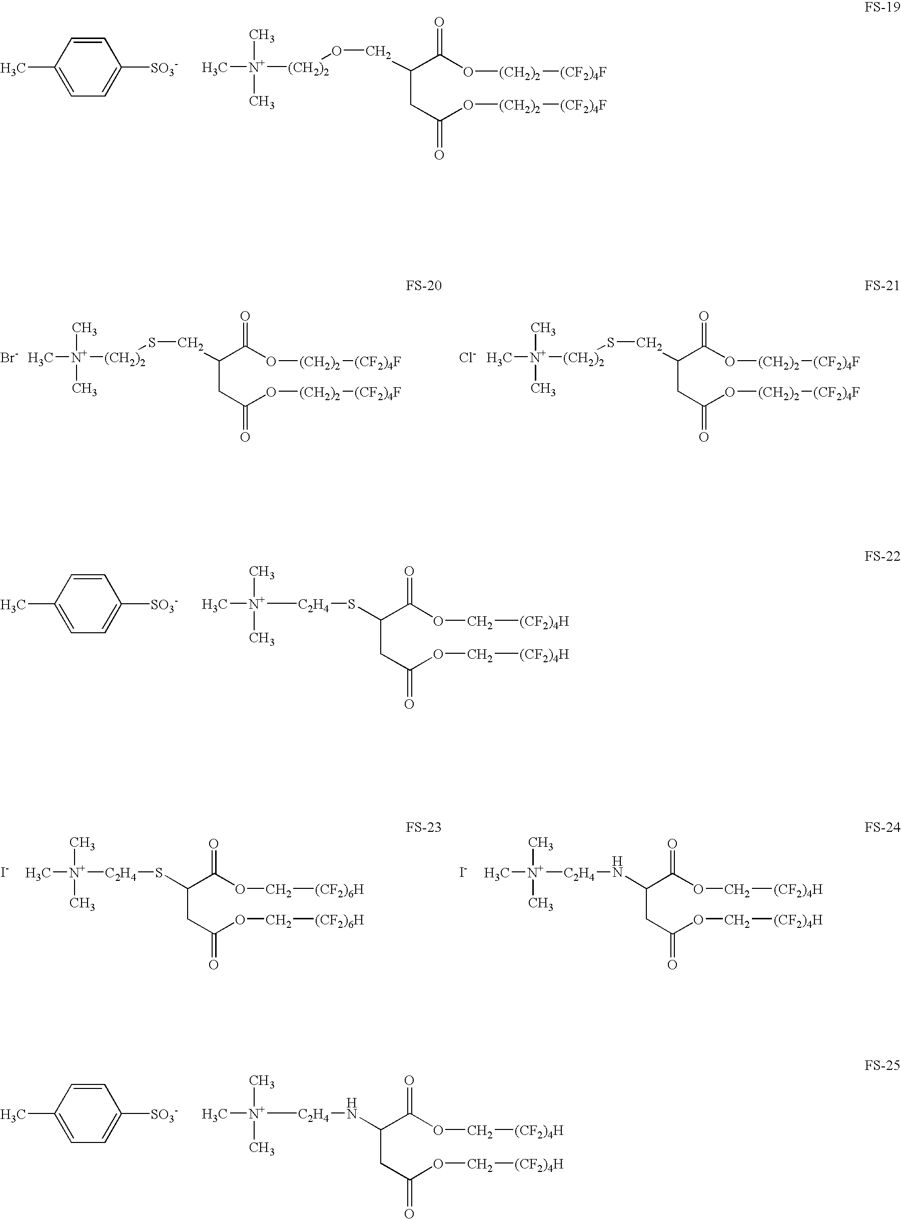

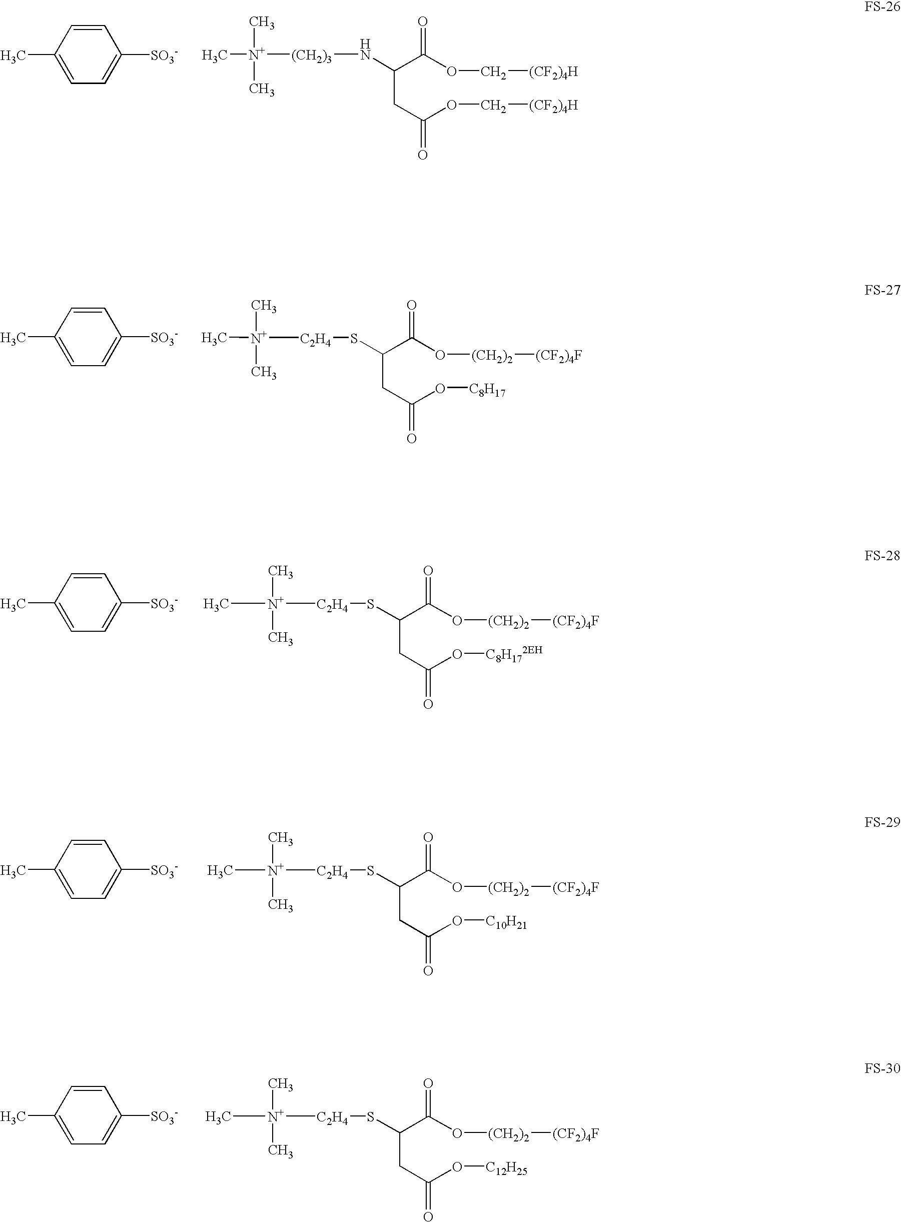

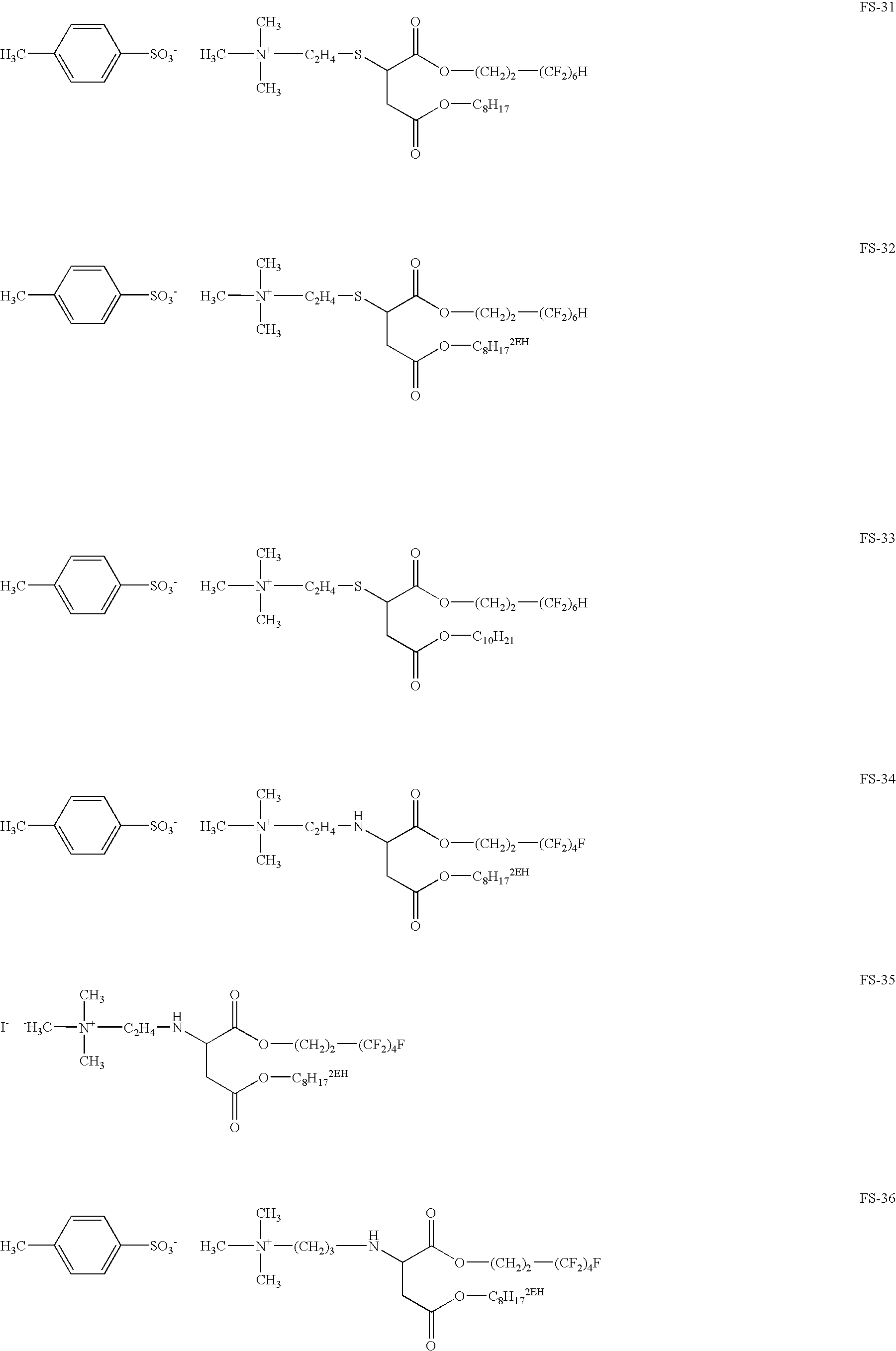

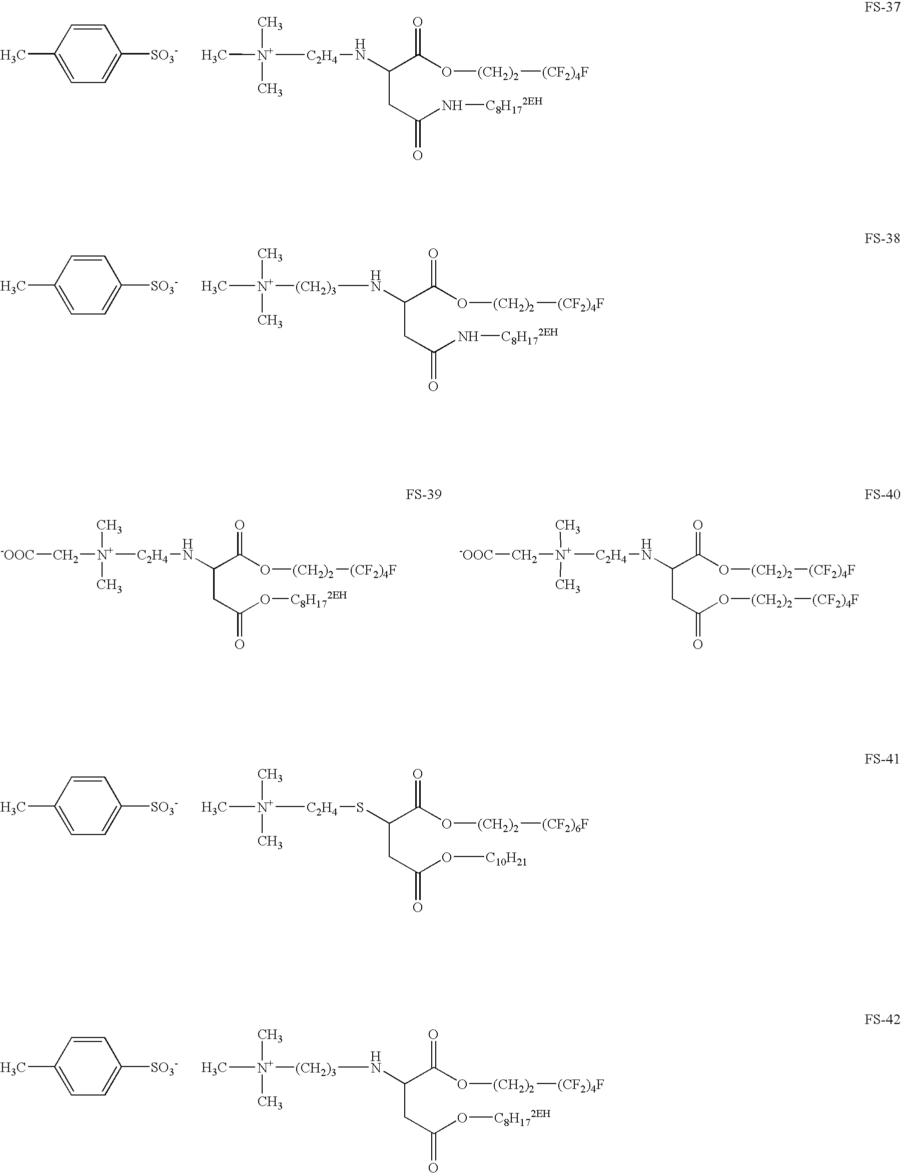

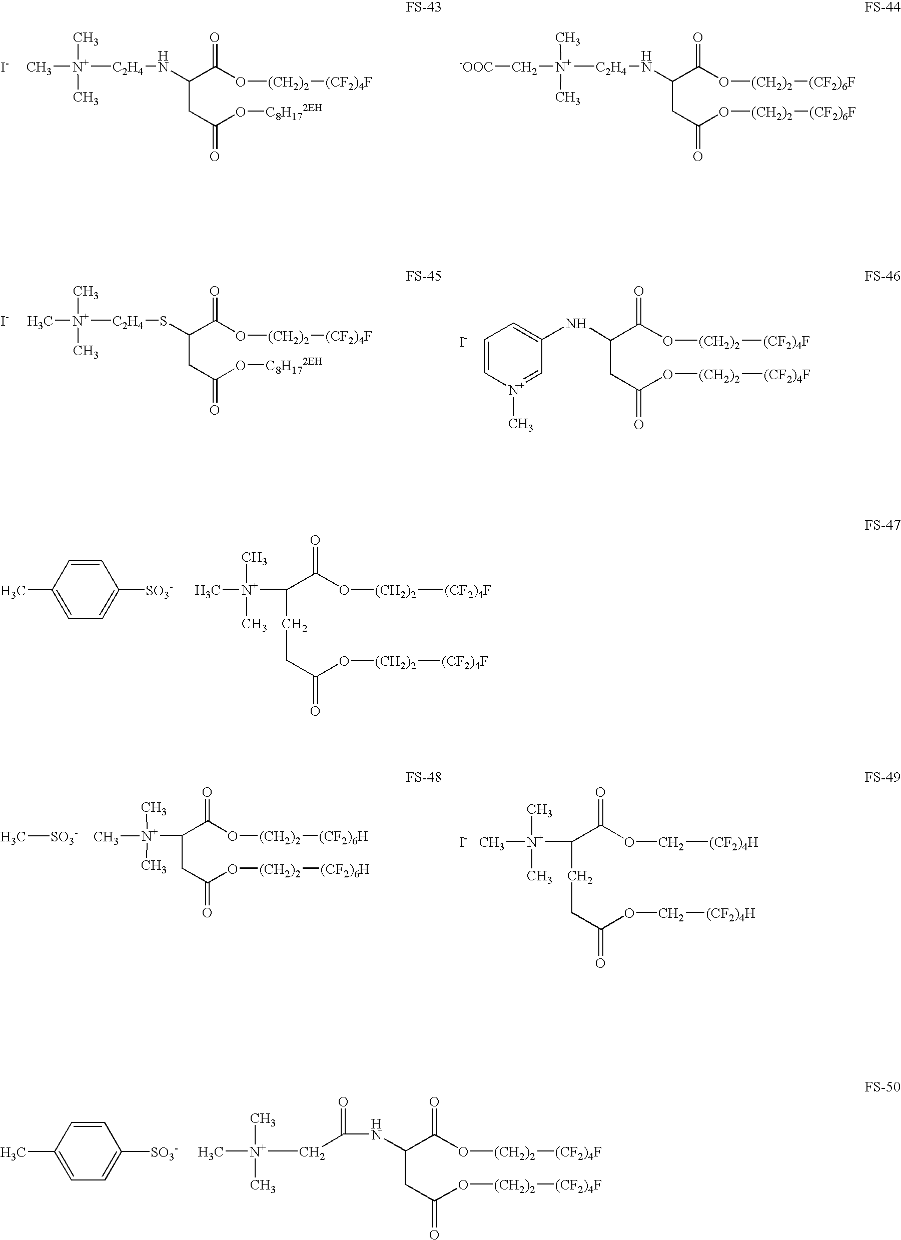

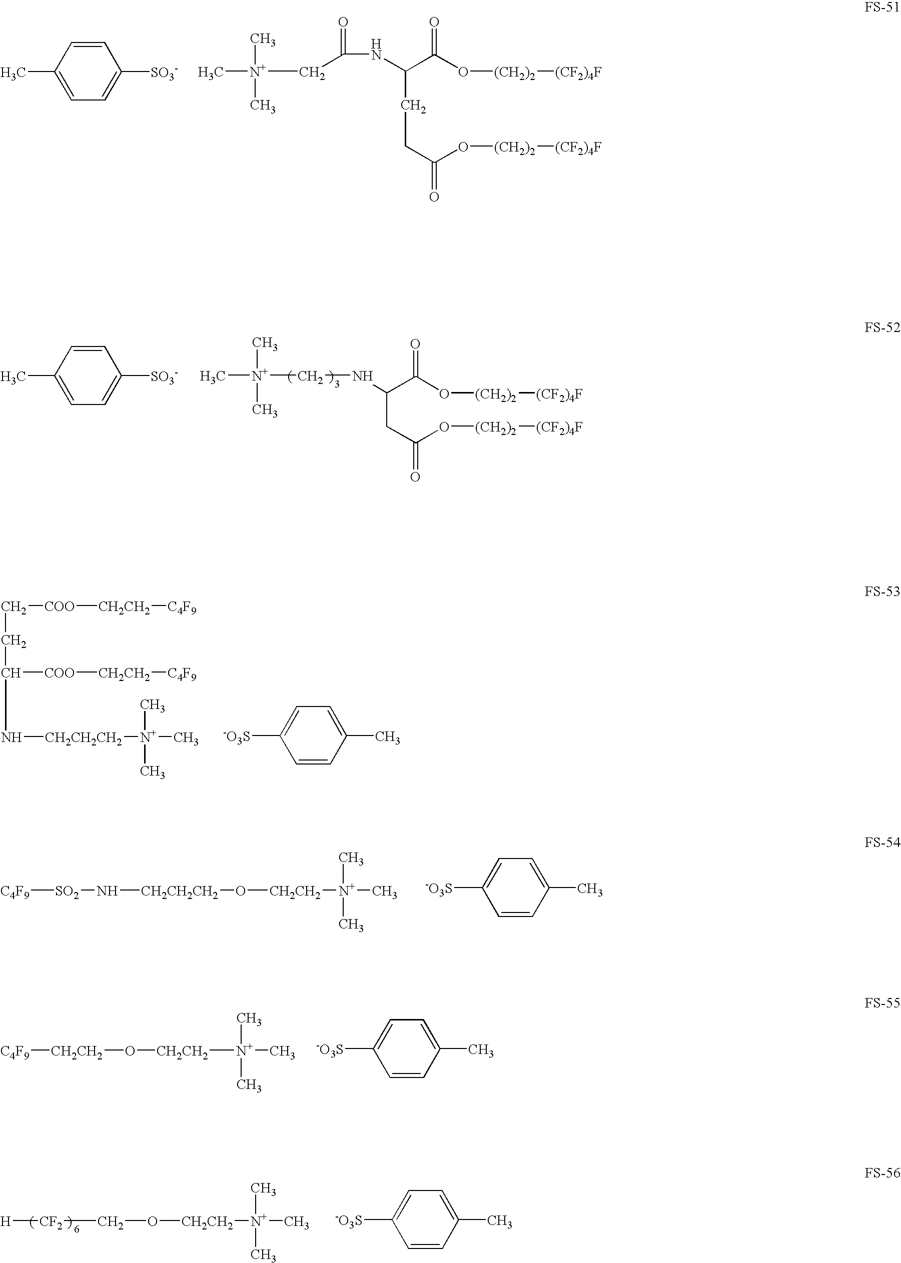

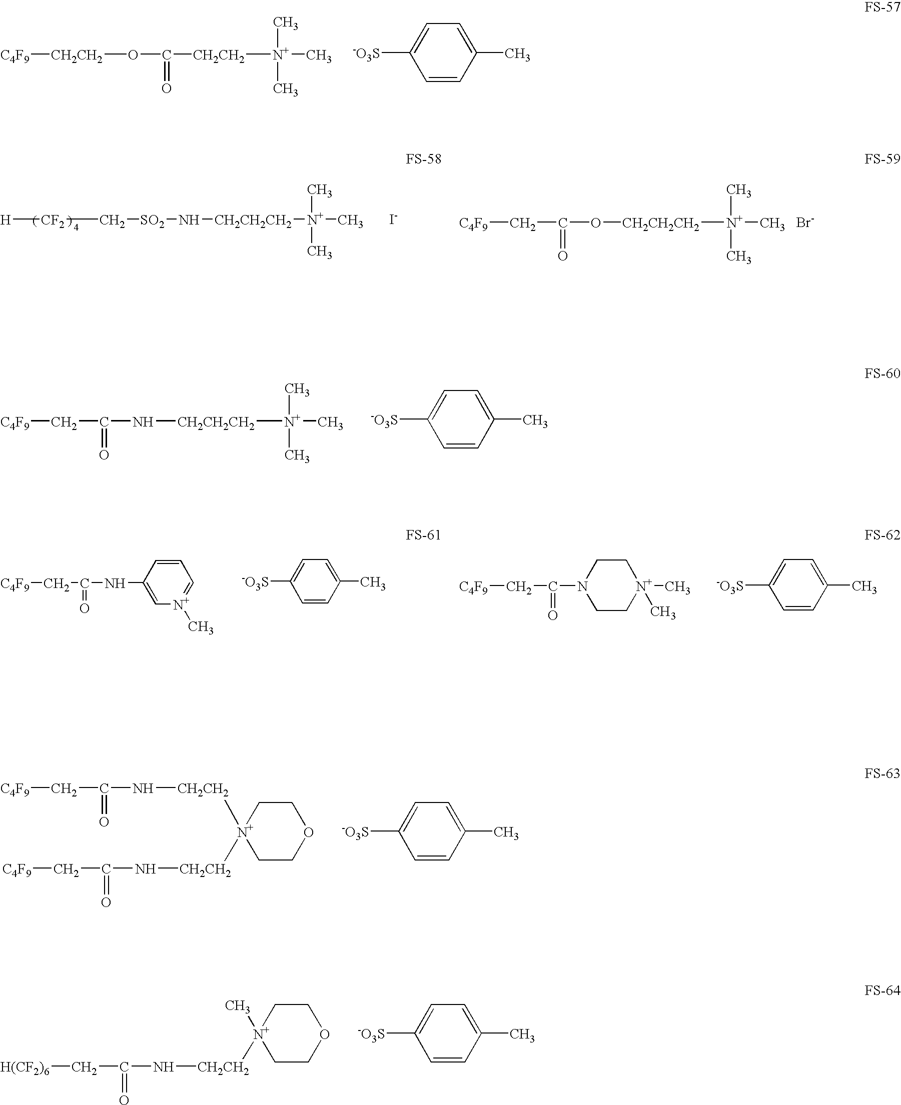

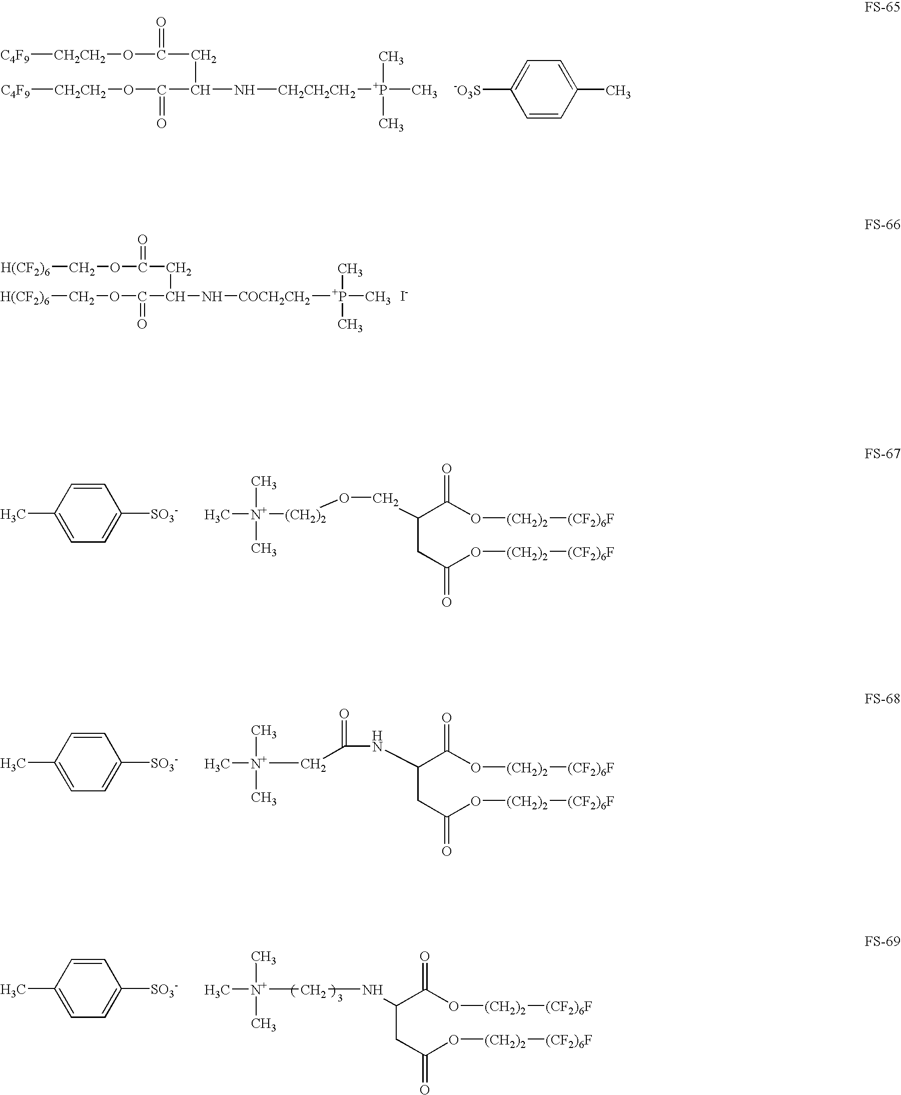

Next, an example of the common synthesis method for the compounds represented by the general formulas (1) and (1-a) is described, but the present invention is not limited by this.

The compound of the present invention may be synthesized from a fumaric acid derivative, a maleic acid derivative, an itaconic acid derivative, a glutamic acid derivative, an aspartic acid derivative or the like. For instance, in a case where a fumaric acid derivative, a maleic acid derivative and an itaconic acid derivative are used as starting materials, the double bonds thereof may be subjected to Michael addition using a nucleophilic reagent and then the resultant product may be treated with an alkylating agent for imparting cationic charges thereto.

The fluorine compound according to the present invention may have an anionic hydrophilic group.

The anionic hydrophilic group is defined to include an acidic group having a pKa value of 7 or less, and an alkali metal salt or ammonium salt thereof. Specific examples of the anionic hydrophilic group include a sulfo group, a carboxyl group, a phosphonic acid group, a carbamoylsulfamoyl group, a sulfamoylsulfamoyl group, an acylsulfamoyl group and salts thereof. Of these, the sulfo group, carboxyl group, phosphonic acid group and the salts thereof are preferred. More preferred are the sulfo group and salts thereof. A cationic seed for salt formation include lithium, sodium, potassium, cesium, ammonium, tetramethylammonium, tetrabutylammonium, methylpyridinium and the like. Lithium, sodium, potassium and ammonium are preferred.

According to the present invention, a preferred fluorine compound having the anionic hydrophilic group is represented by the following formula (3):

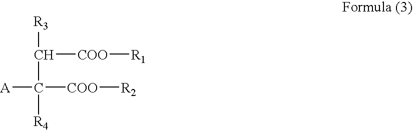

wherein R¹ and R² each independently represent an alkyl group, provided that at least one of them represents the Rf, and that when R¹ and R² each represent an alkyl group other than a fluoroalkyl group, the alkyl group preferably has 2 to 18 carbon atoms, or more preferably 4 to 12 carbon atoms; and R³ and R⁴ each independently represent a hydrogen atom or a substituted or unsubstituted alkyl group.

Specific examples of the fluoroalkyl group represented by R¹ or R² include the foregoing fluoroalkyl groups, a preferred structure of which is similarly represented by the foregoing formula (A). Likewise, preferred structures of the groups of the formula (A) also include the same as those of the foregoing fluoroalkyl groups. It is preferred that both R¹ and R² represent any of the foregoing fluoroalkyl groups as the alkyl group.

The substituted or unsubstituted alkyl group represented by R³ or R⁴ may have any of the linear structure, branched structure and cyclic structure. The substituent of the alkyl group is not particularly limited but may preferably include an alkenyl group, an aryl group, an alkoxy group, a halogen atom (preferably Cl), a carboxylate group, a carbonamido group, a carbamoyl group, an oxycarbonyl group, a phosphate group and the like.

A represents —L_{b}—SO₃M, whereas M represents a cation. Examples of the cation represented by M include an alkali metal ion (lithium ion, sodium ion, potassium ion and the like); an alkali-earth metal ion (barium ion, calcium ion, ammonium ion and the like); an ammonium ion and the like. Among these, a lithium ion, a sodium ion, a potassium ion and an ammonium ion are more preferred, and still more preferred are a lithium ion, a sodium ion and a potassium ion. A suitable cation may be selected from these according to the total carbon number or substituent of the compound represented by the formula (3) or the branched degree of the alkyl group. Where M is a lithium ion when the total carbon number of R¹, R², R³ and R⁴ is 16 or more, the compound presents good solubility (particularly to water) and good antistatic properties and consistent coating property.

L^{b} represents a single bond or a substituted or unsubstituted alkylene group. The substituent of the alkylene group may preferably include those represented by R³. In a case where L^{b} is an alkylene group, the alkylene group may preferably have 2 or less carbon atoms. L^{b} may preferably be a single bond or —CH₂— group or most preferably be a —CH₂— group.

It is more preferred that the above formula (3) is implemented in combination of the foregoing preferred modes.

While specific examples of the fluorine compound having the anionic hydrophilic group according to the present invention are illustrated as below, it is to be noted that these specific examples do not limit the present invention at all. Unless otherwise specifically stated in the representation of the structures of the following compounds, the alkyl group and perfluoroalkyl group are defined herein to have a linear structure.

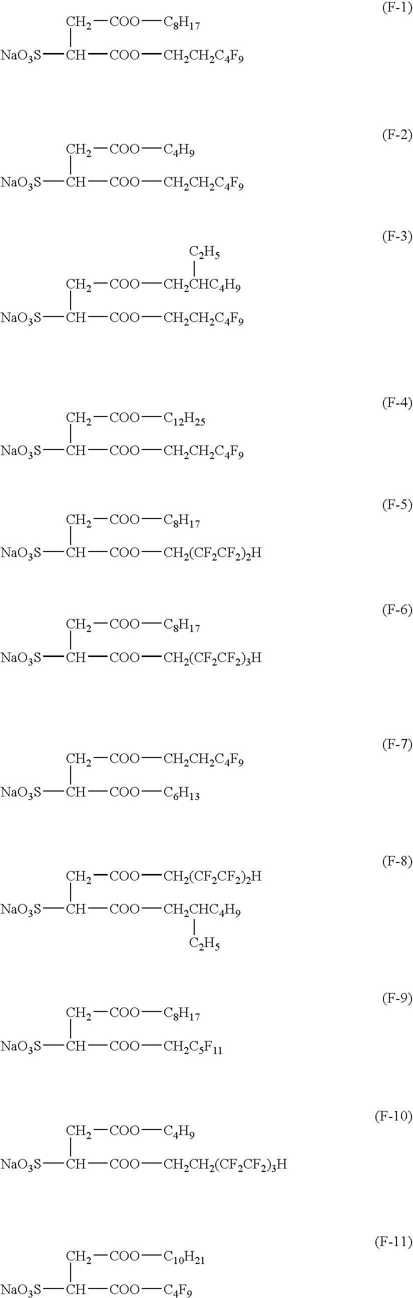

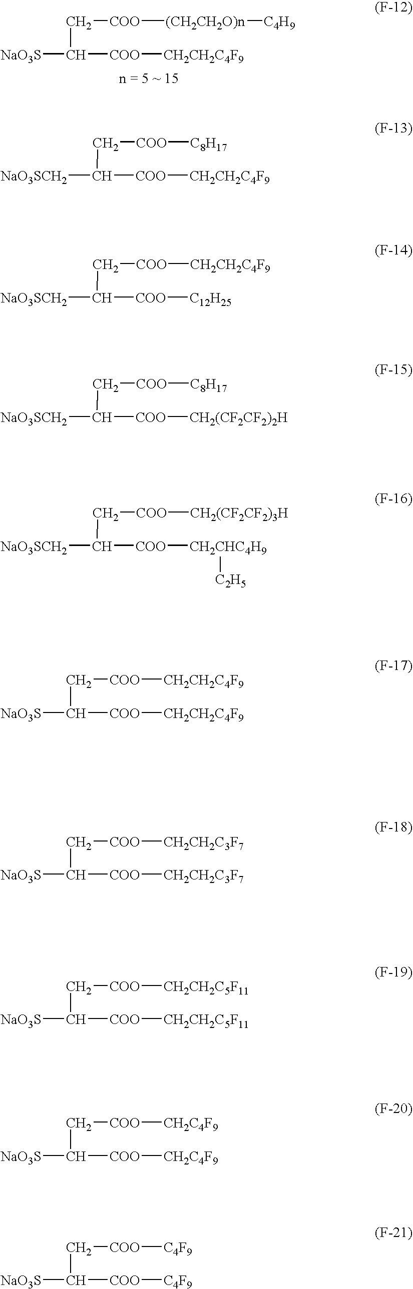

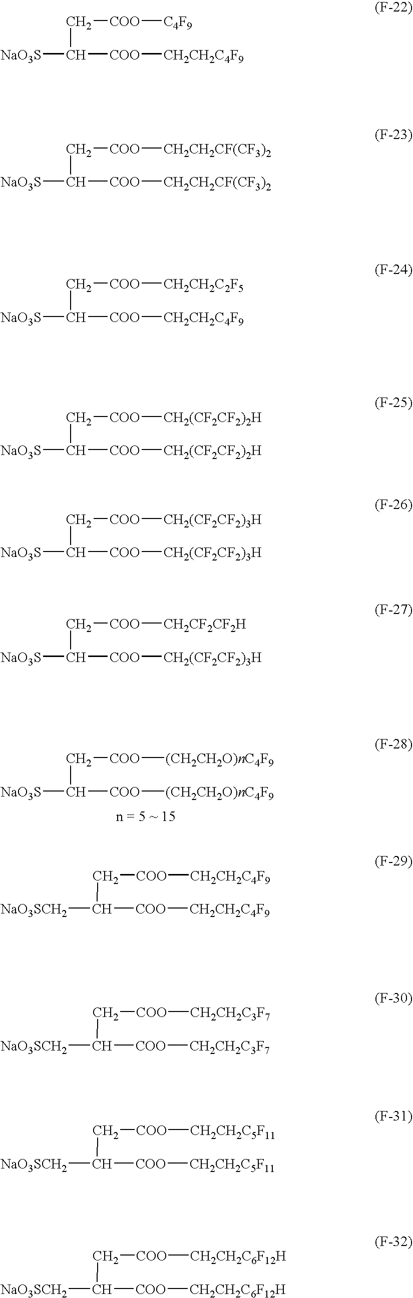

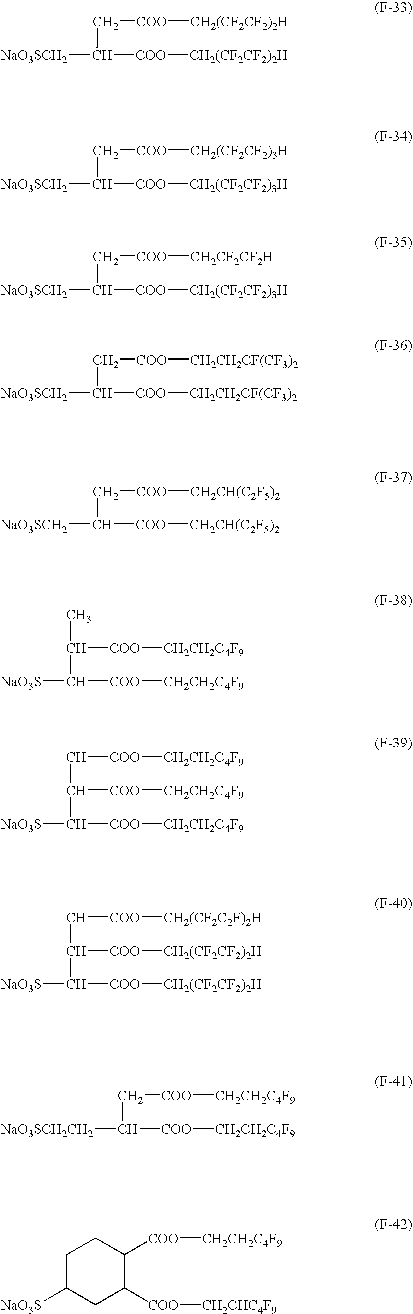

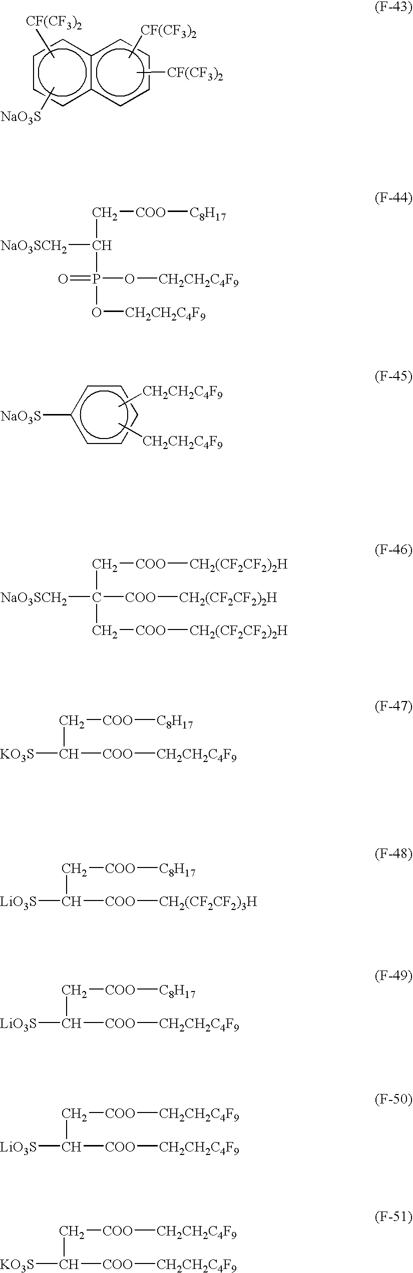

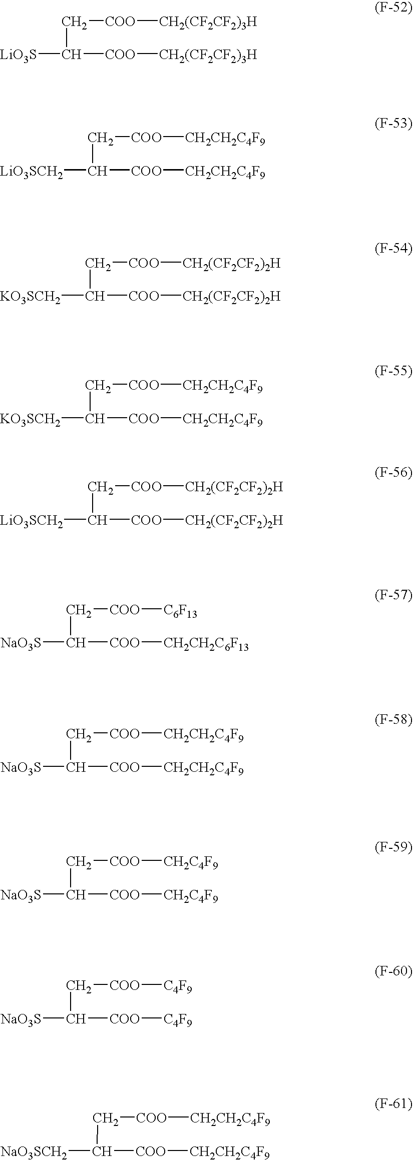

The fluorine compound according to the present invention may have a nonionic hydrophilic group.

The nonionic hydrophilic group is soluble to water without inducing dissociation into ions. Specific examples of such a group include but are not limited to poly(oxyethylene) alkyl ethers, polyhydric alcohols and the like.

According to the present invention, a preferred nonionic fluorine compound is represented by the following formula (4):

Rf—X—(CH²)ₙ—Oₘ—R Formula (4)

In the formula (4), Rf represents the aforesaid fluoroalkyl group, specific examples of which include the groups mentioned above and a preferred structure of which is, similarly to the above, represented by the foregoing formula (A). Preferred structures represented by the formula (A) include the same as those of the foregoing Rf.

In the formula (4), X represents a bivalent coupling group, which is not particularly limited. Examples of the coupling group include the following groups.

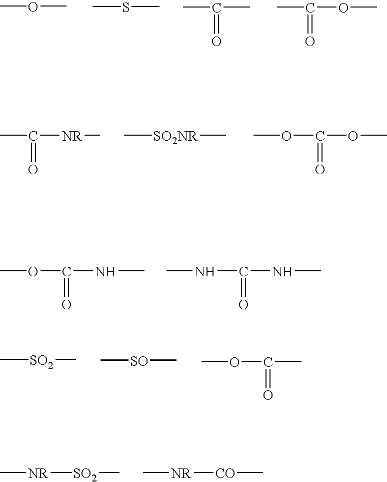

In the formula (4), n represents 2 or 3 whereas m represents 1 to 30. R represents a hydrogen atom, an alkyl group, an aryl group, a heterocyclic group, Rf or a group containing one or more Rfs as substituent.

While specific examples of the nonionic fluorine compound used according to the present invention are illustrated as below, it is to be noted that these specific examples do not limit the present invention.

FN-1 C₄F₉CH₂CH₂O—(CH₂CH₂O)ₙ—H n=5˜15

FN-2 H(CF₂)₆CH₂O—(CH₂CH₂O)ₙ—H n=5˜15

FN-3 C₄F₉CH₂COO—(CH₂CH₂O)ₙ—H n=5˜15

FN-4 C₄F₉CH₂CONH—(CH₂CH₂O)ₙ—H n=5˜15

FN-5 C₄F₉CH₂SO₂NH—(CH₂CH₂O)ₙ—H n=5˜15

FN-6 C₄F₉CH₂CH₂NHCOO—(CH₂CH₂O)ₙ—H n=5˜15

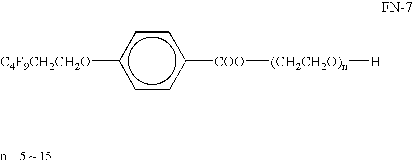

FN-8 H(CF₂)₄CH₂—(CH₂CH₂CH₂O)ₙ—H n=5˜15

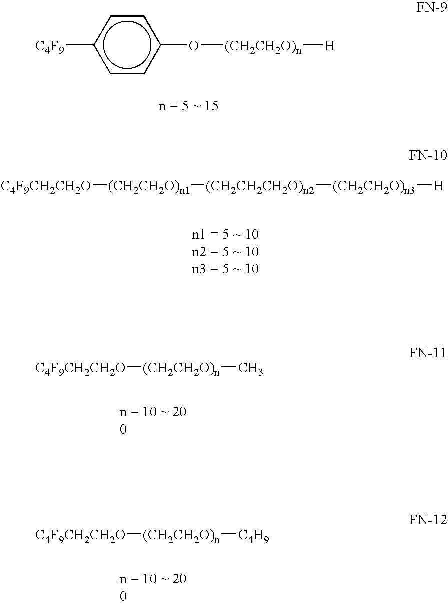

FN-13 C₄F₉CH₂CH₂O—(CH₂CH₂O)ₙ—CH₂CH₂C₄F₉ n=10˜20

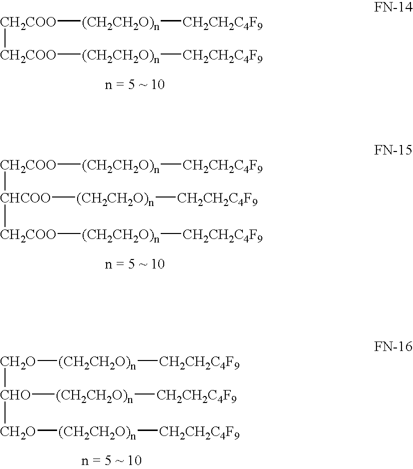

FN-17 H—C₆F₁₂CH₂O—(CH₂CH₂O)ₙ—CH₂C₆F₁₂—H n=5˜10

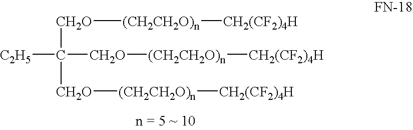

FN-19 C₆F₁₃CH₂CH₂O—(CH₂CH₂O)ₙ—H n=5˜15

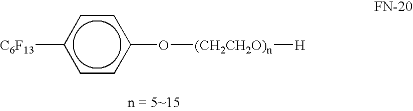

FN-21 C₆F₁₃CH₂CH₂O—(CH₂CH₂O)ₙ—CH₂CH₂C₆F₁₃ n=10˜20

The compound containing the specific fluoroalkyl group according to the present invention is favorably used as a surfactant for use in a coating composition for forming a layer constituting a photosensitive material (a protective layer, undercoat layer and back layer, in particular). It is particularly preferred to use the compound for forming the outermost layer of the photosensitive material because effective antistatic properties and consistent coating properties are obtained. It was also found that forming the compound in the structure of the present invention was effective to achieve the object of the present invention or the improvement in the storage stability of the photosensitive material and in the dependence on the environment where the photosensitive material was used. In order to achieve the effect, the fluorine compound of the present invention may preferably be used in the outermost layer on an image formation layer side or on a backside of the photosensitive material. Furthermore, a similar effect may be obtained by using the compound in the undercoat layer of a support.

The amount of the specific fluorine compound according to the present invention is not particularly limited and may arbitrarily be decided depending upon the structure of the fluorine compound, the place where the fluorine compound is used, or the types or amounts of other materials contained in the composition. In a case where the fluorine compound is used in a coating solution for the outermost layer of the photothermographic material, for instance, a coating amount of the fluorine compound in the coating solution may preferably be in the range of 0.1 mg/m₂ to 100 mg/m², or more preferably of 0.5 mg/m² to 20 mg/m².

According to the present invention, the foregoing specific fluorine compounds may be used alone or in combination of two or more types.

### 2. Description of Organic Silver Salt

A usable organic silver salt according to the present invention is relatively stable to light but is capable of functioning as a silver ion donor when heated to 80° C. or above in the presence of a photosensitive silver halide and a reducing agent exposed to light, thereby permitting the formation of a silver image.

Besides silver behenate, the organic silver salt may further contain an optional organic substance capable of donating silver ions to be reduced by the reducing agent. Such non-photosensitive organic silver salts are set forth in Japanese Patent Application Laid-open (JP-A) No. 10-62899, paragraphs 0048 to 0049; European Laid Open Patent Application (EP-A) No. 0803764A1, page 18, line 24 to page 19, line 37; EP-A No. 0962812A1; JP-A Nos. 11-349591, 2000-7683 and 2000-72711; and the like. Above all, a silver salt of organic acid or a silver salt of long-chained aliphatic carboxylic acid (having 10 to 30 carbon atoms or preferably 15 to 28 carbon atoms) in particular is preferred. Preferred examples of the silver salt of fatty acid include silver lignocerate, silver behenate, silver arachidinate, silver stearate, silver oleate, silver laurate, silver caproate, silver myristate, silver palmitate, silver erucinate and the mixtures thereof.

According to the present invention, the use of an organic silver salt having a silver behenate content of 40 mol % to 99 mol % results in good characteristics including image storability, heat-developing activity and high-speed performance. The content of silver behenate is preferably in the range of 50 mol % to 95 mol %, more preferably of 60 mol % to 90 mol %, or still more preferably of 65 mol % to 85 mol %. According to a design attributing importance to the image storability, the content of silver behenate is preferably in the range of 70 mol % to 99 mol %, or more preferably of 80 mol % to 99 mol %. According to a design attributing importance to the heat-developing activity and rapid performance, the content of silver behenate is preferably in the range of 50 mol % to 85 mol %, or more preferably of 55 mol % to 80 mol %. In addition, silver erucinate may preferably be used in an amount of 2 mol % or less, more preferably of 1 mol % or less, or still more preferably of 0.1 mol % or less.

The organic silver salt applicable to the present invention is not particularly limited in shape and may have any of needle-like, rod-like, tabular and scaly shapes.

The present invention may preferably employ organic silver salt particles of scaly shape. Also preferred are particles having a short rod-like shape of a long axis to short axis ratio of less than 5, a rectangular parallelepiped shape, a cubic shape or potato-like irregular shapes. These organic silver particles are characterized by less fogging during thermal development, as compared with particles shaped like a long rod having a long axis to short axis ratio of 5 or more. Particles having a long axis to short axis ratio of 3 or less are particularly preferred because they form a coated film improved in mechanical stability. The present specification defines the organic silver salt particles of scaly shape as follows. The shape of the organic silver salt particles is approximated as a rectangular parallelepiped as observed with an electron microscope. The sides of the rectangular parallelepiped are expressed a, b and c in the order of increasing length (c may be equal to b). x is calculated from the values a and b of the shorter sides applied to the following equation:

x=b/a

In this manner, approximately 200 particles are determined for the values x, an average x of which is determined. Particles satisfying a relation of x (average)≧1.5 are defined as scaly particles. The scaly particles may preferably satisfy a relation of 30≧x (average)≧1.5, or more preferably 15>x (average) ≧1.5. Incidentally, particles of a needle like shape satisfy a relation of 1≦x (average)<1.5.

In the scaly particle, a may be regarded as a thickness of a tabular particle having a main plane defined by the sides b and c. The average of a is preferably in the range of 0.01 μm to 0.30 μm, or more preferably of 0.1 μm to 0.23 μm. The average of c/b is preferably in the range of 1 to 6, or more preferably of 1 to 4, or still more preferably of 1 to 3. The average of c/b is particularly preferably in the range of 1 to 2.

The particle size distribution of the organic silver salt may preferably correspond to monodispersion. The monodispersion means that the percentage of the value obtained by dividing the standard deviation of the length of the short axis and the long axis respectively by the length of the short axis and long axis is preferably 100% or less, more preferably 80% or less, or still more preferably 50% or less. The shape of the organic silver salt particles can be determined based on a photographic image of an organic silver salt dispersion obtained by a transmission electron microscope. Alternatively, the monodispersion characteristic of the organic silver salt particles may be determined from the standard deviation of volume weight average diameter thereof. The percentage of a value obtained by dividing the standard deviation by volume weight average diameter (variation coefficient) is preferably 100% or less, more preferably 80% or less, or still more preferably 50% or less. For measurement, a laser-scatter particle size measuring instrument, which is commercially available, may be used. The measurement method is applicable to the determination of the size of other particles set forth as below.

The organic acid silver salt usable in the present invention may be prepared and dispersed by any of the known methods. Such methods are taught in, for example, JP-A No. 10-62899; EP-A Nos. 0803763A1 and 0962812A1; JP-A Nos. 11-349591, 2000-7683 and 2000-72711; and 2001-163889, 2001-163827, 2001-033907, 2001-188313, 2001-083652, 2002-006442, 2002-031870, and 2002-006442; and the like.

The organic silver salt of the present invention may be used in a desired amount, but preferably in an amount, on a silver basis, of 0.1 g/m² to 5 g/m², more preferably of 1 g/m² to 3 g/m², or particularly preferably of 1.2 g/m² to 2.5 g/m².

### 3. Description of Reducing Agent

The photothermographic material of the present invention contains a reducing agent for organic silver salt. The reducing agent may be any material (preferably an organic material) that is capable of reducing silver ions to a silver metal. Examples of the reducing agent are illustrated in JP-A No. 11-65021, paragraphs 0043 to 0045; and EP-A No. 0803764, page 7, line 34 to page 18, line 12.

According to the present invention, a so-called hindered phenol reducing agent containing a substituent in the ortho position of a phenolic hydroxyl group or a bisphenol-base reducing agent is preferred, and the bisphenol-base reducing agent is more preferred. Above all, a bisphenol compound represented by the following formula (R) is particularly preferred:

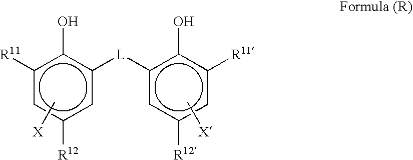

In the formula (R), R¹¹ and R^{11′} each independently represent an alkyl group having 1 to 20 carbon atoms; R¹² and R^{12′} each independently represent a hydrogen atom or a substituent substitutable in a benzene ring; L represents —S— or —CHR¹³— wherein R¹³ represents a hydrogen atom or an alkyl group having 1 to 20 carbon atoms; and X¹ and X¹′ each independently represent a hydrogen atom or a group substitutable in a benzene ring.

Detailed description is made on each of the substituents.

1) R¹¹ and R^{11′}

R¹¹ and R^{11′} each independently represent a substituted or unsubstituted alkyl group having 1 to 20 carbon atoms. Although the substituent of the alkyl group is not particularly limited, preferred examples thereof include an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, halogen atoms and the like.

2) R¹² and R¹²′, and X¹ and X^{1′}

R¹² and R^{12′} each independently represent a hydrogen atom or a group substitutable in a benzene ring.

X¹ and X^{1′}each independently represent a hydrogen atom or a group substitutable in a benzene ring. Preferred examples of the group substitutable in the benzene ring include an alkyl group, an aryl group, a halogen atom, an alkoxy group and an acylamino group. 3) L

L represents —S— or —CHR¹³—. R¹³ represents a hydrogen atom or an alkyl group having 1 to 20 carbon atoms, the alkyl group optionally having a substituent.

Specific examples of the unsubstituted alkyl group represented by R¹³ include a methyl group, an ethyl group, a propyl group, a butyl group, a heptyl group, an undecyl group, an isopropyl group, a 1-ethylpentyl group, a 2,4,4-trimethylpentyl group and the like.

Examples of the substituent of the alkyl group are the same as those of R11, including a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, a sulfamoyl group and the like.

4) Preferred Substituents

R¹¹ and R^{11′} may preferably be a secondary or tertiary alkyl group having 3 to 15 carbon atoms, specific examples of which include an isopropyl group, an isobutyl group, a t-butyl group, a t-amyl group, a t-octyl group, a cyclohexyl group, a cyclopentyl group, a 1-methylcyclohexyl group, a 1-methylcyclopropyl group and the like. R¹¹ and R^{11′} may more preferably be a tertiary alkyl group having 4 to 12 carbon atoms. Above all, a t-butyl group, a t-amyl group, and a1-methylcyclohexyl group are more preferred but the t-butyl group is most preferred.

R¹² and R^{12′} may preferably be an alkyl group having 1 to 20 carbon atoms, specific examples of which include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group and the like. More preferred are the methyl group, ethyl group, propyl group, isopropyl group and t-butyl group.

X¹ and X^{1′}may preferably be a hydrogen atom, a halogen atom or an alkyl group. More preferred is the hydrogen atom.

L may preferably be —CHR¹³—.

R¹³— may preferably be a hydrogen atom or an alkyl group having 1 to 15 carbon atoms. Preferred as the alkyl group are a methyl group, an ethyl group, a propyl group, an isopropyl group and a 2,4,4-trimethylpentyl group. Particularly preferred as R¹³ are the hydrogen atom, methyl group, propyl group and isopropyl group.

Where R¹³ is a hydrogen atom, R¹² and R^{12′} may preferably be an alkyl group having 2 to 5 carbon atoms, of which an ethyl group and a propyl group are more preferred. Most preferred is the ethyl group.

Where R¹³ is a primary or secondary alkyl group having 1 to 8 carbon atoms, R¹² and R^{12′} may preferably be a methyl group. As the primary or secondary alkyl group having 1 to 8 carbon atoms represented by R¹³, a methyl group, an ethyl group, a propyl group and an isopropyl group are more preferred, and the methyl, ethyl and propyl groups are still more preferred.

Where all of R¹¹, R¹¹, R¹² and R^{12′}are a methyl group, R¹³ may preferably be a secondary alkyl group. In this case, preferred as the secondary alkyl group represented by R¹³ are an isopropyl group, an isobutyl group and a 1-ethylpentyl group. More preferred is the isopropyl group.

The above reducing agent is varied in the heat-developing performance depending upon the combinations of R¹¹, R^{11′}; R¹², R^{12′}; and R¹³. The heat-developing performance may be adjusted by a combined use of two or more types of reducing agents in a varied mixing ratio thereof and hence, it is desirable to use two or more types of reducing agents according to a purpose.

While specific examples of the compound represented by the formula (R) according to the present invention are illustrated as below, it is to be noted that these specific examples do not limit the present invention.

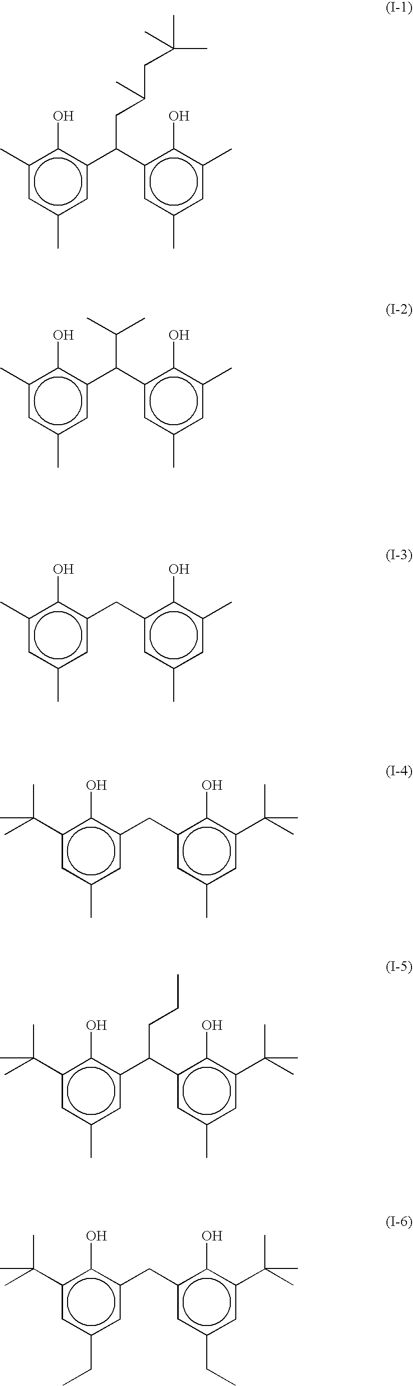

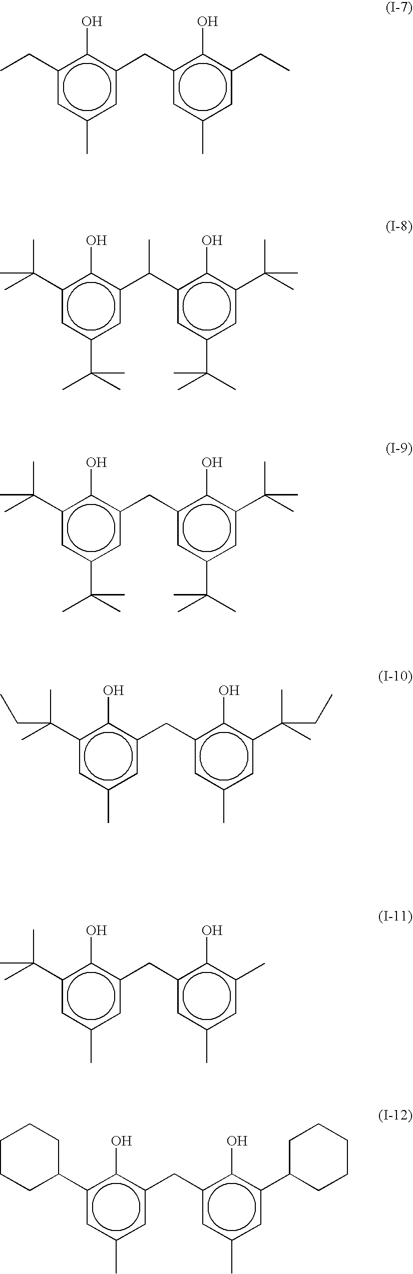

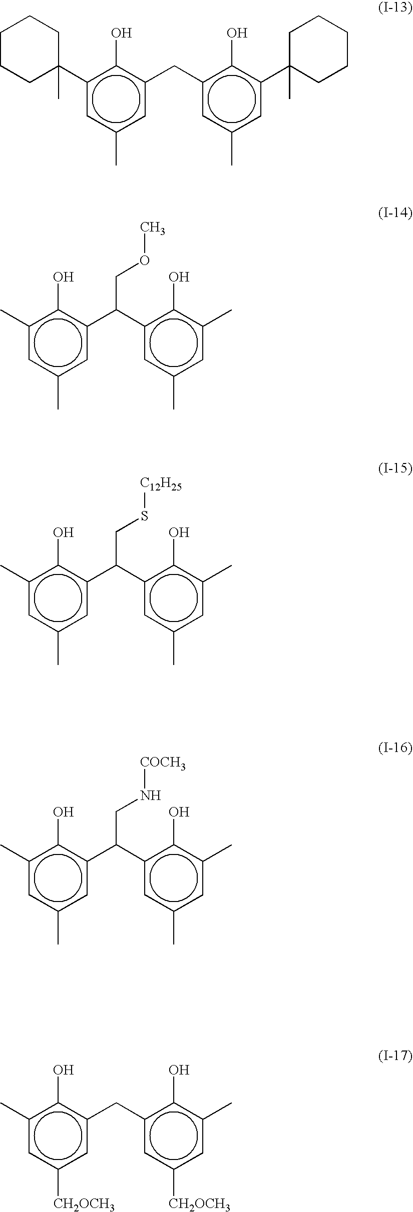

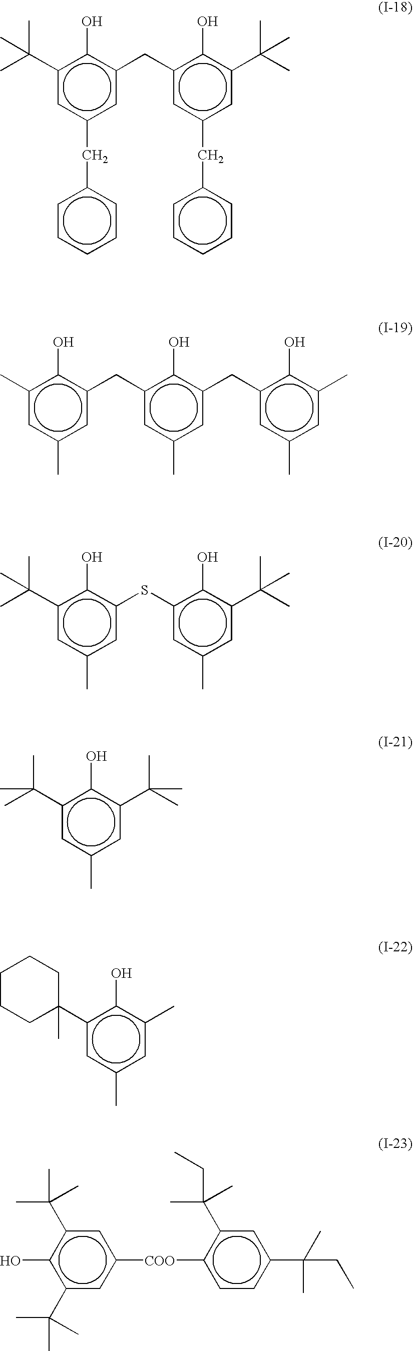

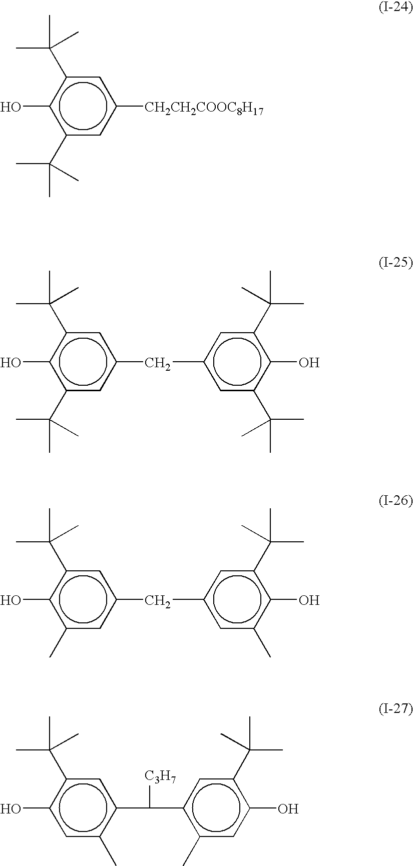

In particular, the compounds represented by the formulas (I-1) to (I-20) are preferred.

According to the present invention, the amount of the reducing agent is preferably in the range of 0.01 g/m² to 5.0 g/m², or more preferably of 0.1 g/m² to 3.0 g/m². The reducing agent is contained preferably in an amount of 5 mol % to 50 mol %, or more preferably of 10 mol % to 40 mol % per mol of silver present in the image formation layer side.

The reducing agent of the present invention may be added to any layers of the photothermographic material. However, it is preferred to add the reducing agent to the image formation layer containing the organic silver salt and photosensitive silver halide; and to layers adjacent thereto. More preferably, the reducing agent may be incorporated in the image formation layer.

The reducing agent of the present invention may be contained in the coating solution in any form of solution, emulsion dispersion, fine solid particles dispersion and the like, so as to be incorporated in the photosensitive material.

According to a well known emulsion dispersion method for mechanically preparing the emulsion dispersion, the reducing agent is dissolved in an oil, such as dibutyl phthalate, tricresyl phosphate, glyceryl triacetate or diethyl phthalte, and in an auxiliary solvent, such as ethyl acetate, cyclohexanone or the like.

On the other hand, the fine solid particles dispersion may be prepared by dispersing the reducing agent particles in a suitable solvent such as water by means of a ball mill, colloid mill, vibrating ball mill, sand mill, jet mill, roller mill or a supersonic disperser. A dispersion process using the sand mill is preferred. In this process, a protective colloid (such as polyvinyl alcohol), a surfactant (such as an anionic surfactant of sodium triisopropylnaphthalenesulfonate as a mixture of isomers differed in the substitution sites by three isopropyl groups) or the like may be used. A water-base dispersion may contain a preservative (such as sodium salt of benzoisothiazolinone).

Particularly preferred is the fine solid particles dispersion of the reducing agent, wherein the fine particles of reducing agent have a number average particle size of 0.01 μm to 10 μm, preferably of 0.05 μm to 5 μm, or more preferably of 0.1 μm to 1 μm. According to the present invention, it is preferred that a dispersion of another solid has a particle size in this range.

### 4. Description of Development Accelerator

The photothermographic material according to the present invention preferably employs, as a development accelerator, a sulfonamidophenol compound represented by a formula (A) set forth in JP-A Nos. 2000-267222, 2000-330234 and the like; a hindered phenol compound represented by a formula (II) set forth in JP-A No. 2001-92075; a hydrazine compound represented by a formula (I) set forth in JP-A Nos. 10-62895 and 11-15116 and the like and represented by a formula (1) set forth in JP-A No. 2002-278017; and a phenol or naphthol compound represented by a formula (2) set forth in JP-A No. 2001-264929. These development accelerator are each used in an amount of 0.1 mol % to 20 mol % based on the reducing agent. The amount of the development accelerator is preferably in the range of 0.5 mol % to 10 mol %, or more preferably of 1 mol % to 5 mol %. The development accelerator may be incorporated into the photosensitive material by the same method as the reducing agent. It is particularly preferred to admix the development accelerator as a solid dispersion or emulsion dispersion. Where the developer accelerator is admixed as an emulsion dispersion, it is preferred to prepare the emulsion dispersion using a solvent of high boiling point, which assumes a solid phase at normal temperatures, in combination with an auxiliary solvent of low boiling point, or otherwise to prepare a so-called oilless emulsion dispersion without using the solvent of high boiling point.

Among the aforementioned development accelerators of the present invention, the hydrazine compound represented by the formula (1) set forth in JP-A No. 2002-278017 and the naphthol compound represented by the formula (2) set forth in JP-A No. 2001-264929 are particularly preferred.

While specific examples of the development accelerator according to the present invention are illustrated as below, it is to be noted that these specific examples do not limit the present invention.

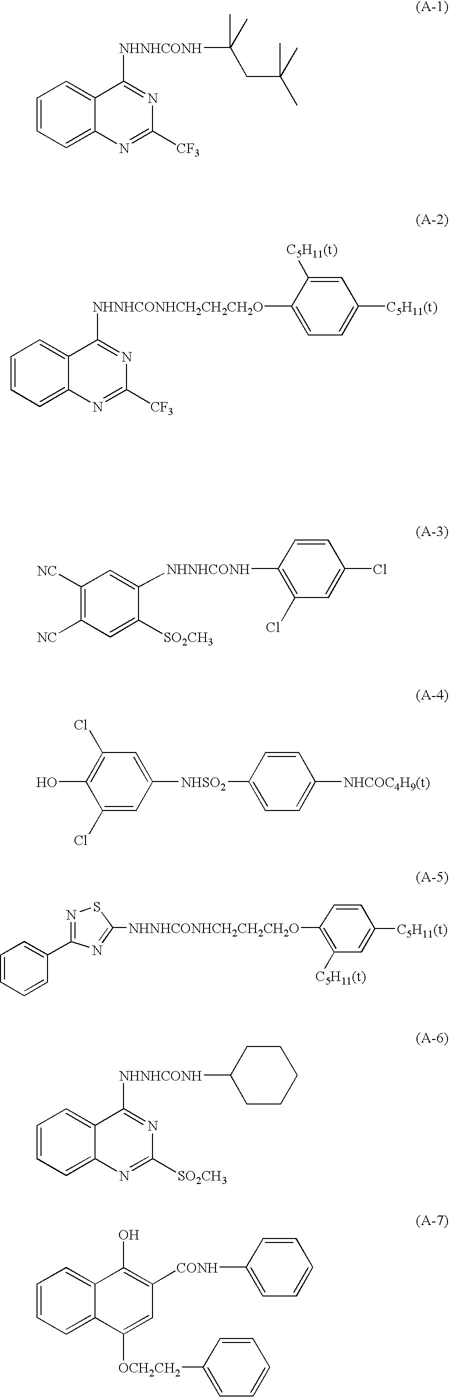

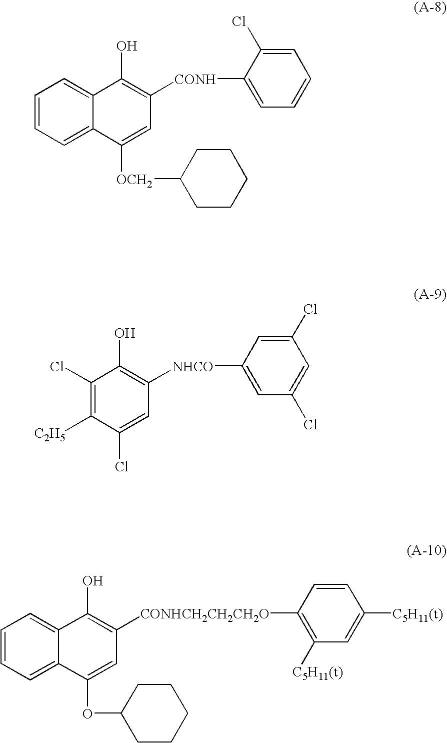

### 5. Description of Hydrogen-bonding Compound

In a case where the reducing agent according to the present invention has an aromatic hydroxyl group (—OH) or an amino group (—NHR, R representing a hydrogen atom or an alkyl group), or the reducing agent is the aforesaid bisphenol, in particular, a nonreducing compound having a group capable of forming a hydrogen bond together with such a group may preferably be used in combination.

Examples of the group forming the hydrogen bond together with the hydroxyl group or amino group include a phosphoryl group, a sulfoxide group, a sulfonyl group, a carbonyl group, an amide group, an ester group, a urethane group, a ureido group, a tertiary amino group, a nitrogen-containing aromatic group and the like. Among these, preferred compounds are those having a phosphoryl group, a sulfoxide group, an amide group (which is free from >N—H and blocked just like >N—Ra (Ra representing a substituent other than H)), a urethane group (which is free from >N—H and blocked just like >N—Ra (Ra representing a substituent other than H)) or a ureido group (which is free from >N—H and blocked just like >N—Ra (Ra representing a substituent other than H)).

According to the present invention, a particularly preferred hydrogen-bonding compound is represented by the following formula (D):

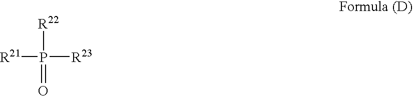

In the formula (D), R²¹ to R²³ each independently represent an alkyl group, an aryl group, an alkoxy group, an aryloxy group, an amino group or a heterocyclic group, which may be unsubstituted or substituted. Examples of a substituent of R²¹ to R²³ include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group and the like. Preferred substituents are the alkyl group and aryl group, examples of which include a methyl group, an ethyl group, an isopropyl group, a t-butyl group, a t-octyl group, a phenyl group, a 4-alkoxyphenyl group, a 4-acyloxyphenyl group and the like.

Specific examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, 1-methylcyclohexyl group, a benzyl group, a phenethyl group, a 2-phenoxypropyl group and the like. Specific examples of the aryl group include a phenyl group, a cresyl group, a xylyl group, a naphthyl group, a 4-t-butylphenyl group, a 4-t-octylphenyl group, a 4-anisidyl group, a 3,5-dichlorophenyl group and the like. Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group and the like. Examples of the aryloxy group include a phenoxy group, a cresyloxy group, an isopropylphenoxy group, a 4-t-butylphenoxy group, a naphthoxy group, a biphenyloxy group and the like. Examples of the amino group include a dimethylamino group, a diethylamino group, a dibutylamino group, a dioctylamino group, N-methyl-N-hexylamino group, a dicyclohexylamino group, a diphenylamino group, N-methyl-N-phenylamino group and the like.

Preferred as R²¹ to R²³ are the alkyl group, aryl group, alkoxy group and aryloxy group. In the light of the effect of the present invention, it is preferred that at least one of R²¹ to R²³ is the alkyl or aryl group. It is more preferred that 2 or more of R²¹ to R²³ are the alkyl or aryl group. From the standpoint of low material cost, it is preferred that R²¹ to R²³ are the same group.

While specific examples of the hydrogen-bonding compound including that represented by the formula (D) are illustrated as below, it is to be noted that these specific examples do not limit the present invention.

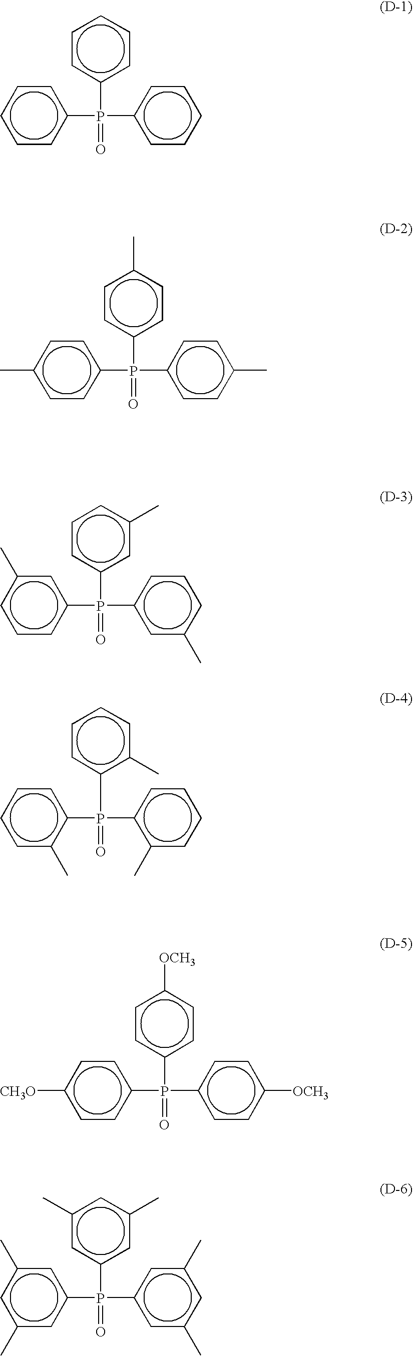

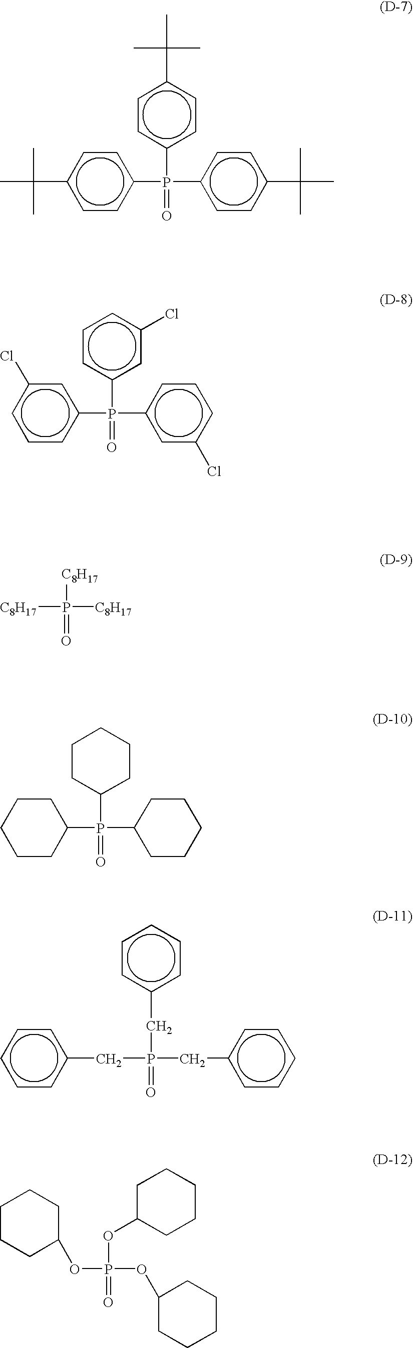

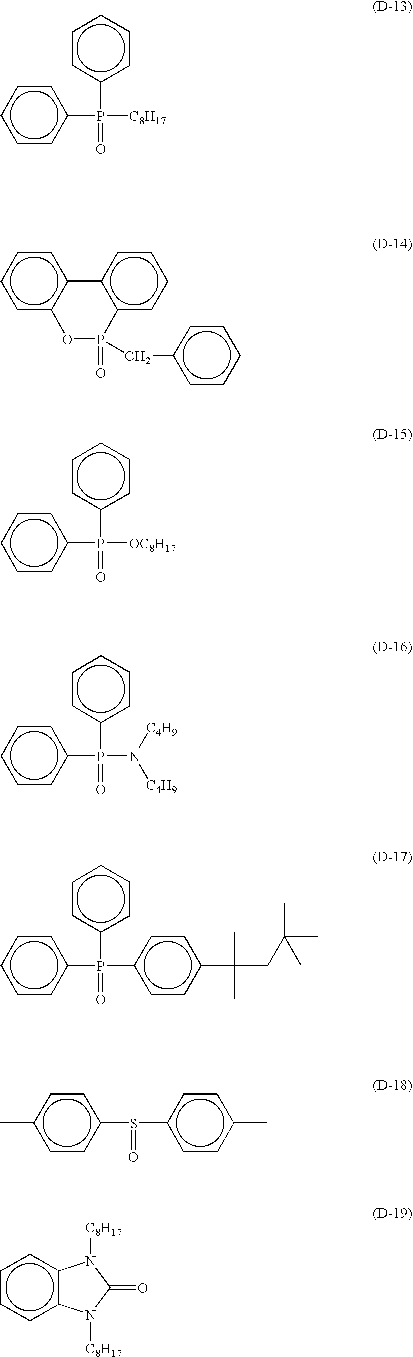

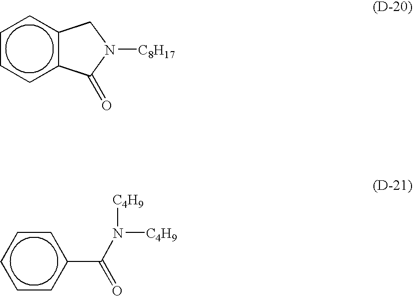

In addition to the above compounds, specific examples of the hydrogen-bonding compound include those set forth in EP-A No. 1096310 and 2002-318431.

Similarly to the reducing agent, the compound represented by the formula (D) and employed by the present invention may be contained in the coating solution in any form of solution, emulsion dispersion, fine solid particles dispersion or the like, so as to be incorporated in the photosensitive material. However, the compound may preferably be used in a solid dispersion. In a solution, the compound of the formula (D) forms a hydrogen-bonding complex with a compound having a phenolic hydroxyl group and hence, can be isolated as a complex in crystalline form depending upon the combination with the reducing agent used. The use of the crystal powder thus isolated as a dispersion of solid particles is particularly preferred for the provision of stable properties. Alternatively, a method may be preferably used which comprises mixing the reducing agent and the compound of the formula (D) in powder form, and then subjecting the mixture to dispersion with a proper dispersant in a sand grinder mill or the like thereby causing complexing.

The compound of the formula (D) is preferably used in an amount of 1 mol % to 200 mol %, more preferably of 10 mol % to 150 mol %, or still more preferably of 20 mol % to 100 mol % based on the reducing agent.

### 6. Description of Silver Halide

1) Halogen Composition

It is important that the photosensitive silver halide used in the present invention has a high content percentage of silver iodide in the range of 40 mol % to 100 mol %, while the remainder is not particularly limited and may be selected from the organic silver salts such as silver chloride, silver bromide, silver thiocyanate and silver phosphate. However, silver bromide or silver chloride is particularly preferred. The use of the silver halide having such a high silver iodide content allows for the design of a favorable photothermographic material excellent in the storability of developed image or, in particular, notably reduced in fogging associated with exposure to light.

The content percentage of silver iodide is preferably in the range of 80 mol % to 100 mol %, particularly preferably of 85 mol % to 100 mol %, or extremely preferably of 90 mol % to 100 mol % from the viewpoint of good storability of the processed image against exposure to light.

The distribution of halogen composition in the photosensitive silver halide particle may be uniform, or varied stepwise or continuously. A silver halide particle having a core/shell structure may preferably be employed. The core/shell structure may preferably have a double to quintuple structure, or more preferably a double to quadruple structure. Also preferred is a core high silver-iodide structure wherein the content percentage of silver iodide is higher in a core portion than in a shell portion, or a shell high silver-iodide structure wherein the content percentage of silver iodide is higher in the shell portion than in the core portion. Furthermore, there may preferably be used a technique for localizing silver chloride or silver bromide on the particle surface to define an epitaxial portion thereat. It is also preferred that the silver halide particle contains a dislocation line or a lattice defect.

2) Particle Size

The particle size is a particularly important feature of the silver halide having a high content of silver iodide which is used in the present invention. If the silver halide is too great in the particle size, the silver halide must be applied in an increased amount in order to achieve a maximum optical density required. The present inventors have found the following facts. If the silver halide having a high content of silver iodide, which is preferably used in the present invention, is applied in a large amount, the photosensitive material is decreased in photosensitivity with the developing performance thereof seriously decreased, and is also deteriorated in density stability with respect to development time. Consequently, the silver halide particles greater than a given size cannot afford the maximum optical density in a predetermined development time. On the other hand, if used in a limited amount, silver iodide can provide a sufficient developing performance.

In a case where the silver halide having a high silver iodide content is used, the silver halide particles must have a much smaller size than the conventional silver bromide particles or silver iodide particles having a low iodine content, in order to fully achieve the maximum optical density. A preferred particle size of the silver halide is in the range of 5 nm to 70 nm, or more preferably of 5 nm to 55 nm. A particularly preferred particle size of the silver halide is in the range of 10 nm to 45 nm. The particle size is defined herein as an average diameter of a circle image having an equal area to that of a projected area of the particle determined by means of an electron microscope.

3) Coating Amount

A coating amount of such silver halide particles is in the range of 0.5 mol % to 15 mol %, preferably of 0.5 mol % to 12 mol %, or more preferably of 0.5 mol % to 10 mol % per mol of silver of the non-photosensitive organic silver salt to be described hereinlater. The coating amount of the silver halide particles is still more preferably in the range of 1 mol % to 9 mol %, or particularly preferably of 1 mol % to 7 mol %. The selection of the coating amount of silver halide having a high silver iodide content is extremely important in avoiding the seriously decreased developing performance by such a silver halide.

4) Particle Formation Method

Methods for forming the photosensitive silver halide particles are well known in the art. For instance, methods disclosed in Research Disclosure No. 17029, June 1978, and U.S. Pat. No. 3,700,458 may be used. Specifically, a method may be used which comprises adding a silver supplying compound and a halogen supplying compound to a solution of gelatin or another polymer thereby preparing a photosensitive silver halide, and then mixing the photosensitive silver halide with an organic silver salt. Other preferred methods are disclosed in JP-A No. 11-119374, paragraphs 0217 to 0224, JP-A No. 11-352627 and 2000-347335.

5) Particle Shape

Exemplary shapes of the silver halide particles include cubic particles, octahedral particles, tetradecahedral particles, dodecahedral particles, tabular particles, spherical particles, rod-like particles, potato-like particles and the like. Particularly preferred are the dodecahedral particles, tetradecahedral particles and tabular particles. The silver halide particles having a high content of silver iodide according to the present invention may take a complicated configuration. A preferred particle configuration is exemplified by combined particles set forth in R. L. JENKINS et.al. J of Phot. Sci. Vol.28 (1980) p164-FIG. 1. Platelet particles as shown in FIG. 1 of the above publication may also preferably be used. Silver halide particles corners of which are rounded are also preferred. Although the index of plane (Miller index) of outer surfaces of the photosensitive silver halide particles is not particularly limited, it is preferred that [100] planes presenting a high spectral sensitization efficiency upon adsorption of a spectral sensitizing dye account for a large proportion. The percentage of the [100] planes is preferably at least 50%, more preferably at least 65%, or still more preferably at least 80%. The percentage of a plane with a Miller index of [100] can be determined by a method set forth in T. Tani, J, Imaging Sci., 29,165 (1985), which is based on the plane dependency of adsorption of the sensitizing dye between [111] and [100] planes. 6) Heavy Metal The silver halide particles of the present invention may contain any of metals of groups 8 to 10 of the periodic table (including the groups 1 to 18) or a complex thereof. Preferred examples of a central metal in the metal belonging to the groups 8 to 10 of the periodic table or in the complex thereof include rhodium, ruthenium and iridium. These metal complexes may be used alone or in combination of two or more of the same type or of different types. The content of the metal complex is preferably in the rang of 1×10⁻⁹ mol to 1×10⁻³ mol per mol of silver. The details of these heavy metals and complexes thereof as well as addition methods thereof are taught in JP-A No. 7-225449, JP-A No. 11-65021, paragraphs 0018 to 0024, and JP-A No. 11-119374, paragraphs 0227 to 0240.

According to the present invention, a silver halide particle having a hexacyano metal complex present on the outermost surface thereof is preferred. Examples of such a hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻, and the like. According to the present invention, a hexacyano Fe complex is preferred.

Since such a hexacyano metal complex occurs in the form of ion in an aqueous solution, the counter cation is not important. However, a cation miscible with water and suitable for the precipitation of silver halide emulsion may preferably used. Examples of such a cation include alikali metal ions such as sodium ion, potassium ion, rubidium ion, cesium ion and lithium ion; ammonium ion; and alkyl ammonium ions such as tetramethyl ammonium ion, tetraethyl ammonium ion, tetrapropyl ammonium ion and tetra(n-butyl) ammonium ion.

The hexacyano metal complex may be added in admixture with a solvent mixture of water and a suitable organic solvent miscible with water (such as an alcohol, an ether, a glycol, a ketone, an ester and an amide) or with gelatin.

The amount of the hexacyano metal complex is preferably in the range of 1×10⁻⁵ mol to 1×10⁻² mol, or more preferably of 1×10⁻⁴ mol to 1×10⁻³ mol per mol of silver.

The hexacyano metal complex may be localized in the outermost surface of the silver halide particles as follows. After the termination of addition of an aqueous solution of silver nitrate to be used for particle formation, the hexacyano metal complex is directly added to the solution mixture before the termination of charging step preceding chemical sensitization where chalcogen sensitization such as sulfur sensitization, selenium sensitization and tellurium sensitization, or noble metal sensitization such as gold sensitization is carried out; during rinsing step; during dispersion step or before the chemical sensitization step. For inhibition of the growth of fine particles of silver halide, the hexacyano metal complex may preferably be added immediately after the particle formation. Hence, it is preferred to add the hexacyano metal complex prior to the termination of the charging step.

The addition of the hexacyano metal complex may be started when 96 wt % of the total amount of silver nitrate for particle formation has been added, more preferably when 98 wt % of the total amount thereof has been added, or particularly preferably when 99 wt % of the total amount thereof has been added.

If the hexacyano metal complex is added following the addition of the aqueous solution of silver nitrate just before the completion of particle formation, the hexacyano metal complex can be adsorbed to the outermost surfaces of the silver halide particles so that the most of the hexacyano metal complex combines with silver ions on the particle surfaces to form poorly soluble salt. Since the silver salt of hexacyano ferric iron (II) is less soluble than AgI, the redissolution by fine particles is prevented. This permits the preparation of the silver halide particles further reduced in size.

Details of metal atoms to be incorporated in the silver halide particles used in the present invention, methods for desalting the silver halide emulsion and chemical sensitizing methods are set forth in JP-A No. 11-84574, paragraphs 0046 to 0050, JP-A No. 11-65021, paragraphs 0025 to 0031, and JP-A No. 11-119374, paragraphs 0242 to 0250.

7) Gelatin

Various types of gelatins may be used as one to be incorporated in the photosensitive silver halide emulsion used by the present invention. It is preferred to use a low molecular weight gelatin having a molecular weight of 500 to 60,000 in order to maintain the photosensitive silver halide emulsion favorably dispersed in a coating solution containing the organic silver salt. The molecular weight is defined herein as number average molecular weight determined by gel permeation chromatography (GPC) using styrene standard. Such a low molecular weight gelatin may be used during the particle formation step or the dispersion step following the desalting step. However, it is preferred to use the gelatin during the dispersion step following the desalting step.

8) Chemical Sensitization

The photosensitive silver halide used in the present invention may not be chemically sensitized. However, it is preferred that the silver halide is chemically sensitized by at least one of the processes of chalcogen sensitization, gold sensitization and reduction sensitization. Examples of the chalcogen sensitization process include sulfur sensitization, selenium sensitization and tellurium sensitization.

The sulfur sensitization uses an unstable sulfur compound, examples of which are set forth in P. Grafkides, Chimie et Physique Photographique (Paul Momtel, 5th edition 1987), and Research Disclosure Vol.307 No. 307105.

Specific examples of the unstable sulfur compound include thiosulfates such as hypo; thioureas such as diphenylthiourea, triethylthiourea, N-ethyl-N′-(4-methyl-2-thiazolyl)thiourea and carboxymethyltrimethylthiourea; thioamides such as thioacetamide; rhodanines such as diethyl rhodanine and 5-benzylidene-N-ethyl rhodanine; phosphinesulfides such as trimethyl phosphinesulfide; thiohydantoins; 4-oxo-oxazolidine-2-thiones; disulfides or polysulfides such as dimorpholindisulfide, cystine, lenthionine(1,2,3,5,6-pentathiepane); polythionates; known sulfur compounds such as sulfur in elemental form; and active gelatin. Above all, the thiosulfates, thioureas and rhodanines are preferred.

The selenium sensitization uses an unstable selenium compound, examples of which are set forth in JP-B Nos. 43-13489 and 44-15748; JP-A Nos. 4-25832, 4-109340, 4-271341, 5-40324, 5-11385, 6-051415, 6-175258, 6-180478, 6-208186, 6-208184, 6-317867, 7-092599, 7-098483 and 7-140579; and the like.

Specific examples of the unstable selenium compound include colloidal metal selenium; selenoureas such as N,N-dimethyl selenourea, trifluoromethylcarbonyl-trimethyl selenourea, acetyl-trimethyl selenourea; selenoamides such as selenoamide, N,N-diethylphenylselenoamide; phosphineselenides such as triphenyl phosphineselenide, pentafluorophenyl-triphenyl phosphineselenide; selenophosphates such as tri-p-tolyl selenophospate, tri-n-butyl selenophosphate; selenoketones such as selenobenzophenone; isoselenocyanates; selenocarboxylic acids; selenoesters; diacylselenides and the like. Furhtermore, also preferred are non-unstable selenium compunds such as disclosed in JP-B Nos. 46-4553 and 52-34492, which include, for example, selenious acid, selenocyanate, selenazoles, selenides and the like. Above all, the phosphineselenides, selenoureas and selenocyanate are particularly preferred.

The tellurium sensitization uses an unstable tellurium compund, examples of which are set forth in JP-A Nos. 4-224595, 4-271341, 4-333043, 5-303157, 6-27573, 6-175258, 6-180478, 6-208186, 6-208184, 6-317867, 7-140579, 7-301879, 7-301880 and the like.

Specific examples of the unstable tellurium compound include phosphinetellurides such as butyl-diisopropyl phosphinetelluride, tributyl phosphinetelluride, tributoxyphosphinetelluride, ethoxy-diphenyl phosphinetelluride; diacyl(di)tellurides such as bis(diphenylcarbamoyl)ditelluride, bis(N-phenyl-N-methylcarbamoyl)ditelluride, bis(N-phenyl-N-methylcarbamoyl)telluride, bis(N-phenyl-N-benzylcarbamoyl)telluride, bis(ethoxycarbonyl)telluride; telluroureas such as N,N′-dimethylethylene tellurourea, N,N′-diphenylethylene tellurourea; telluroamides; telluroesters and the like. In particular, the diacyl(di)tellurides and phosphinetellurides are preferred. More preferred are compounds set forth in JP-A No. 11-65021, paragraph 0030, and compounds represented by general formulas (II), (III) and (IV) in JP-A No. 5-313284.

In the chalcogen sensitization according to the present invention, the selenium sensitization and tellurium sensitization are preferred, and the tellurium sensitization is particularly preferred.

The gold sensitization may use gold sensitizers set forth in P. Grafkides, Chimie et Physique Photographique (Paul Momtel, 5th edition 1987), and Research Disclosure Vol.307 No. 307105. Specific examples of the gold sensitizer include chloroauric acid, potassium chloroaurate, potassium aurithiocyanate, gold sulfide, gold selenide and the like. In addition, gold compounds disclosed in U.S. Pat. Nos. 2,642,361, 5,049,484, 5,049,485, 5,169,751 and 5,252,455; Belgian Patent No. 691857 and the like are also usable. Besides the gold compounds, there may be also used salts of noble metals such as platinum, palladium and iridium, which are set forth in P. Grafkides, Chimie et Physique Photographique (Paul Momtel, 5th edition 1987), and Research Disclosure Vol.307 No. 307105.

Although the gold sensitization may be used alone, it is preferred to use the gold sensitization in combination with the chalcogen sensitization. Specifically, gold-sulfur sensitization, gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization may be used.

According to the present invention, the chemical sensitization may be carried out at any time between the particle formation and the application of coating solution. That is, after the desalting step, the chemical sensitization may be performed (1) before spectral sensitization step, (2) in parallel with the spectral sensitization step, (3) after the spectral sensitization step, or (4) just before the application of coating solution.

The amount of the chalcogen sensitizer to be used according to the present invention varies depending upon the silver halide particles to be used or the chemical ripening conditions, but is in the range of 10⁻⁸ to 10⁻¹ mol, or preferably of 10⁻⁷ to 10⁻² per mol of silver halide.

Likewise, the amount of gold sensitizer to be added according to the present invention also varies according to various conditions. For reference, the addition amount is in the range of 10⁻⁷ mol to 10⁻² mol, or more preferably of 10⁻⁶ mol to 5×10⁻³ mol per mol of silver halide.

Any conditions may be selected as environment for the chemical sensitization. The pAg level may be 8 or less, preferably 7.0 or less, more preferably 6.5 or less or particularly preferably 6.0 or less, and may be 1.5 or more, preferably 2.0 or more, or particularly preferably 2.5 or more. The pH value may be in the range of 3 to 10 or preferably of 4 to 9, whereas the temperature may be in the range of 20 to 95° C., or preferably of 25 to 80° C.

According to the present invention, the chalcogen sensitization and gold sensitization may be used in combination with reduction sensitization. It is particularly preferred to use the reduction sensitization in combination with the chalcogen sensitization.

Preferred examples of a specific compound used in the reduction sensitization process include ascorbic acid, thiourea dioxide and dimethylamineborane. Other preferred compounds include stannous chloride, aminoiminomethane sulfinate, hydrazine derivatives, borane compounds, silane compounds, polyamine compounds and the like. The reduction sensitizer may be added at any step of the photosensitive emulsion preparation process between crystal growth and immediately before the application of coating solution. The reduction sensitization may preferably be effected by ripening the particles with the emulsion maintained at a pH of 8 or more and at a pAg of 4 or less. Alternatively, the reduction sensitization may preferably be performed through introduction of single addition of silver ions during particle formation.

The amount of the reduction sensitizer to be added also varies according to various conditions. For reference, the addition amount is in the range of 10⁻⁷ mol to 10⁻¹ mol, or more preferably of 10⁻⁶ mol to 5×10⁻² mol per mol of silver halide.

The silver halide emulsion used according to the present invention may be added with a thiosulfonate compound according to a method taught in EP-A No. 293,917.

Although the photosensitive silver halide particles according to the present invention may not be chemically sensitized, it is preferred from the standpoint of designing a photothermographic material of high sensitivity that the silver halide particles are chemically sensitized by at least one of gold sensitization and chalcogen sensitization.

9) Sensitizing Dye

As a sensitizing dye applicable to the present invention, an advantageous sensitizing dye may be selected which is capable of spectrally sensitizing the silver halide particles within a desired spectral wavelength range as adsorbed thereon and has spectral sensitivity suited to the spectral characteristics of a light source. The photothermographic material of the present invention is preferably spectrally sensitized in the wavelength range of 600 nm to 900 nm or preferably of 300 nm to 500 nm. Examples of a preferred sensitizing dye and addition method thereof include compounds set forth in JP-A No. 11-65021, paragraphs 0103 to 0109; a compound represented by a general formula(II) in JP-A No. 10-186572; a dye represented by a formula (I) in JP-A No. 11-119374 and examples thereof set forth in paragraph 0106; dyes set forth in U.S. Pat. Nos. 5,510,236 and 3,871,887, Example 5; dyes disclosed in JP-A Nos. 2-96131 and 59-48753; and those set forth in EP-A No. 0803764A1, page 19, line 38 to page 20, line 35 and JP-A Nos. 2001-272747, 2001-290238 and 2002-023306. These sensitizing dyes may be used alone or in combination of two or more types. According to the present invention, the sensitizing dye is preferably added to the silver halide emulsion at any time during a period between the desalting step and the application of coating solution, or more preferably between the desalting step and the termination of chemical ripening.

The sensitizing dye of the present invention may be added in a desired amount according to the performance of the photosensitive material including photosensitivity and fogging. The addition amount is preferably in the range of 10⁻⁶ mol to 1 mol or more preferably of 10⁻⁴ mol to 10⁻¹ mol per mol of silver halide present in the image formation layer.

The present invention may use a super-sensitizer for increasing the spectral sensitization efficiency. Examples of the super-sensitizer used by the present invention include compounds set forth in EP-A No. 587,338, U.S. Pat. Nos. 3,877,943 and 4,873,184, and JP-A Nos. 5-341432, 11-109547 and 10-111543.

10) Combined Use of Silver Halide

In the photothermographic material of the present invention, the photosensitive silver halide emulsion may be used alone or in combination of two or more types (for example, those having different average particle sizes, different halogen compositions, different seams or different chemical sensitization conditions). The use of plural types of photosensitive silver halides having different photosensitivities provides for gradation control. Related techniques are disclosed in, for example, JP-A Nos. 57-119341, 53-106125, 47-3929, 48-55730, 46-5187, 50-73627, 57-150841 and the like. A sensitivity difference among individual emulsions may preferably be 0.2 logE or more.

11) Mixing of Silver Halide and Organic Silver Salt

It is particularly preferred that the photosensitive silver halide particles of the present invention are formed and chemically sensitized in the absence of the non-photosensitive organic silver salt. This is because a method of forming the silver halide by adding a halogenating agent to the organic silver salt may sometimes fail to achieve a sufficient sensitivity.

There are plural methods for mixing the silver halide with the organic silver salt. One exemplary method uses a high-speed stirrer, ball mill, sand mill, colloid mill, vibrating mill, homogenizer or the like to blend together the photosensitive silver halide and organic silver salt which are independently prepared. In an alternative method, a prepared photosensitive silver halide is admixed to an organic silver salt at any point of time during the preparation of the organic silver salt. Any of the above methods may preferably afford the effect of the present invention.

12) Addition of Silver Halide to Coating Solution

A preferred time to admix the silver halide of the present invention to a coating solution for image formation layer is at any point of time between 180 minutes ahead of the application of the coating solution and just before the application thereof, or preferably between 60 minutes ahead of the application of the coating solution and 10 seconds ahead of the application thereof. However, the mixing method and mixing conditions are not particularly limited so long as the effect of the present invention is fully attained. Specifically, the silver halide may be admixed with the coating solution in a tank wherein an average dwell time is set to a desired value, the average dwell time calculated from an addition flow rate of the silver halide and a feed volume to a coater. Alternatively, a static mixer may be used, which is set forth in Chapter 8 of “Liquid Mixing Technique” by N. Harnby, M. F. Edwards and A. W. Nienow, translated by Koji Takahashi, published by Nikkan Kogyo Shinbun-sha (1989).

### 7. Description of Surfactant

Said fluorine compound of the present invention may be used in combination with another surfactant. Various types of surfactants such as an anionic surfactant, a cationic surfactant and a nonionic surfactant may be used in combination with the fluorine compound. The surfactant for combined use may be a fluorine interfacial activating agent other than the above specific fluorine compounds. As such a surfactant, the anionic and nonionic surfactants are more preferred.

Examples of a usable surfactant are those set forth in JP-A No. 62-215272, pages 649 to 706; Research Disclosure (RD) Item 17643, pages 26 to 27 (December, 1978), Item 18716, page 650 (November, 1979), and Item 307105, pages 875 to 876 (November, 1989); and the like.

### 8. Description of Binder

The image formation layer of the photosensitive material of the present invention may employ any polymer as a bider. A suitable binder is transparent or translucent and generally colorless, and includes naturally occurring resins, polymers and copolymers; synthetic resins, polymers and copolymers; and other film forming media. Examples of a usable binder material include gelatins; rubbers; poly(vinyl alcohol)s; hydroxyethyl celluloses; cellulose acetates; cellulose acetate butyrates; poly(vinylpyrrolidone)s; casein; starch; poly(acrylate)s; poly(methyl methacrylate) s; poly(vinyl chloride)s; poly(methacrylate)s; styrene-maleic anhydride copolymers; styrene-acrylonitrile copolymers; styrene-butadiene copolymers; poly(vinylacetal)s, such as poly(vinylformal) and poly(vinylbutyral); poly(ester)s; poly(urethane)s; phenoxy resins; poly(vinylidene chloride)a; poly(epoxide)s; poly(carbonate)s; poly(vinylacetate)s; poly(olefin)s; cellulose esters; and poly(amide)s. The binder may be dissolved in water, an organic solvent or emulsion so as to be applied for forming the image formation layer.

As required, two or more types of binders may be used in combination. In this case, two or more polymers having different glass transition points (hereinafter, referred to as “Tg”) may be blended together.

In this specification, the Tg value is calculated based on the following equiation:

1/Tg=Σ(Xi/Tgi)

It is assumed herein that n monomer components (i=1 to n) are copolymerized to form the polymer. Xi represents a weight percentage of an i-th monomer (ΣXi=1), whereas Tgi represents a glass transition point (absolute temperature) of a homopolymer of the i-th monomer. It is noted that Σ is the sum from i=1 to i=n. The value of the glass transition point of homopolymer of each monomer (Tgi) is based on the value set forth in Polymer Handbook (3rd Edition) by J. Brandrup and E. H. Immergut (Wiley-Interscience, 1989).

In a case where an organic solvent is used as a solvent for the coating solution, the binder may be any one selected from the group consisting of polyvinyl acetal, polyvinyl chloride, polyvinyl acetate, cellulose acetate, polyolefin, polyester, polystyrene, polycrylonitrile, polycarbonate, polyvinyl butyral, butyl ethyl cellulose, methacrylate copolymer, maleate anhydride-ester copolymer, polystyrene, butadiene-styrene copolymer and the like. The image formation layer, in particular, may preferably contain polyvinyl butyral as the binder. Specifically, polyvinyl butyral as the binder is used in an amount of at least 50 wt % based on the overall binder composition for the image formation layer. As a matter of course, a copolymer and a terpolymer are contained. A preferred total amount of polyvinyl butyral is in the range of 50 wt % to 100 wt %, or more preferably of 70 wt % to 100 wt % based on the overall binder composition for the image formation layer. The Tg of the binder is preferably in the range of 40° C. to 90° C., or more preferably of 50° C. to 80° C. Where two or more types of polymers having different Tg values are blended together, a weight average Tg of the polymers may preferably be in the above range.

The total amount of the binder should be sufficient for retaining the components of the image formation layer therein. That is, the binder is used in such an amount effective to function as the binder. The range of an effective amount of the binder resin may suitably decided by those skilled in the art. For reference as to a case where at least the organic silver salt is retained by the binder, a weight ratio between the binder and the organic silver salt to be blended together is preferably in the range of 15:1 to 1:3, or particularly preferably of 8:1 to 1:2.

In a case where a water-base solvent is used as the solvent for coating solution, a polymer having a low moisture content is preferably used as the binder. Therefore, in a case where the image formation layer is formed using a coating solution wherein water accounts for 30 wt % or more of the solvent, it is preferred to use a polymer latex having an equilibrium moisture content of 2 wt % or less at 25° C. and 60% RH. A polymer latex in the most preferred mode is so prepared as to have an ion conductivity of 2.5 mS/cm or less. Such a polymer latex may be obtained by purifying a synthesized polymer by means of a separation function membrane. The Tg value of the binder in the water-base solvent is preferably in the range of −20° C. to 80° C., more preferably of 0C to 70° C., or still more preferably of 10° C. to 60° C. Similarly to the case where the organic solvent is used for the coating solution, when two or more types of polymers having different Tg values are used in the water-base solvent, a weight average Tg of the polymers is preferably in the above range.

The water-base solvent capable of dissolving or dispersing the polymer is water or a mixture of water and 70 wt % or less of water-miscible organic solvent. Examples of a water-miscible organic solvent include alcohols such as methyl alcohol, ethyl alcohol and propyl alcohol; cellosolves such as methyl cellosolve, ethyl cellosolve and butyl cellosolve; ethyl acetate; dimethylformamide and the like.

The equilibrium moisture content at 25° C. and 60% RH can be expressed by the following equation wherein W1 represents the weight of a polymer adjusted to an equilibrium moisture content in the environment of 25° C. and 60% RH, and WO represents the weight of the polymer in a bone dry state at 25° C.:

Equilibrium moisture content at 25° C. and 60% RH={(W1−W0)/W0}×100 (wt %) As to the definition and measurement method of the moisture content, reference may be made to “Kobunshi Zairyo Shiken-ho (Test Methods for Polymer Materials)” in the series of “Kobunshi Kougaku Koza 14 (Polymer Engineering Course 14)” edited by Polymer Society, published by Chijin Shokan.

The binder polymer according to the present invention may preferably have an equilibrium moisture content of 2 wt % or less at 25° C. and 60% RH, more preferably of 0.01 wt % to 1.5 wt %, or still more preferably of 0.02 wt % to 1 wt %.

The binder polymer may take the following exemplary dispersion forms. Hydrophobic polymer particles insoluble to water may be dispersed to form a latex. Otherwise, polymer molecules may be dispersed as they are or as micells. However, it is more preferred that the polymer particles are dispersed to form the latex. The number average particle size of the dispersed particles is in the range of 1 nm to 50000 nm, preferably of 5 nm to 1000 nm, more preferably of 10 nm to 500 nm, or still more preferably of 50 nm to 200 nm. The particle-size distribution of the dispersed particles is not particularly limited. Both the polymer particles having a broad particle-size distribution and the polymer particles having a particle-size distribution of monodispersion are usable. A mixture containing two or more types of polymer particles having the particle-size distribution of monodispersion is also preferred from the standpoint of controlling the physical properties of the coating solution.

Preferred examples of the polymer dispersible in the water-base solvent include hydrophobic polymers such as acrylic polymers; poly(ester)s; rubbers (e.g., SBR resin); poly(urethane)s; poly(vinyl chloride)s; poly(vinyl acetate)s; poly(vinylidene chloride)s; and poly(olefin)s. These polymers may be linear, branched or crosslinked. The polymers may be a so-called homopolymer consisting of a single type of monomers or a copolymer including two or more types of monomers. The copolymer may be a random copolymer or a block copolymer. These polymers may have a number average molecular weight of 5000 to 1000000, or preferably of 10000 to 200000. Having too small a molecular weight, the polymer forms an image formation layer poor in mechanical strength. Having an excessive molecular weight, the polymer is detrimentally low in film forming performance. On the other hand, a crosslinking polymer latex is particularly preferred.

While specific examples of the favorable polymer dispersible in the water-base solvent are illustrated as below, it is to be noted that these specific examples do not limit the present invention. The polymers are expressed by way of source monomer. Numerals in parentheses represent contents in wt %, whereas the molecular weight is represented by number average molecular weight. A multifunctional monomer is described as “crosslinking” and the description of the molecular weight thereof is omitted, because the multifunctional monomer forms a crosslinking structure so that the concept of molecular weight is inapplicable.

P-1; latex of -MMA(70)-EA(27)-MAA(3)-(molecular weight: 37000, Tg: 61° C.)

P-2; latex of -MMA(70)-2EHA(20)-St(5)-AA(5)-(molecular weight: 40000, Tg: 59° C.)

P-3; latex aof -St(50)-Bu(47)-MAA(3)-(crosslinking, Tg: −17° C.)

P-4; latex of -St(68)-Bu(29)-AA(3)-(crosslinking, Tg: 17° C.)

P-5; latex of -St(71)-Bu(26)-AA(3)-(crosslinking, Tg: 24° C.)

P-6; latex of -St(70)-Bu(27)-IA(3)-(crosslinking)

P-7; latex of -St(75)-Bu(24)-AA(1)-(crosslinking, Tg: 29° C.)

P-8; latex of -St(60)-Bu(35)-DVB(3)-MAA(2)-(crosslinking)

P-9; latex of -St(70)-Bu(25)-DVB(2)-AA(3)-(crosslinking)

P-10; latex of -VC(50)-MMA(20)-EA(20)-AN(5)-AA(5) (molecular weight: 80000)

P-11; latex of -VDC(85)-MMA(5)-EA(5)-MAA(5)-(molecular weight: 67000)

P-12; latex of -Et(90)-MMA(10)-(molecular weight: 12000)

P-13; latex of -St(70)-2EHA(27)-AA(3)-(molecular weight: 130000, Tg: 43° C.)

P-14; latex of -MMA(63)-EA(35)-AA(2)-(molecular weight: 33000, Tg: 47° C.)

P-15; latex of -St(70.5)-Bu(26.5)-AA(3)-(crosslinking, Tg: 23° C.)

P-16; latex of -St(69.5)-Bu(27.5)-AA(3)-(crosslinking, Tg: 20.5° C.)

The abbreviations of the above structures represent the following monomers: MMA; methylmethacrylate, EA; ethyl acrylate, MAA; methacrylic acid, 2EHA; 2-ethylhexyl acrylate, St; styrene, Bu; butadiene, AA; acrylic acid, DVB; divinylbenzene, VC; vinyl chloride, AN; acrylonitrile, VDC; vinylidene chloride, Et; ethylene, and IA; itaconic acid.

The aforementioned polymer latexes are also commercially available and the following polymers are available. Examples of acrylic polymer include CEBIAN A-4635, 4718 and 4601 (available from Dicel Kagaku Kogyo K.K.); Nipol Lx811 , 814, 821, 820 and 857 (available from Zeon Co.) and the like. Examples of poly(ester) include FINETEX ES650, 611, 675 and 850 (available from Dai-Nippon Ink & Chemicals, Inc.); WD-size, WMS (available from Eeastman Chemical) and the like. Examples of poly(urethane) include HYDRAN AP10, 20, 30 and 40 (available from Dai-Nippon Ink & Chemicals, Inc.) and the like. Examples of rubber include LACSTAR 7310K, 3307B, 4700H and 7132C (available from Dai-Nippon Ink & Chemicals, Inc.); Nipol Lx416, 410, 438C and 2507 (available from Zeon Co.) and the like. Examples of poly(vinyl chloride) include G351 and G576 (available from Zeon Co.) and the like. Examples of poly(vinylidene chloride) include L502 and L513 (available from Asahi kasei Co., Ltd.) and the like. Examples of poly(olefin) include CHEMIPEARL S120 and SA100 (available from Mitsui Chemicals, Inc.) and the like.

These polymer latexes may be used alone or in combination of two or more types as required.

As the polymer dispersible in the water-base solvent, the styrene-butadiene copolymer is particularly preferred. A weight ratio between a styrene monomer unit and a butadiene monomer unit in the styrene-butadiene copolymer is preferably in the range of 40:60 to 95:5. A proportion of the styrene monomer unit and butadiene monomer unit is preferably in the range of 60 wt % to 99 wt % based on the overall copolymer. Furthermore, the polymer latex of the present invention may preferably contain acrylic acid or methacrylic acid in an amount of 1 wt % to 6 wt %, or more preferably of 2 wt % to 5 wt % based on the sum of styrene and butadiene. It is preferred that the polymer latex of the present invention contains acrylic acid.

Preferred examples of the styrene-butadiene-acrylic acid copolymer latex or styrene-butadiene-methacrylic acid copolymer latex include those set forth in the foregoing pages 3 to 8, and 15, and commercially available products such as LACSTAR-3307B, 7132C, Nipol Lx416 and the like.

As required, a hydrophilic polymer, such as gelatin, polyvinyl alcohol, methyl cellulose, hydroxypropyl cellulose and carboxymethyl cellulose, may be added to the image formation layer of the photosensitive material according to the present invention. The amount of such a hydrophilic polymer is 30 wt % or less, or more preferably 20 wt % or less based on the overall binder in the image formation layer.

The image formation layer formed using the water-base solvent may preferably employ the polymer latex. The binder may be present in the image formation layer in an overall binder/organic silver salt weight ratio of 1/10 to 10/1, more preferably of 1/3 to 5/1, or still more preferably of 1/1 to 3/1.

Such an image formation layer is also a photosensitive layer (emulsion layer) normally containing the photosensitive silver halide as the photosensitive silver salt. In this case, an overall binder/silver halide weight ratio is in the range of 400 to 5, or more preferably of 200 to 10.

The total amount of the binder used in the image formation layer according to the present invention is preferably in the range of 0.2 g/m² to 30 g/m², more preferably of 1 g/m² to 15 g/m², or still more preferably of 2 g/m² to 10 g/m². The image formation layer of the present invention may further contain therein a crosslinking agent for crosslinking structure, a surfactant for improving coating properties, and the like.

### 9. Description of Antifoggant

According to the present invention, an organic polyhalogen compound represented by the following formula (B) is preferably used as an antifoggant:

Q—(Y)n—C(Z₁)(Z₂)X Formula (B)

In the formula (B), Q represents an alkyl group, an aryl group or a heterocyclic group; Y represents a bivalent coupling group; n represents 0 or 1; Z¹ and Z² represent a halogen atom; and X represents a hydrogen atom or an electron-attracting group.

Preferably, Q represents a phenyl group substituted by an electron-attracting group having a positive value of Hammett's substitution constant up. As to the Hammett's substitution constant, reference may be made to Journal of Medicinal Chemistry, 1973, Vol.16, No. 11, 1207-1216 or the like.

Examples of such a preferred electron-attracting group include a halogen atom (fluorine atom, σp value: 0.06); chlorine atom (σp value: 0.23); bromine atom (σp value: 0.23); iodine atom (σp value: 0.18); a trihalomethyl group (tribromomethyl (σp value: 0.29); trichloromethyl (σp value: 0.33); trifluoromethyl (σp value: 0.54); a cyano group (σp value: 0.66); a nitro group (σp value: 0.78); an aliphatic, aryl, or heterocyclic sulfonyl group (e.g., methanesulfonyl (up value: 0.72)); an aliphatic, aryl, or heterocyclic acyl group (e.g., acetyl (σp value: 0.50)); benzoyl (σp value: 0.43); an alkynyl group (e.g., C≡CH (σp value: 0.23)); an aliphatic, aryl, or heterocyclic oxycarbonyl group (e.g., methoxycarbonyl (σp value: 0.45)); phenoxycarbonyl (σp value: 0.44); a carbamoyl group (σp value: 0.36); a sulfamoyl group (σp value: 0.57); a sulfoxide group; a heterocyclic group; a phosphoryl group; and the like.

The σp value is preferably in the range of 0.2 to 2.0, or more preferably of 0.4 to 1.0.

Preferred examples of the electron-attracting group include a carbamoyl group, an alkoxycarbonyl group, an alkylsulfonyl group, an alkylphosphoryl group, a carboxyl group, an alkyl or aryl carbonyl group and an arylsulfonyl group. Particularly preferred are the carbamoyl group, alkoxycarbonyl group, alkylsulfonyl group and alkylphosphoryl group. The carbamoyl group is most preferred.

X is preferably an electron-attracting group, or more preferably a halogen atom, a sulfonyl group, an acyl group, an oxycarbonyl group, a carbamoyl group or a sulfamoyl group. The sulfonyl group, acyl group, oxycarbonyl group, carbamoyl group and sulfamoyl group may optionally have an aliphatic, aryl, or heterocyclic chain. Particularly preferred as X is the halogen atom.

A preferred halogen atom include a chlorine atom, a bromine atom and an iodine atom. More preferred are the chlorine atom and bromine atom and particularly preferred is the bromine atom.

Y is preferably —C(═O)—, —SO— or —SO₂—. More preferred are —C(═O)— and —SO₂— and particularly preferred is —SO₂—. n represents 0 or 1, or preferably 1.

While specific examples of the compound represented by the formula (B) are illustrated as below, it is to be noted that these specific examples do not limit the present invention.

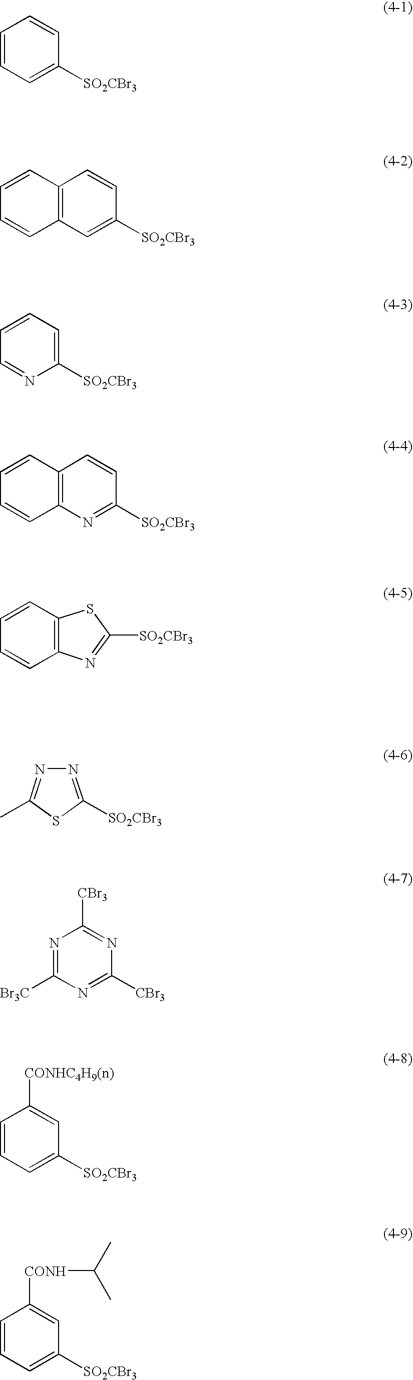

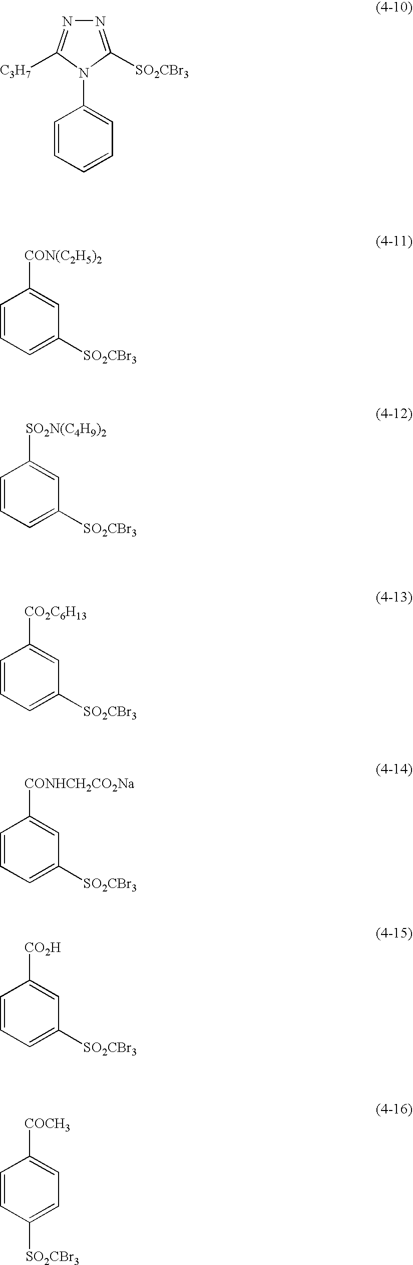

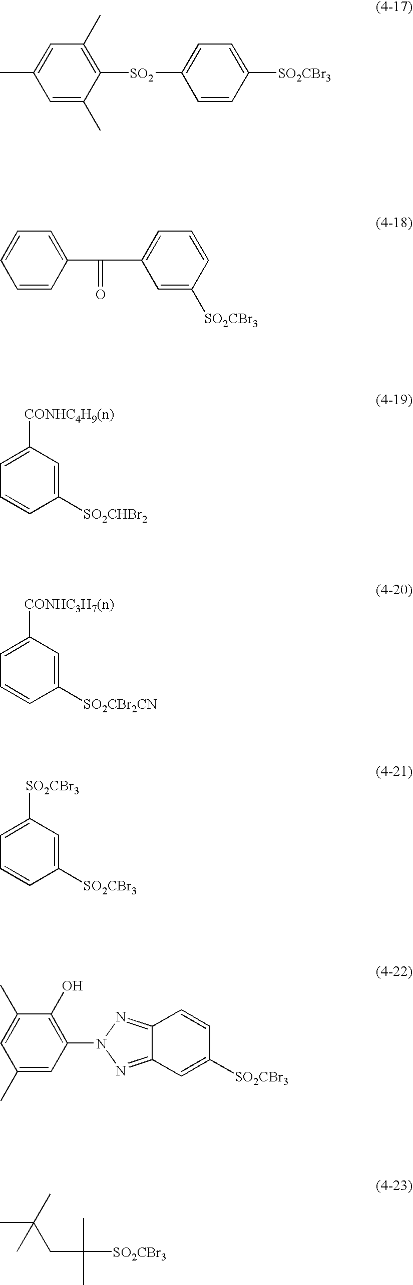

The compound represented by the formula (B) of the present invention is preferably used in an amount of 10⁻⁴ mol to 0.8 mol, more preferably of 10⁻³ mol to 0.1 mol, or still more preferably of 5×10⁻³ mol to 0.05 mol per mol of the non-photosensitive silver salt present in the image formation layer.

According to the present invention, the compound represented by the formula (B) may be incorporated in the photosensitive material by the aforementioned methods for incorporating the reducing agent.

The compound represented by the formula (B) preferably has a melting point of 200° C. or less, or more preferably of 170° C. or less.

Other organic polyhalogen compounds usable in the present invention include those set forth in JP-A No. 11-65021, paragraphs 0111 to 0112. Particularly preferred are an organic halogen compound represented by a formula (P) in JP-A No. 2000-284399, and organic polyhalogen compounds set forth in JP-A No. 10-339934 and 2001-033911.

Examples of other usable antifoggants include mercury (II) salts set forth in JP-A No. 11-65021, paragraph 0113 and benzoic acids set forth in paragraph 0114 of the same patent publication; salicylic derivatives set forth in JP-A No. 2000-206642; a formalin scavenger represented by a formula (S) in JP-A No. 2000-221634; a triazine compound related to claim 9 of JP-A No. 11-352624; 4-hydroxy-6-methyl- 1,3,3a,7-tetrazaindene represented by a formula (III) in JP-A No. 6-11791; and the like.

The antifoggant, stabilizer and stabilizer precursor usable in the present invention include compounds set forth in JP-A No. 10-62899, praragraph 0070; EP-A No. 0803764A1, page 20, line 57 to page 21, line 7; and JP-A Nos. 9-281637 and 9-329864.

The photothermographic material of the present invention may contain an azolium salt for the purpose of preventing fogging. Examples of a usable azolium salt include a compound represented by a formula (XI) in JP-A No. 59-193447; a compound set forth in JP-B No. 55-12581; and a compound represented by a formula (II) in JP-A No. 60-153039. The azolium salt may be added to any portion of the photosensitive material. However, it is preferred to add the azolium salt in a layer on the side including the image formation layer and it is more preferred to add the azolium salt to the image formation layer.

The azolium salt may be added in any step of the preparation of the coating solution. In a case where the azolium salt is added to the image formation layer, it may be added at any step between the preparation of the organic silver salt and the preparation of the coating solution but may preferably be added at some step after the preparation of the organic silver salt and just before the application of the coating solution. The azolium salt may be added in any form of powder, solution, microparticle dispersion and the like. Furthermore, the azolium salt may also be added in a solution containing other additives such as a sensitizing dye, reducing agent and color toning agent.

The azolium salt may be added in any amount but preferably in an amount of 1×10⁻⁶ mol to 2 mol, or more preferably of 1×10⁻³ mol to 0.5 mol per mol of silver.

### 10. Description of Color Toning Agent

The photothermographic material of the present invention is preferably added with a color toning agent. The color toning agent is described in JP-A No. 10-62899, paragraphs 0054 to 0055; EP-A No. 0803764A1 page 21, line 23 to line 48; JP-A No. 2000-356317, and the like. Particularly preferred color toning agents include phthalazinones (phthalazinone, a phthalazinone derivative and a metal salt thereof; such as 4-(1-naphthyl) phthalazinone, 6-chlorophthalazinone, 5,7-dimethoxyphthalazinone and 2,3-dihydro-1,4-phthalazinedione); a combination of a phthalazinone and a phthalic acid (such as phthalate, 4-methyl phthalate, 4-nitrophthalate, diammonium phthalate, sodium phthalate, potassium phthalate and tetrachlorophthalic anhydride); and phthalazines (phthalazine, a phthalazine derivative and a metal salt thereof (such as 4-(1-naphthyl)phthalazine, 6-isopropylphthalazine, 6-t-butylphthalazine, 6-chlorophthalazine,5,7-dimethoxyphthalazine and 2,3-dihydrophthalazine). When used in combination with a silver halide having a high content of silver iodide, a phthalazine or phthalic acid is particularly preferred.

The amount of phthalazine is preferably in the range of 0.01 mol to 0.3 mol, more preferably of 0.02 mol to 0.2 mol, or still more preferably of 0.02 mol to 0.1 mol per mol of organic silver salt.

### 11. Other Additives

According to the present invention, there may be added a mercapto compound, a disulfide compound or a thione compound for the purpose of controlling the development process by suppressing or accelerating the development, improving the spectral sensitization efficiency, or improving the storability of the undeveloped or developed photosensitive material. Such additives include compounds set forth in JP-A No. 10-62899, paragraphs 0067 to 0069; a compound represented by a formula (I) in JP-A No. 10-186572 and specific examples thereof set forth in the paragraphs 0033 to 0052 of the patent publication; and compounds set forth in EP-A No. 0803764A1 page 20, lines 36 to 56. Above all, particularly preferred are mercapto-substituted heteroaromatic compounds illustrated in JP-A Nos. 9-297367, 9-304875 and 2001-100358, 2002-303954 and 2002-303951 and the like.

Plasticizers and lubricants usable in the image formation layer of the present invention are illustrated in JP-A No. 11-65021, paragraph 0117. Examples of a usable lubricant include those set forth in JP-A No. 11-84573, paragraphs 0061 to 0064.

From the standpoint of improvement of color tone, prevention of interference fringes during laser exposure, and irradiation prevention, any of a variety of dyes and pigments (such as C.I. Pigment Blue 60, C.I. Pigment Blue 64 and C.I. Pigment Blue 15:6) may be used in the image formation layer of the present invention. Details of such dyes and pigments are described in PCT Publication No. WO98/36322, and JP-A Nos. 10-268465 and 11-338098.

For the formation of an ultra-hard contrast image suitable for platemaking use, the image formation layer is preferably added with an ultra-hard contrast agent. The ultra-hard contrast agent, and addition method and the adding amount thereof are described in JP-A No. 11-65021, paragraph 0118, and JP-A No. 11-223898, paragraphs 0136 to 0193. The ultra-hard contrast agent is exemplified by compounds represented by formulas (H), (1) to (3), (A) and (B) in JP-A No. 2000-284399. The ultra-hard contrast agent is described in JP-A No. 11-65021, paragraph 0102; and JP-A No. 11-223898, paragraphs 0194 to 0195.

Where formic acid or a formic acid salt is used as a strong fogging agent, the agent may preferably be added to the side including the image formation layer containing the photosensitive silver halide, in an amount of 5 mmol or less, or more preferably of 1 mmol or less per mol of silver.

Where the ultra-hard contrast agent is used in the photothermographic material of the present invention, an acid formed by hydration of diphosphorus pentaoxide or a salt thereof may preferably be used in combination with the agent. The acid formed by hydration of diphosphorus pentaoxide and the salt thereof include metaphosphoric acid (salt), pyrophosphoric acid (salt), orthophosphoric acid (salt), triphosphoric acid (salt), tetraphosphoric acid (salt), hexametaphosphoric acid (salt) and the like. Particularly preferred are the orthophosphoric acid (salt) and hexametaphosphoric acid (salt). Specific examples of the salt include sodium orthophosphate, sodium dihydrorthophosphate, sodium hexametaphosphate, ammonium hexametaphosphate and the like.

The acid formed by hydration of diphosphorus pentaoxide or the salt thereof may be used in a desired amount (coating amount per m² of the photosensitive material) according to the performance of the photosensitive material such as photosensitivity and fogging, but preferably in an amount of 0.1 to 500 mg/m² or more preferably of 0.5 to 100 mg/m².

### 12. Description of Layer Arrangement and Other Components

The photothermographic material of the present invention may further comprise a non-photosensitive layer additionally to the image formation layer. The non-photosensitive layers are classified based on the position thereof as (a) a surface protective layer overlaid on the image formation layer (remote side from the support); (b) an intermediate layer interposed between a plurality of image formation layers or between the image formation layer and the protective layer; (c) an undercoat layer interposed between the image formation layer and the support; and (d) a back layer formed on the opposite side from the image formation layer.

There may be provided a layer acting as an optical filter, which is formed as the layer (a) or (b). An antihalation layer is formed as the layer (c) or (d) of the photosensitive material.

According to the present invention, the coating solution for image formation layer of the photosensitive material is prepared preferably at temperatures in the range of 30° C. to 65° C., more preferably of 35° C. to less than 60° C., or still more preferably of 35° C. to 55° C. Immediately after the addition of a polymer latex, the coating solution for image formation layer is preferably maintained at 30° C. to 65° C.

1) Surface Protective Layer

The photothermographic material of the present invention may be provided with a surface protective layer for preventing the adhesion of the image formation layer. The surface protective layer may be formed in a single layer or multiple layers. The surface protective layer is described in JP-A No. 11-65021, paragraphs 0119 to 0120, and 2001-348546.

The surface protective layer of the present invention preferably employs gelatin as the binder. It is also favorable to use polyvinyl alcohol (PVA) alone or in combination with gelatin. Examples of a usable gelatin include an inert gelatin (such as Nitta Gelatin 750), phthalated gelatin (such as Nitta Gelatin 801) and the like.

A usable PVA include those set forth in JP-A No. 2000-171936, paragraphs 0009 to 0020. Preferred examples of PVA include fully saponified PVA-105; partially saponified PVA-205 and PVA-335; and modified polyvinyl alcohol MP-203 (all of which are trade names of KURARAY Co., Ltd.).

The coating amount of polyvinyl alcohol for a single protective layer (per m² of the support) is preferably in the range of 0.3 g/m² to 4.0 g/m², or more preferably of 0.3 g/m² to 2.0 g/m².

The total coating amount of the binder (including water-soluble polymer and latex polymer) for a single surface protective layer (per m² of the support) is preferably in the range of 0.3 g/m² to 5.0 g/m², or more preferably of 0.3 g/m² to 2.0 g/m².

2) Antihalation Layer

The photothermographic material of the present invention may be arranged such that an antihalation layer is disposed on a remote side of the image formation layer from the light exposure source. The antihalation layer is described in JP-A No. 11-65021, paragraphs 0123 to 0124; JP-A Nos. 11-223898, 9-230531, 10-36695, 10-104779, 11-231457, 11-352625, 11-352626 and the like.

The antihalation layer contains an antihalation dye having absorbance at the wavelength of the exposure light. In a case where the wavelength of the exposure light is in the infrared region, an infrared absorbing dye may be used. In this case, the infrared absorbing dye preferably has no absorbance in the visible region.

In the case of preventing halation from occurring by using a dye having absorption in the visible region, it is preferred that the color of the dye would not substantially reside after image formation, and is preferred to employ a means for fading color by the heat of heat development; in particular, it is preferred to add thermal fading dye and a basic precursor to the non-photosensitive layer to impart function as an antihalation layer. Those techniques are described in JP-A No. 11-231457 and the like.

The amount of the color fading dye is decided based on the use of the dye. It is a common practice to use the dye in such an amount as to give an optical density (absorbance) of more than 0.1 as determined at a target wavelength, or preferably to give an optical density of 0.2 to 2. The amount of the dye used to give such an optical density is generally in the range of 0.001 g/m² to 1 g/m².

By color fading the dye in such a manner, the optical density after heat development can be lowered to 0.1 or lower. Two types or more of color fading dyes may be used in combination in a thermal color fading type recording material or in a photothermographic material. Similarly, two types or more of basic precursors may be used in combination.

In thermal color fading using such a color fading dye and a basic precursor, preferred is to use a substance (for instance, diphenylsulfone, 4-chlorophenyl(phenyl)sulfone, and the like) as disclosed in JP-A No. 11-352626, as well as 2-naphthyl benzoate and the like, which is capable of lowering the melting point by 3° C. when mixed with a basic precursor from the viewpoint of thermal color fading property or the like.

3) Back Layer

A back layer applicable to the present invention is described in JP-A No. 11-65021, paragraphs 0128 to 0130.

According to the present invention, a coloring agent having an maximum absorption at wavelength between 300 nm and 450 nm may be added for the purpose of improving the silver color tone of the image or reducing the change of the image with passage of time. Such a coloring agent include those set forth in JP-A Nos. 62-210458, 63-104046, 63-103235, 63-208846, 63-306436, 63-314535 and 01-61745 and JP-A No. 2001-100363. The coloring agent is normally added in an amount of 0.1 mg/m² to 1 g/m² and preferably added to the back layer formed on the opposite side from the image formation layer.

4) Matting Agent

According to the present invention, a matting agent for improving conveyance characteristics is preferably added to the surface protective layer and the back layer. The matting agent is described in JP-A No. 11-65021, paragraphs 0126 to 0127.

The coating amount of the matting agent (per m² of the photosensitive material) is preferably in the range of 1 mg/m² to 400 mg/m², or more preferably of 5 mg/m² to 300 mg/m².

While there is no limitation to the degree of matting of the emulsion surface so long as a so-called stardust failure does not occur wherein an image portion sustains small white spots detrimentally allowing light leakage. The matting degree preferably has a Bekk smoothness of 30 sec to 2000 sec, or particularly preferably of 40 sec to 1500 sec. The Bekk smoothness is readily determined according to JIS P8119 “Smoothness Test Method for paper and paper board using Bekk Tester” and TAPPI tandard Method T479.

According to the present invention, the degree of matting of the back layer is preferably at a Bekk smoothness of 10 sec to 1200 sec, more preferably of 20 sec to 800 sec, or still more preferably of 40 sec to 500 sec.

According to the present invention, the matting agent is preferably added to the outermost surface layer, a layer serving as the outermost surface layer, a layer close to the outer surface of the photosensitive material, or a layer serving as a so-called protective layer.

5) Polymer Latex

According to the present invention, a polymer latex may be added to the surface protective layer and back layer. Such a polymer latex is described in “Synthetic Resin Emulsion” edited by Taira Okuda and Hiroshi Inagaki, published from Kobunshi Kanko Kai (1978); “Application of Synthetic Latex” edited by Takaaki Sugimura, Yasuo Kataoka, Souichi Suzuki and Keiji Kasahara, published from Kobunshi Kanko Kai (1993); “Chemistry of Synthetic Latex” by Souichi Muroi, from Kobunshi Kanko Kai (1970); and the like. Specific examples of the polymer latex include a copolymer latex of methylmethacrylate (33.5 wt %)/ethylacrylate (50 wt %)/methacrylic acid (16.5 wt %); a copolymer latex of methylmethacrylate (47.5 wt %)/butadiene (47.5 wt %)/itaconic acid (5 wt %); a copolymer latex of ethylacrylate/methacrylic acid; a copolymer latex of methylmethacrylate (58.9 wt %)/2-ethylhexylacrylate (25.4 wt %)/styrene (8.6 wt %)/2-hydroxyethylmethacrylate (5.1 wt %)/acrylic acid (2.0 wt %); a copolymer latex of methylmethacrylate (64.0 wt %)/styrene (9.0 wt %)/butylacrylate (20.0 wt %)/2-hydroxyethylmethacrylate (5.0 wt %)/acrylic acid (2.0 wt %); and the like.

The polymer latex is preferably used in an amount of 10 wt % to 90 wt %, or particularly preferably of 20 wt % to 80 wt % based on the overall binder (including water-soluble polymer and latex polymer) in the surface protective layer or the back layer.

6) Film Surface pH

The photothermographic material of the present invention preferably has a pre-thermal development film surface pH of 7.0 or less, or more preferably of 6.6 or less. The lower limit of the pH is not particularly limited but is on the order of 3. The most preferred pH is in the range of 4 to 6.2.

The film surface pH may preferably be controlled by the use of an organic acid such as a phthalic acid derivative, a nonvolatile acid such as sulfuric acid or a volatile base such as ammonia in the light of decreasing the film surface pH. Ammonia, in particular, is preferably used for lowering the film surface pH because ammonia is prone to vaporization so as to be removed during the application of the coating solution or before the photosensitive material is subjected to the thermal development process.

Alternatively, ammonia is preferably used in combination with a nonvolatile base such as sodium hydroxide, potassium hydroxide or lithium hydroxide. A measurement method for the film surface pH is described in JP-A No. 2000-284399, paragraph 0123.

7) Film Hardener

According to the present invention, a film hardener agent may be used in the image formation layer, protective layer, back layer and the like.

The use of the film hardener agent is described in “THE THEORY OF THE PHOTOGRAPHIC PROCESS FOURTH EDITION” by T. H. James, published from Macmillan Publishing Co., Inc. (1977), pages 77 to 87. Preferred examples of the film hardener agent include chrome alum, 2,4-dichloro-6-hydroxy-s-triazine sodium salt, N,N-ethylenebis(vinylsulfoneacetamide), N,N-propylenebis(vinylsulfoneacetamide); polyvalent metal ions set forth in page 78 of the above publication; polyisocyanates set forth in U.S. Pat. No. 4,281,060 and JP-A No. 6-208193; epoxy compounds set forth in U.S. Pat. No. 4,791,042; vinylsulfone compounds set forth in JP-A No. 62-89048; and the like. Particularly preferred are the vinylsulfone compounds, of which a vinylsulfone rendered non-diffusible is more preferred.

The film hardener added is added in solution. A preferred time to admix the solution is at any point of time between 180 minutes ahead of the application thereof and just before the application thereof, or preferably between 60 minutes ahead of the application thereof and 10 seconds ahead of the application thereof. However, the mixing method and mixing conditions are not particularly limited so long as the effect of the present invention is fully attained.

Specifically, the film hardener agent may be mixed with the coating solution in a tank wherein an average dwell time is set to a desired value, the average dwell time calculated from an addition flow rate of the agent and a feed volume to a coater. Alternatively, the static mixer may be used, which is set forth in Chapter 8 of “Liquid Mixing Technique” by N. Harnby, M. F. Edwards and A. W. Nienow, translated by Koji Takahashi, published by Nikkan Kogyo Shinbun-sha (1989).

8) Antistatic Agent

The present invention may further comprise an antistatic layer containing any of the various known metal oxides and conductive polymers. The antistatic layer may also serve as the aforesaid undercoat layer, a surface protective layer of the back layer or the like. Otherwise, the antistatic layer may be formed independently. The antistatic layer may be formed using techniques described in JP-A No. 11-65021, paragraph 0135; JP-A Nos. 56-143430, 56-143431, 58-62646 and 56-120519; JP-A No. 11-84573, paragraphs 0040 to 0051; U.S. Pat. No. 5,575,957; and JP-A No. 11-223898, paragraphs 0078 to 0084.

9) Support A transparent support preferably employs polyester or particularly a polyethylene terephthalate heat treated at temperatures in the range of 130 to 185° C. so that internal strain in a film biaxially stretched may be reduced for obviating the thermal shrinkage of the film subjected to the thermal development process.

In the case of a photothermographic material for medical application, the transparent support may be colored with a blue dye (such as a dye-1 illustrated in example of JP-A No. 8-240877) or may be colorless.

Specific examples of the support are set forth in JP-A No. 11-65021, paragraph 0134.

Any of the following priming techniques may preferably be applied to the support, the techniques related to a water-soluble polyester described in JP-A No. 11-84574; a styrene-butadiene copolymer described in JP-A No. 10-186565; and a vinylidene chloride copolymer described in JP-A No. 2000-39684.

10) Other Additives

The photothermographic material may further contain an antioxidant, stabilizer, plasticizer, ultraviolet absorber or coating aid depending upon the characteristics of each constituent layer. A solvent described in JP-A No. 11-65021, paragraph 0133 may be added. Each of the additives is added to either of the image formation layer and the non-photosensitive layer. As to the addition of the additive to these layers, reference may be made to PCT Publication No. WO98/36322, EP-A No. 803764A1, and JP-A Nos. 10-186567 and 10-18568.

11) Coating Method

The photothermographic material of the present invention may be applied by any method. Examples of a usable method include extrusion coating, slide coating, curtain coating, dip coating, knife coating, flow coating, and other various coating processes including an extrusion coating using a specific hopper described in U.S. Pat. No. 2,681,294. Preferred are an extrusion coating and slide coating described in “LIQUID FILM COATING” by Stephen F. Kistler and Petert M. Schweizer (CHAPMAN & HALL (1997), pages 399 to 536. Particularly preferred is the slide coating.

A configuration of a slide coater used in the slide coating is illustrated in FIG. 11b. 1 of page 427 of the above publication. If desired, two or more layers can be coated at a time according to a method described in pages 399 to 536 of the above publication, or in U.S. Pat. No. 2,761,791 or GBP-A No. 837,095.

The coating solution for image formation layer according to the present invention may preferably be a so-called thixotropy fluid. As to the thixotrophy technology, reference may be made to JP-A No. 11-52509.

According to the present invention, the coating solution for image formation layer preferably has a viscosity of 400 mPa·s to 100,000 mPa·s at a shear rate of 0.1 S⁻¹, or more preferably of 500 mPa·s to 20,000 mPa·s.

At a shear rate of 1000S⁻¹, the viscosity of the coating solution is preferably in the range of 1 mPa·s to 200 mPa·s or more preferably of 5 mPa·s to 80 mPa·s.

The photothermographic material of the present invention is preferably heat treated immediately after coating and drying so as to be improved in the film forming characteristics. The temperature of the heat treatment is preferably in the range of 60° C. to 100° C. at film surface. The heating time is preferably in the range of 1 sec to 60 sec. The film surface temperature is more preferably in the range of 70 to 90° C., whereas the heating time is more preferably in the range of 2 to 10 sec. A preferred heat treatment method of the present invention is described in JP-A No. 2002-107872.

12) Wrapping Material

It is preferred that the photothermographic material of the present invention is hermetically packaged in a wrapping material having a low oxygen transmittance and/or water transmittance in order to prevent the photothermographic material being deteriorated in the photographic performance during storage or to prevent a roll product from sustaining curling. The oxygen transmittance at 25° C. is preferably 50 ml/atm/m²·day or less, more preferably 10 ml/atm/m²·day or less, or still more preferably 1.0 ml/atm/m²·day. The water transmittance is preferably 10 g/atm/m²·day or less, more preferably 5 g/atm/m²·day, or still more preferably 1 g/atm/m²·day. Specific examples of a wrapping material having a low oxygen transmittance and/or water transmittance include those set forth in JP-A Nos. 8-254793 and 2000-206653.

13) Other Applicable Techniques

Techniques applicable to the photothermographic material of the present invention include those set forth in EP-A Nos. 803764A1 and 883022A1; PCT Publication No. WO98/36322; JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569-10-186572, 10-197974, 10-197982, 10-197983, 10-197985-10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536- 11-133539, 11-133542, 11-133543, 11-223898, 11-352627, 11-305377, 11-305378, 11-305384, 11-305380, 11-316435, 11-327076, 11-338096, 11-338098, 11-338099 and 11-343420; and 2001-200414, 2001-234635, 2002-020699, 2001-275471, 2001-275461, 2000-313204, 2001-292844, 2000-324888, 2001-293864 and 2001-348546.

14) Color Image Formation

A multi-color photothermographic material may have a structure including a respective pair of layers of each color, or a structure wherein a single layer contains therein all the components, as disclosed in U.S. Pat. No. 4,708,928.

In the multi-color photothermographic material, individual image formation layers are retained as separated from each other by means of a functional or non-functional barrier layer interposed between a respective pair of image formation layers, as disclosed in U.S. Pat. No. 4,460,681.

### 14. Description of Image Forming Method

1) Light Exposure

The photosensitive material of the present invention may be exposed to light by any method. However, a laser light is preferred as the light exposure source. A silver halide emulsion having a high content of silver iodide, like that of the present invention, has conventionally suffered a low photosensitivity. However, it has been found that the problem associated with the low sensitivity of the photosensitive material can be solved by writing with the laser light of high luminance or the like, which requires less energy for imagewise recording. Thus, a target photosensitivity can be achieved by quickly writing with such a light of high intensity.

When the photosensitive material is exposed to such a light as to give the maximum optical density (Dmax), the light quantity on the surface of the photosensitive material is preferably in the range of 0.1 W/mm² to 100 W/mm², more preferably of 0.5 W/mm² to 50 W/mm², or most preferably of 1 W/mm² to 50 W/mm².

A laser light preferably used in the present invention include gas lasers (Ar⁺, He—Ne, He—Cd), YAG lasers, dye lasers, semiconductor lasers and the like. A combination of a semiconductor laser and a second harmonic generator is also usable. A preferred laser is decided in correspondence to the peak absorption wavelength of a spectral sensitizing dye present in the photothermographic material, including, for example, a He—Ne laser of red through infrared emission, a red semiconductor laser, Ar⁺, He—Ne and He—Cd lasers of blue throught green emission, a blue semiconductor laser and the like. The peak wavelength of the laser light is preferably in the range of 600 nm to 900 nm, or more preferably of 620 nm to 850 nm.

More recently, in particular, a module integrating an SHG (Second Harmonic Generator) device and a semiconductor laser and a blue semiconductor laser have been developed, drawing an increasing attention to a laser output device of short wavelength region. There is a prospect of an increasing demand for the blue semiconductor laser which is capable of recording a high definition image and features an increased recording density and long-lasting stable output. The peak wavelength of the blue laser light is preferably in the range of 300 nm to 500 nm or particularly preferably of 400 nm to 500 nm.

A laser light oscillated in a multiple longitudinal oscillation mode by high-frequency wave superimposition or the like is also favorably used.

2) Thermal Development

The photothermographic material of the present invention is normally developed by image-wise exposure to light followed by elevating the temperature, while the photothermographic material may be thermal-developed by any method. The development temperature is preferably in the range of 80° C. to 250° C., or more preferably of 100° C. to 140° C.

The development time is preferably in the range of 1 sec to 60 sec, more preferably of 5 see to 30 sec, or still more preferably of 5 sec to 20 sec.

A plate type heater system is preferred as a thermal development system. A preferred thermal development method using the plate type heater system is disclosed in JP-A No. 11-133572. A thermal development apparatus of the above publication is adapted to form a visible image by bringing a photothermographic material formed with a latent image into contact with heating means in a thermal development portion. The heating means comprises a plate heater, whereas a plurality of pressure rollers are arranged in face-to-face relation along one side of the plate heater. The thermal development apparatus thermally develops the photothermographic material by passing the material through space between the pressure rollers and the plate heater. It is preferred that the plate heater system consists of 2 to 6 stages, a front stage of which has 1 to 10° C. lower temperature than the others.

Such a method is also disclosed in JP-A No. 54-30032. The method can advantageously discharge the moisture and organic solvent present in the photothermographic material out of the system, and can also prevent the deformation of the support of the photothermographic material due to sharp temperature rise.

3) System

A medical laser imager including a light exposure portion and a thermal development portion may be exemplified by Fuji Medical Dry Imager FM-DPL and DRYPIX7000. The technologies related to the system are available as they are described in Fuji Medical Review No. 8, pages 39 to 55. The system is also applicable to a photothermographic material for use in a laser imager incorporated in “AD network”, which Fuji Medical Co., Ltd. has proposed as a network system conforming with DICOM Standards.

13. Application of the Present Invention

The photothermographic material including the photographic emulsion having a high content of silver iodide according to the present invention is adapted to form a monochromatic image based on a silver image and may preferably be used as a photothermographic material for medical diagnosis, a photothermographic material for industrial photography, a photothermographic material for printing and a photothermographic material for COM.

### EXAMPLES

While the present invention will be described in detail with reference to the examples thereof, it is noted that the present invention is not limited by these examples.

### Example 1

### Preparation of PET Support

A common procedure was taken to prepare PET using terephthalic acid and ethylene glycol, PET having an intrinsic viscosity IV=0.66 (determined in phenol/tetrachloroethane=6/4 (weight ratio) at 25° C.). The resultant PET was pelletized, dried at 130° C. for 4 hours and molten at 300° C. to be extruded through a T-shaped die and then quenched. Thus was obtained such an unstretched film as to exhibit a thermal fixation thickness of 175 μm.

The film was longitudinally stretched by a factor of 3.3 at 110° C. by means of 3 rollers having different circumferential speeds and then was transversely stretched by a factor of 4.5 at 130° C. by means of a tenter. Subsequently, the film was thermally set at 240° C. for 20 seconds and then, transversely relaxed by 4% at the same temperature. Thereafter, a portion of the film caught by a chuck of the tenter was removed by slitting. Both ends of the film was knurled and then, PCT Publication No. WOund at a tension of 4 kg/cm² to form a roll having a thickness of 175 μm.

### Corona Discharge Surface Treatment

A solid state corona processor 6KVA model commercially available from PILLER GmbH. was operated to treat the both sides of the support at a rate of 20 m/min. at room temperatures. It was found from the readings of current and voltage during the treatment that the support was treated at 0.375 kV·A·min/m². The treatrmtent used a process frequency of 9.6 kHz. A gap clearance between an electrode and a dielectric roll was 1.6 mm.

### Preparation of Undercoated Support

(1) Preparation of Coating Solution for Undercoat Layer

Formulation (1):

| | | |
|---|---|---|
| Coating Solution for Undercoat of Image formation layer | 59 | g |
| PESRESIN A-520 (30 wt % solution) commercially available | | |
| from Takamatsu Oil & Fat Co., Ltd. | | |
| Polyethylene glycol monononylphenyl ether (average number | 5.4 | g |
| of ethylene oxide = 8.5), 10 wt % solution | | |
| MP-1000 (polymer microparticles, average particle size: | 0.91 | g |
| 0.4 μm) commercially available from Soken Chemical & | | |
| Engineering Co., Ltd. | | |
| Distilled water | 935 | ml |

Formulation (2):

| | | |
|---|---|---|
| Coating Solution for First Back-Side Layer | 158 | g |
| Styrene-butadiene copolymer latex (solid content: 40 wt %, | | |
| styrene/butadiene weight ratio = 68/32) | | |
| 2,4-dichloro-6-hydroxy-S-triazine sodium salt (8 wt % | 20 | g |
| aqueous solution) | | |
| Sodium laurylbenzenesulfonate (1 wt % aqueous solution) | 10 | ml |
| Distilled water | 854 | ml |

Formulation (3):

| | | |
|---|---|---|
| Coating Solution for Second Back-Side Layer | 84 | g |
| SnO₂/SbO (weight ratio: 9/1, average particle size: 0.038 μm, | | |
| 17 wt % dispersion) | | |
| Gelatin (10 wt % aqueous solution) | 89.2 | g |
| METHOLLOSE TC-5 (2 wt % aqueous solution) | 8.6 | g |
| commercially available from Shin-Etsu Chemical Co., Ltd. | | |
| MP-1000 commercially available from Soken Chemical & | 0.01 | g |
| Engineering Co., Ltd. | | |
| Sodium dodecylbenzenesulfonate (1 wt % aqueous solution) | 10 | ml |
| NaOH (1 wt %) | 6 | ml |
| PROXEL (commercially available from ICI Corporation) | 1 | ml |
| Distilled water | 805 | ml |

The biaxially stretched polyethylene terephthlate support having the thickness of 175 μm was subjected to the aforesaid corona discharge treatment on both sides thereof. Subsequently, the coating solution for undercoat of image formation layer of the formulation (1) was applied to one side (image formation layer side) of the support by means of a wire bar in a wet coated amount of 6.6 ml/m² (per one side) and then, dried at 180° C. for 5 minutes. Subsequently, the coating solution for undercoat of the formulation (2) was applied to the other side (back side) by means of a wire bar in a wet coated amount of 5.7 ml/m² and then, dried at 180° C. for 5 minutes. Subsequently, the coating solution for undercoat of the formulation (3) was further applied to the back side by means of a wire bar in a wet coated amount of 7.7 ml/m² and then, dried at 180° C. for 6 minutes. Thus was obtained an undercoated support.

### Preparation of Back Surface Coating Solution

Preparation of Coating Solution for Antihalation Layer

A coating solution for antihalation layer was prepared by blending together 60 g of gelatin; 24.5 g of polyacrylamide; 2.2 g of 1 mol/L sodium hydroxide; 2.4 g of monodispersion of polymethylmethacrylate microparticles (average particle size: 8 μm, particle size standard deviation: 0.4); 0.08 g of benzoisothiazolinone; 0.3 g of sodium polystyrenesulfonate; 0.21 g of blue dye compound-1; 0.15 g of yellow dye compound-1; and 8.3 g of acrylic acid/ethylacrylate copolymer latex (copolymerization ratio: 5/95), and the adding water to make the overall volume 818 ml.

### Preparation of Coating Solution for Back-Side Protective Layer

A coating solution for back-side protective layer was prepared by blending together, in a vessel maintained at 40° C., 40 g of gelatin; 1.5 g of liquid paraffin emulsion as liquid paraffin; 35 mg of benzoisothiazolinone; 6.8 g of 1 mol/L sodium hydroxide; 0.5 g of sodium t-octylphenoxyethoxyethane sulfonate; 0.27 g of sodium polystyrenesulfonate; 5.4 mg of 2 wt % aqueous solution of fluorinated surfactant (FF-1); 6.0 g of acrylic acid/ethylacrylate copolymer (copolymerization ratio: 5/95); and 2.0 g of N,N-ethylenebis(vinylsulfoneacetamide) and then adding water to make the overall volume 1000 ml.

### Preparation of Silver Halide Emulsion

Preparation of Silver Halide Emulsion 1

In a stainless steel reaction vessel, 1420 mol of distilled water; 4.3 ml of 1 wt % potassium iodide solution; 3.5 ml of 0.5 mol/L sulfuric acid; and a solution containing 36.7 g of phthalized gelatin were blended together with stirring and admixed with the whole volumes of 195.6 ml of Solution A and 218 ml of Solution B at a constant flow rate over 9 minutes while maintaining the solution temperature at 42° C. Solution A was prepared by diluting 22.22 g of silver nitrate in distilled water, whereas Solution B was prepared by diluting 21.8 g of potassium iodide in distilled water. Subsequently, 10 ml of 3.5 wt % aqueous solution of hydrogen peroxide, and then 10.8 ml of 10 wt % aqueous solution of benzoimidazole were added to the resultant mixture.

To the mixture, the whole volume of 317.5 ml of Solution C was added at a constant flow rate over 120 minutes, while the whole volume of 600 ml of Solution D was added by a controlled double jet method with a pAg level maintained at 8.1. Solution C was prepared by diluting 51.86 g of silver nitrate in distilled water, whereas Solution D was prepared by diluting 60 g of potassium iodide in distilled water. After a lapse of 10 minutes from the start of addition of Solutions C and D, hexachloriridate (III) potassium salt was added in such an amount that the concentration of iridium was 1×10⁻⁴ mol per mol of silver. Furthermore, an aqueous solution of potassium hexacyanoferrate (II) was added in an amount of 3×10⁻⁴ mol per mol of silver after a lapse of 5 seconds from the termination of addition of Solution C. The dispersion was adjusted with 0.5 mol/L sulfuric acid to a pH of 3.8 and then, the stirring was terminated, followed by sedimentation, desalting and rinsing steps. The dispersion was adjusted with 1 mol/L sodium hydroxide to a pH of 5.9. Thus was obtained a silver halide dispersion having a pAg of 8.0.

While stirring the above silver halide dispersion maintained at a temperature of 38° C., 5 ml of methanol solution of 0.34 wt % 1,2-benzoisothiazoline-3-one was added and then the temperature was elevated to 47° C. After a lapse of 20 minutes from the temperature elevation, methanol solution of sodium benzenethiosulfonate was added in an amount of 7.6×10⁻⁵ mol per mol of silver. Then 5 minutes later, a tellurium sensitizer B in methanol was added in an amount of 2.9×10⁻⁴ mol per mol of silver and the dispersion was ripened for 91 minutes.

Thereafter, 1.3 ml of 0.8 wt % N,N′-dihydroxy-N″,N″-diethylmelamine in methanol was added and 4 minutes thereafter, 5-methyl-2-mercaptobenzoimidazole in methanol and 1-phenyl-2-heptyl-5-mercapto-1,3,4-triazole in methanol were added in respective amounts of 4.8×10⁻³ mol per mol of silver and 5.4×10⁻³ mol per mol of silver. Thus was obtained a silver halide emulsion 1.

The resultant silver halide emulsion contained pure silver iodide particles having an average equivalent sphere diameter of 0.040 μm and an equivalent sphere diameter variation coefficient of 18%. The particles size and the like were determined based on the average of 1000 particles microscopically observed.

### Preparation of Emulsion Mixture A for Coating Solution

The silver halide emulsion 1 was dissolved and 1 wt % aqueous solution of benzothiazolium iodide was added in an amount of 7×10⁻³ mol per mol of silver. Then, water was added to the resultant mixture in such an amount that a content of silver halide based on silver was 38.2 g per kg of emulsion mixture for coating solution.

### Preparation of Fatty Acid Silver Dispersion A

A mixture was prepared by blending together 87.6 kg of behenic acid (trade name: Edenor C22-85R commercially available from Henkel Japan Ltd.); 423 L of distilled water; 49.2 L of 5 mol/L aqueous solution of NaOH; and 120 L of t-butyl alcohol. The mixture was reacted with stirring at 75° C. for 1 hour to give a sodium behenate solution A. Separately, 206.2 L of aqueous solution containing 40.4 kg of silver nitrate (pH:4.0) was prepared and maintained at a temperature of 10° C. A reaction vessel charged with 635 L of distilled water and 30 L of t-butyl alcohol was maintained at a temperature of 30° C. While adequately stirring, the solution mixture was further admixed with the whole volumes of the sodium behenate solution A and the aqueous solution of silver nitrate at constant flow rates over respective periods of 93 minutes and 15 seconds and 90 minutes. In this step, the aqueous solution of silver nitrate was singly added for a period of 11 minutes from the start of addition thereof and then, the addition of sodium behenate solution A was started. Hence, the sodium behenate solution A alone was added for a period of 14 minutes and 15 seconds after the termination of the addition of the aqueous silver nitrate solution. During the addition step, the internal temperature of the reaction vessel was maintained at 30° C. That is, the ambient temperature was controlled such that the liquid temperature was kept constant. Double piping system for adding the sodium behenate solution A was kept heated by circulating hot water through an outside pipe of the system, whereas the liquid temperature from an outlet port of an adding nozzle was controlled to 75° C. On the other hand, double piping system for adding the aqueous silver nitrate solution was maintained at a given temperature by circulating cold water through an outside pipe of the system. The sodium behenate solution A and aqueous silver nitrate solution were added from symmetrical positions with respect to a stirring axis and at such a height as kept out of contact with the reaction fluid.

After the termination of addition of the sodium behenate solution A, the mixture was allowed to stand with stirring for 20 minutes at a temperature as it was. Subsequently, the temperature of the reaction fluid was elevated to 35° C. over 30 minutes and then, the reaction fluid was ripened for 210 minutes. Immediately after the termination of the ripening, solids were centrifugally filtered out and rinsed with water until the conductivity of the filtrate was reduced to 30 μS/cm. Thus was obtained a fatty acid silver salt. The resultant solids were not dried and stored as a wet cake.

The configuration of the resultant silver behenate particles was examined by means of microscopic photography. The particles were scaly crystals having average values of a=0.14 μm, b=0.4 μm and c=0.6 μm; an average aspect ratio of 5.2; an average equivalent sphere diameter of 0.52 μm; and an average equivalent sphere diameter coefficient of 15% (a, b and c defined as in the foregoing).

To the wet cake equivalent to a dry weight of 260 kg of the solids, 19.3 kg of polyvinyl alcohol (trade name: PVA-217) was added and water were further added to make the whole volume 1000 kg. The resultant mixture was rendered slurry by means of dissolver blades and then pre-dispersed by means of a pipeline mixer (PM-10 model commercially available from MIZUHO Industrial Co.,Ltd.).

Subsequently, the pre-dispersed stock was processed 3 times in a disperser (trade name: Microfluidizer M-610 equipped with a Z-type interaction chamber and commercially available from Microfluidex International Corporation), the pressure of which was adjusted to 1260 kg/cm². Thus was obtained a silver behenate dispersion. The interaction chamber was provided with a coiled heat exchanger at a front side and a rear side thereof, respectively, for regulating the temperature of a coolant so as to set a dispersion temperature to 18° C.

### Preparation of Fatty Acid Silver Dispersion B

Preparation of Recrystallized Behenic Acid

First, 100 kg of behenic acid (trade name: Edenor C22-85R commercially available from Henkel Japan Ltd.) was dissolved in 1200 kg of isopropyl alcohol at 50° C., filtered through a 10 μm filter, and cooled to 30° C. for recrystallization. The cooling speed for the crystallization was controlled to 3° C./hour. The resultant crystals were centrifugally filtered out, washed with 100 kg of isopropyl alcohol and then dried. The resultant crystals were esterified and examined by GC-FID. The crystals contained 96 mol % of behenic acid, 2 mol % of lignoceric acid, 2 mol % of arachidinic acid, and 0.001 mol % of erucic acid.

### Preparation of Fatty Acid Silver Dispersion B

A mixture was prepared by blending together 88 kg of recrystallized behenic acid; 422 L of distilled water; 49.2 L of 5 mol/L aqueous solution of NaOH; and 120 L of t-butyl alcohol. The mixture was reacted with stirring at 75° C. for 1 hour to give a sodium behenate solution B. Separately, 206.2 L of aqueous solution containing 40.4 kg of silver nitrate (pH:4.0) was prepared and was maintained at a temperature of 10° C. A reaction vessel charged with 635 L of distilled water and 30 L of t-butyl alcohol was maintained at a temperature of 30° C. While adequately stirring, the mixture was further admixed with the whole volumes of the aforesaid sodium behenate solution B and the aforesaid aqueous solution of silver nitrate at constant flow rates over respective periods of 93 minutes and 15 seconds and 90 minutes. In this step, the aqueous solution of silver nitrate was singly added for a period of 11 minutes from the start of addition thereof and then, the addition of sodium behenate solution B was started. Hence, the sodium behenate solution B alone was added for a period of 14 minutes and 15 seconds after the termination of the addition of the aqueous silver nitrate solution. During the addition step, the internal temperature of the reaction vessel was maintained at 30° C. That is, the ambient temperature was controlled such that the liquid temperature was kept constant. Double piping system for adding the sodium behenate solution B was kept heated by circulating hot water through an outside pipe of the system, whereas the liquid temperature from an outlet port of an adding nozzle was controlled to 75° C. On the other hand, double piping system for adding the aqueous silver nitrate solution was maintained at a given temperature by circulating cold water through an outside pipe of the system. The sodium behenate solution B and aqueous silver nitrate solution were added from symmetrical positions with respect to a stirring axis and at such a height as kept out of contact with the reaction fluid.

After the termination of addition of the sodium behenate solution B, the mixture was allowed to stand with stirring for 20 minutes at a temperature as it was. Subsequently, the temperature of the reaction fluid was elevated to 35° C. over 30 minutes and then, the reaction fluid was ripened for 210 minutes. Immediately after the termination of the ripening, solids were centrifugally filtered out and rinsed with water until the conductivity of the filtrate was reduced to 30 μS/cm. Thus was obtained a fatty acid silver salt. The resultant solids were not dried and stored as a wet cake.

The configuration of the resultant silver behenate particles was examined by means of microscopic photography. The particles were crystals having average values of a=0.21 μm, b=0.4 μm and c=0.4 μm; an average aspect ratio of 2.1; and an average equivalent sphere diameter coefficient of 11% (a, b and c defined as in the foregoing).

To the wet cake equivalent to a dry weight of 260 kg of the solids, 19.3 kg of polyvinyl alcohol (trade name: PVA-217) was added and water were further added to make the whole volume 1000 kg. The resultant mixture was rendered slurry by means of dissolver blades and then pre-dispersed by means of a pipeline mixer (PM-10 model commercially available from MIZUHO Industrial Co.,Ltd.).

Subsequently, the pre-dispersed stock was processed 3 times in a disperser (trade name: Microfluidizer M-610 equipped with a Z-type interaction chamber and commercially available from Microfluidex International Corporation), the pressure of which was adjusted to 1150 kg/cm². Thus was obtained a silver behenate dispersion. The interaction chamber was provided with a coiled heat exchanger at a front side and a rear side thereof, respectively, for regulating the temperature of a coolant so as to set a dispersion temperature to 18° C.

Preparation of Fatty Acid Silver Dispersions B-1 and B-2

The same procedure as in the preparation of the fatty acid silver dispersion B was taken to prepare dispersions B-1 and B-2, except that lignoceric acid, arachidinic acid and stearic acid were added to the recrystallized behenic acid to form a desired fatty acid composition, respectively, and that the content of fatty acid silver was changed as listed in Table 1 as below.

TABLE 1

| Organic Silver | Fatty Acid Composition (mol %) | | | |
|---|---|---|---|---|
| Salt | Behenic | Lignoceric | Arachidinic | Stearic |
| A | 90% | 2% | 6% | 2% |
| B | 96% | 2% | 2% | 0% |
| B-1 | 80% | 3% | 10% | 8% |
| B-2 | 65% | 4% | 17% | 17% |

### Preparation of Reducing Agent Dispersion

Preparation of Reducing Agent-1 Dispersion

A mixture consisting of 10 kg of reducing agent-1 (2,2′-methylenebis(4-ethyl-6-tert-butylphenol) and 16 kg of 10 wt % aqueous solution of modified polyvinyl alcohol (POVAL MP203 commercially available from KURARAY CO., LTD.) was admixed with 10 kg of water and thoroughly stirred to form a slurry. The slurry was fed by a diaphragm pump to a horizontal sand mill (UVM-2 commercially available from Aimex Co., Ltd.) charged with zirconia beads having an average diameter of 0.5 mm, so as to be dispersed for 3 hours. Subsequently, 0.2 g of sodium salt of benzoisothiazolinone and water was added to adjust the concentration of the reducing agent to 25 wt %. The dispersion was heated at 60° C. for 5 hours to give a reducing agent-i dispersion. The resultant dispersion contained reducing agent particles having a median diameter of 0.40 μm and a maximum particle size of 1.4 μm or less. The reducing agent dispersion thus obtained was filtered through a polypropylene filter having a pore diameter of 3.0 μm to remove foreign matters such as dusts before stored.

Preparation of Reducing Agent-2 Dispersion

A mixture consisting of 10 kg of reducing agent-2 (6,6′-di-t-butyl-4,4′-dimethyl-2,2′-butylidenediphenol) and 16 kg of 10 wt % aqueous solution of modified polyvinyl alcohol (POVAL MP203 commercially available from KURARAY CO., LTD.) was admixed with 10 kg of water and thoroughly stirred to form a slurry. The slurry was fed by a diaphragm pump to a horizontal sand mill (UVM-2 commercially available from Aimex Co., Ltd.) charged with zirconia beads having an average diameter of 0.5 mm, so as to be dispersed for 3 hours and 30 minutes. Subsequently, 0.2 g of sodium salt of benzoisothiazolinone and water was added to adjust the concentration of the reducing agent to 25 wt %. The dispersion was heated at 40° C. for 1 hour and then at 80° C. for 1 hour, thereby giving a reducing agent-2 dispersion. The resultant dispersion contained reducing agent particles having a median diameter of 0.50 μm and a maximum particle size of 1.6 μm or less. The reducing agent dispersion thus obtained was filtered through a polypropylene filter having a pore diameter of 3.0 μm to remove foreign matters such as dusts before stored.

### Preparation of Hydrogen-Bonding Compound-1 Dispersion

A mixture consisting of 10 kg of hydrogen-bonding compound-1 (tri(4-t-butylphenyl)phosphineoxide) and 16 kg of 10 wt % aqueous solution of modified polyvinyl alcohol (POVAL MP203 commercially available from KURARAY CO., LTD.) was admixed with 10 kg of water and thoroughly stirred to form a slurry. The slurry was fed by a diaphragm pump to a horizontal sand mill (UVM-2 commercially available from Aimex Co., Ltd.) charged with zirconia beads having an average diameter of 0.5 mm, so as to be dispersed for 4 hours. Subsequently, 0.2 g of sodium salt of benzoisothiazolinone and water was added to adjust the concentration of the hydrogen-bonding compound to 25 wt %. The dispersion was heated at 40° C. for 1 hour and then at 80° C. for 1 hour, thereby giving a hydrogen-bonding compound-1 dispersion. The resultant dispersion contained hydrogen-bonding compound particles having a median diameter of 0.45 μm and a maximum particle size of 1.3 μm or less. The hydrogen-bonding compound dispersion thus obtained was filtered through a polypropylene filter having a pore diameter of 3.0 μm to remove foreign matters such as dusts before stored.

### Preparation of Development Accelerator-1 Dispersion

A mixture consisting of 10 kg of development accelerator-1 and 20 kg of 10 wt % aqueous solution of modified polyvinyl alcohol (POVAL MP203 commercially available from KURARAY CO., LTD.) was admixed with 10 kg of water and thoroughly stirred to form a slurry. The slurry was fed by a diaphragm pump to a horizontal sand mill (UVM-2 commercially available from Aimex Co., Ltd.) charged with zirconia beads having an average diameter of 0.5 mm, so as to be dispersed for 3 hours and 30 minutes. Subsequently, 0.2 g of sodium salt of benzoisothiazolinone and water was added to adjust the concentration of the development accelerator to 20 wt %. Thus was obtained a development accelerator-1 dispersion. The resultant dispersion contained development accelerator particles having a median diameter of 0.48 μm and a maximum particle size of 1.4 μm or less. The development accelerator dispersion thus obtained was filtered through a polypropylene filter having a pore diameter of 3.0 μm to remove foreign matters such as dusts before stored.

A development accelerator-2 and a color-tone-adjusting agent-1 were each dispersed the same way as in the preparation of the development accelerator-1 dispersion, thereby forming a 20 wt % dispersion of the development accelerator-2 and a 15 wt % dispersion of the color-tone-adjusting agent-1.

### Preparation of Aqueous Additive S-1 Solution and S-2 Solution

An additive S-1 was added to water in a predetermined amount on a solid basis such as to give a 0.2 wt % aqueous solution. An aqueous solution of additive S-2 was prepared the same way as the aqueous additive S-1 solution, except that an additive S-2 was used in place of the additive S-1.

### Preparation of Polyhalogen Compound

Preparation of Polyhalogen Compound-1 Dispersion

A mixture consisting of 10 kg of polyhalogen compound-1 (tribromomethanesulfonylbenzene), 10 kg of 20 wt % aqueous solution of modified polyvinyl alcohol (POVAL MP203 commercially available from KURARAY CO., LTD.) and 0.4 kg of 20 wt % aqueous solution of sodium triisopropylnaphthalenesulfonate was admixed with 14 kg of water and thoroughly stirred to form a slurry. The slurry was fed by a diaphragm pump to a horizontal sand mill (UVM-2 commercially available from Aimex Co., Ltd.) charged with zirconia beads having an average diameter of 0.5 mm, so as to be dispersed for 5 hours. Subsequently, 0.2 g of sodium salt of benzoisothiazolinone and water was added to adjust the concentration of the polyhalogen compound to 30 wt %. Thus was obtained a polyhalogen compound-1 dispersion. The resultant dispersion contained polyhalogen compound particles having a median diameter of 0.41 μm and a maximum particle size of 2.0 μm or less. The polyhalogen compound dispersion thus obtained was filtered through a polypropylene filter having a pore diameter of 10.0 μm to remove foreign matters such as dusts before stored.

Preparation of Polyhalogen Compound-2 Dispersion

A mixture consisting of 10 kg of polyhalogen compound-2 (N-butyl-3-tribromomethanesulfonylbenzamide), 20 kg of 10 wt % aqueous solution of modified polyvinyl alcohol (POVAL MP203 commercially available from KURARAY CO., LTD.) and 0.4 kg of 20 wt % aqueous solution of sodium triisopropylnaphthalenesulfonate was thoroughly stirred to form a slurry. The slurry was fed by a diaphragm pump to a horizontal sand mill (UVM-2 commercially available from Aimex Co., Ltd.) charged with zirconia beads having an average diameter of 0.5 mm, so as to be dispersed for 5 hours. Subsequently, 0.2 g of sodium salt of benzoisothiazolinone and water was added to adjust the concentration of the polyhalogen compound to 30 wt %. The dispersion was heated at 40° C. for 5 hours, thereby giving a polyhalogen compound-2 dispersion. The resultant dispersion contained polyhalogen compound particles having a median diameter of 0.40 μm and a maximum particle size of 1.3 μm or less. The polyhalogen compound dispersion thus obtained was filtered through a polypropylene filter having a pore diameter of 3.0 μm to remove foreign matters such as dusts before stored.

### Preparation of Phthalazine Compound-1 Dispersion

First, 8 kg of modified polyvinyl alcohol (POVAL MP203 commercially available from KURARAY CO., LTD.) was dissolved in 174.57 kg of water. The resultant aqueous solution was admixed with 3.15 kg of 20 wt % aqueous solution of sodium triisopropylnaphthalenesulfonate and 14.28 kg of 70 wt % aqueous solution of phthalazine compound-1 (6-isopropylphthalazine), thereby giving a 50 wt % solution of phthalazine compound-1.

### Preparation of Mercapto Compound

Preparation of Aqueous Mercapto Compound-1 Solution

A 0.7 wt % aqueous solution of mercapto compound-1 was prepared by dissolving 7 g of mercapto compound-1 (1-(3-sulfophenyl)-5-mercaptotetrazole sodium salt) in 993 g of water.

### Preparation of Aqueous Mercapto Compound-2 Solution

A 2.0 wt % aqueous solution of mercapto compound-2 was prepared by dissolving 20 g of mercapto compound-2 (1-(3-methylureidophenyl)-5-mercaptotetrazole) in 980 g of water.

### Preparation of Pigment-1 Dispersion

A mixture consisting of 64 g of C.I. Pigment Blue 60 and 6.4 g of DEMOL-N (commercially available from KAO Corporation) was admixed with 250 g of water and thoroughly stirred to form a slurry. The slurry together with 800 g of zirconia beads having an average diameter of 0.5 mm were charged in a vessel of a disperser (1/4G sand grinder mill commercially available from Aimex Co., Ltd.) and dispersed for 25 hours. Water was added to the dispersion to adjust the content of the pigment to 5 wt %. Thus was obtained a pigment-1 dispersion. The resultant pigment dispersion contained pigment particles having an average particle size of 0.21 μm.

### Preparation of SBR Latex Solution

SBR Latex was Prepared as Described Below.

To a polymerization tank of a gas monomer reaction apparatus (manufactured by Taiatsu Techno Corporation, TAS-2J type), were charged 287 g of distilled water, 7.73 g of a surfactant (Pionin A-43-S (manufactured by TAKEMOTO OIL & FAT CO.,LTD.): solid matter content of 48.5% by weight), 14.06 mL of 1 mol/liter NaOH, 0.15 g of ethylenediamine tetraacetate tetrasodium salt, 255 g of styrene, 11.25 g of acrylic acid, and 3.0 g of tert-dodecyl mercaptan, followed by sealing of the reaction vessel and stirring at a stirring rate of 200 rpm. Degassing was conducted with a vacuum pump, followed by repeating nitrogen gas replacement several times. Thereinto was injected 108.75 g of 1,3-butadiene, and the inner temperature was elevated to 60° C. Thereto was added a solution of 1.875 g of ammonium persulfate dissolved in 50 mL of water, and the mixture was stirred for 5 hours as it stands. The temperature was further elevated to 90° C., followed by stirring for 3 hours. After completing the reaction, the inner temperature was lowered to reach to the room temperature, and thereafter the mixture was treated by adding 1 mol/liter NaOH and NH⁴OH to give the molar ration of Na⁺ ion: NH⁴+ ion=1:5.3, and thus, the pH of the mixture was adjusted to 8.4. Thereafter, filtration with a polypropylene filter having the pore size of 1.0 μm was conducted to remove foreign substances such as dust followed by storage. Accordingly, SBR latex was obtained in an amount of 774.7 g. Upon the measurement of halogen ion by ion chromatography, concentration of chloride ion was revealed to be 3 ppm. As a result of the measurement of the concentration of the chelating agent by high performance liquid chromatography, it was revealed to be 145 ppm.

The aforementioned latex had the mean particle diameter of 90 nm, Tg of 17° C., solid matter concentration of 44 wt % by weight, the equilibrium moisture content at 25° C., 60% RH of 0.6% by weight, ionic conductance of 4.80 mS/cm (measurement of the ionic conductance performed using a conductivity meter CM-30S manufactured by Toa Electronics Ltd. for the latex stock solution (44 wt % by weight) at 25° C.).

### Preparation of Coating Solution-1 for Image formation Layer

To 1000 g of the fatty acid silver dispersion A and 276 ml of water, there were sequentially added the pigment-1 dispersion, polyhalogen compound-1 dispersion, polyhalogen compound-2 dispersion, phthalazine compound-1 solution, SBR latex solution (Tg: 17° C.), reducing agent-1 dispersion, reducing agent-2 dispersion, hydrogen-bonding compound-1 dispersion, development accelerator-1 dispersion, development accelerator-2 dispersion, color-tone-adjusting agent-1 dispersion, aqueous mercapto compound-1 solution, aqueous mercapto compound-2 solution, aqueous additive S-1 solution, and aqueous additive S-2 solution. Just before the application of the solution, the silver halide emulsion mixture A was added to the above mixture and thoroughly stirred to give a coating solution for image formation layer, which was directly fed to a coating die for application.

The coating solution for image formation layer had a viscosity of 25 [mPa·s] as determined by a B-type viscometer (commercially available from Tokyo Keiki K.K.) at 40° C. (No. 1 rotor: 60 rpm).

The coating solution was also measured for the viscosity at 25° C. using an RFS fluid spectrometer commercially available from Rheometrics Scientific F.E. Ltd. The coating solution presented viscosities of 242, 65, 48, 26 and 20 [mPa·s] at shear rates of 0.1, 1, 10, 100 and 1000 (1/sec), respectively.

The content of zirconium in the coating solution was 0.52 mg per g of silver.

### Preparation of Coating Solution for Intermediate Layer

A mixture consisting of 1000 g of polyvinyl alcohol PVA-205 commercially available from KURARAY CO., LTD.; 272 g of pigment-1 dispersion; and 4200 ml of 19 wt % solution of methylmethacrylate/styrene/butylacrylate/hydroxyethylmethacrylate/acrylic acid copolymer latex (copolymerization weight ratio of 64/9/20/5/2) was admixed with 27 ml of 5 wt % aqueous solution of Aerosol OT (commercially available from American Cyanamide Corporation) and 135 ml of 20 wt % aqueous solution of diammonium phthalate, and then with water in such an amount to make the whole volume 10000 g. The pH of the resultant mixture was adjusted with NaOH to 7.5. Thus was obtained a coating solution for intermediate layer, which was fed to a coating die in an amount of 9.1 ml/m².

The coating solution had a viscosity of 58 [mPa·s] as determined at 40° C. by means of the B-type viscometer (No. 1 rotor: 60 rpm).

### Preparation of Coating Solution for First Surface Protective Layer

First, 64 g of inert gelatin was dissolved in water. The resultant aqueous solution was admixed with 112 g of 19.0 wt % solution of methylmethacrylate/styrene/butylacrylate/hydroxyethylmethacrylate/ac rylic acid copolymer latex (copolymerization weight ratio of 64/9/20/5/2); 30 ml of 15 wt % methanol solution of phthalic acid; 23 ml of 10 wt % aqueous solution of 4-methylphthalic acid; 28 ml of 0.5 mol/L sulfuric acid; 5 ml of Aerosol OT (commercially available from American Cyanamide Corporation); 0.5 g of phenoxyethanol; and 0.1 g of benzothiazolinone and then, with water in such an amount to make the whole amount 750 g to give a coating solution. Just before the application, 26 ml of 4 wt % chrome alum was added and blended together by a static mixer. The resultant solution mixture was fed to a coating die in an amount of 18.6 ml/m².

The coating solution had a viscosity of 20 [mPa·s] as determined at 40° C. by means of the B-type viscometer (No. 1 rotor: 60 rpm). Preparation of Coating Solution for Second Surface Protective Layer First, 80 g of inert gelatin was dissolved in water. The resultant aqueous solution was admixed with 102 g of 27.5 wt % solution of methylmethacrylate/styrene/butylacrylate/hydroxyethylmethacrylate/ac rylic acid copolymer latex (copolymerization weight ratio of 64/9/20/5/2); 9.6 ml of 1 wt % solution of fluorinated surfactant (FF-1); 23 ml of 5 wt % solution of Aerosol OT (commercially available from American Cyanamide Corporation); 4 g of polymethylmethacrylate microparticles (average particle size: 0.7 μm); 21 g of polymethylmethacrylate microparticles (average particle size: 4.5 μm); 1.6 g of 4-methylphthalic acid; 4.8 g of phthalic acid; 44 ml of 0.5 mol/L sulfuric acid; and 10 mg of benzothiazolinone and then, with water in such an amount to make the whole amount 650 g to give a coating solution. Just before the application, 445 ml of aqueous solution containing 4 wt % of chrome alum and 0.67 wt % of phthalic acid was added and blended together by a static mixer, thereby forming a coating solution for surface protective layer. The resultant coating solution was fed to a coating die in an amount of 8.3 ml/m².

The coating solution had a viscosity of 19 [mPa·s] as determined at 40° C. by means of the B-type viscometer (No. 1 rotor: 60 rpm).

### Preparation of Photothermnographic Material-1

To the back side of the above undercoated support, the coating solution for antihalation layer and the coating solution for back-side protective layer were simultaneously applied in respective amounts of 0.88 g/m² and 1.2 g/m² on a gelatin basis. The coating solutions were dried to form a back layer.

Reverse surface of the back surface was subjected to simultaneous overlaying coating by a slide bead coating method in order of the image-forming layer, intermediate layer, first layer of the surface protective layer and second layer of the surface protective layer starting from the undercoated face, and thus a sample of the photothermographic material was produced. In this method, the temperature of the coating solution was adjusted to 31° C. for the image forming layer and intermediate layer, to 36° C. for the first layer of the surface protective layer, and to 37° C. for the second layer of the surface protective layer.

Coated amounts of individual compounds contained in the image formation layer (g/m²) are listed as below.

| | |
|---|---|
| Silver behenate | 5.27 |
| Pigement (C.I. Pigment Blue 60) | 0.036 |
| Polyhalogen compound-1 | 0.09 |
| Polyhalogen compound-2 | 0.14 |
| Phthalazine compound-1 | 0.18 |
| SBR latex | 9.43 |
| Reducing agent-1 | 0.55 |
| Reducing agent-2 | 0.22 |
| Hydrogen-bonding compound-1 | 0.28 |
| Development accelerator-1 | 0.025 |
| Development accelerator-2 | 0.020 |
| color-tone-adjusting agent-1 | 0.008 |
| Mercapto compound-1 | 0.002 |
| Mercapto compound-2 | 0.006 |
| Additive S-1 | 0.001 |
| Additive S-2 | 0.002 |
| Silver halide (as Ag) | 0.046 |

The coating solutions were applied and dried under the following conditions.

The coating process was carried out at a coating speed of 160 m/min, while maintaining a gap between an end of the coating die and the support in the range of 0.10 to 0.30 mm. The pressure of the vacuum chamber was set to a level 196 to 882 Pa lower than the atmospheric pressure. The support was de-electrified with an ionic air blow prior to the application of the coating solution.

In the subsequent chilling zone, the coated liquid was cooled by applying thereto air flow at a dry-bulb temperature of 10 to 20° C. and then conveyed in a non-contact fashion to a helical non-contact drying apparatus wherein the coated liquid was dried by applying thereto a dry air flow at a dry-bulb temperature of 23 to 45° C. and a wet-bulb temperature of 15 to 21° C.

After drying, the moisture of the resultant film was adjusted to 40 to 60% RH at 25° C. and then the film was heated so that the film surface temperature was raised to 70 to 90° C. After heating, the film was cooled to a surface temperature of 25° C.

The resultant photothermographic material had a matting degree of 550 sec on the image formation layer side and of 130 sec on the back side, as determined based on the Bekk smoothness. The pH of the film surface on the image formation layer side was determined to be at a pH of 6.0.

Chemical structures of the compounds used by the present invention are shown as below.

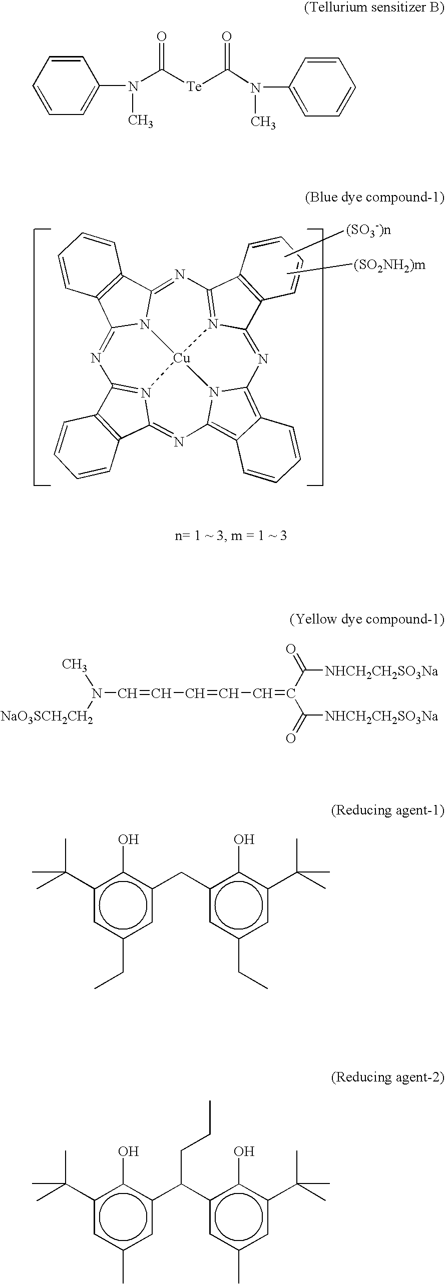

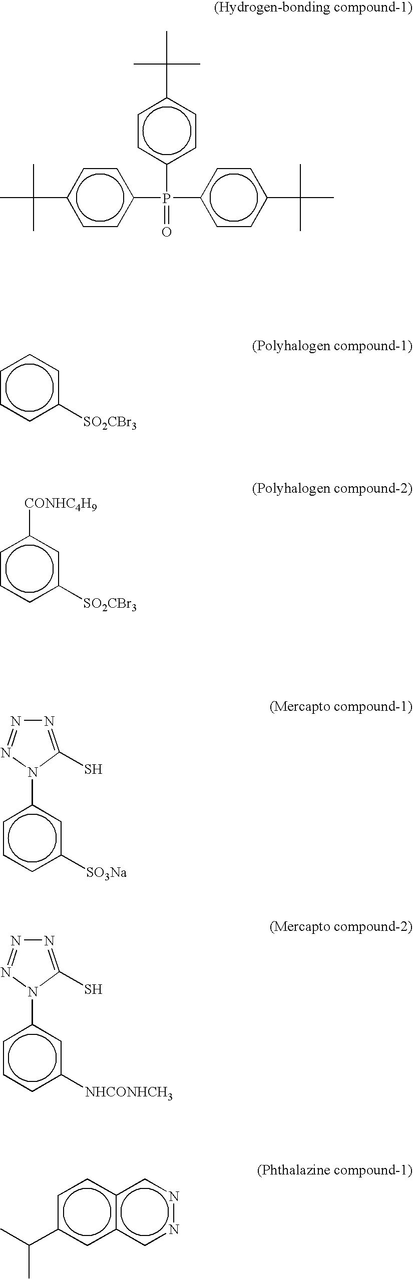

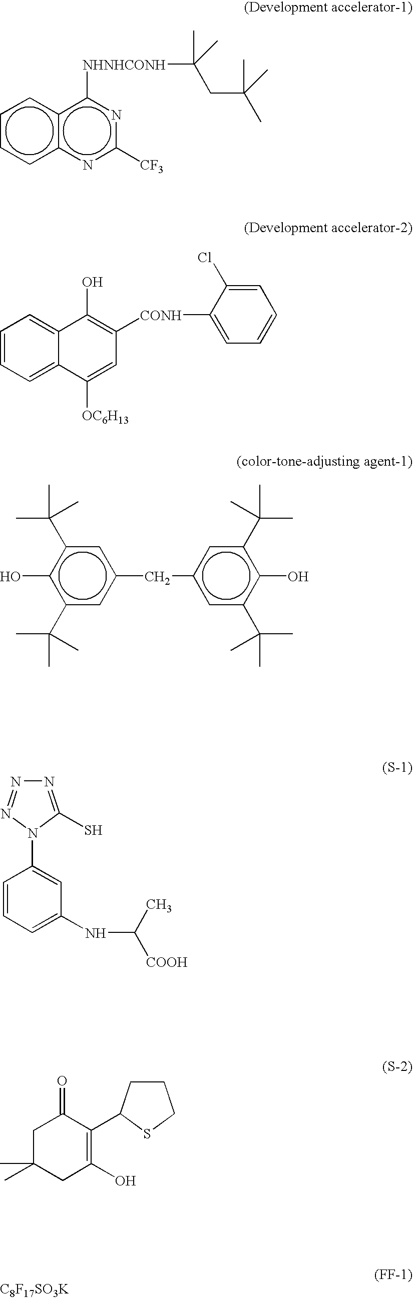

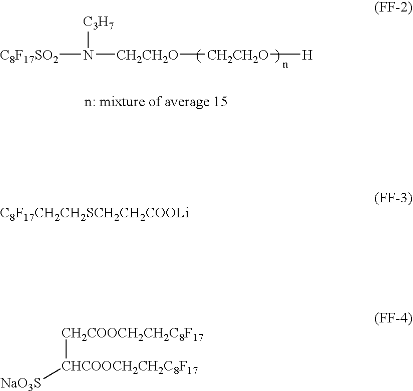

Preparation of Photothermographic Materials 2 to 20

Photothermographic materials 2 to 20 were each fabricated the same way as the photothermographic material-1, except that a fluorine compound listed in Table 2 was added to the surface protective layer-2 and the back-side protective layer in the same amount as the above.

### 4. Evaluation of Photographic Performance

1) Preparation

The resultant samples were each cut in a size of 14×17-in and packaged in the following wrapping material in an environment of 25° C. and 50% RH. The samples were stored at normal temperatures for 2 weeks and subjected to the following evaluation test.

2) Packaging Material

PET: polyethylene film having a thickness of 50 μm and including 10 μm/PE, 12 μm/aluminum foil, 9 μm/Ny, and 15 μm/3 wt % carbon

Oxygen transmittance: 0.02 ml/atm·m²·25° C.·day

Water transmittance: 0.10 g/atm-m²·25° C.·day

3) Light Exposure/Development

The samples were stored for more 7 days under conditions of 25° C.-40% RH, 40° C.-70% RH, or 50° C.-70% RH. A semiconductor laser NLHV 3000E (commercially available from NICHIA CORPORATION) as a semiconductor laser light source was mounted to a light exposure portion of Fuji Medical Dry Laser Imager FM-DP L placed in the environment of 25° C.-55% RH. A laser beam was focused to a size of 100 μm. The samples were subjected to 10⁻⁶-sec exposure with the luminance of the laser beam on the surface of the photosensitive material varied in the range of 0 and between 1 mW/mm² and 1000 mW/mm². The laser beam had an oscillation wavelength of 405 nm. Four panel heaters for thermal development were set to respective temperatures of 112° C., 118° C., 120° C. and 120° C., while a conveyance speed was progressively increased so that the sample was developed in the total length of time of 14 seconds. The resultant images were evaluated by a densitometer.

The conditions of 40° C.-70% RH and 50° C.-70% RH are compulsory for the evaluation of storage stability of photothermographic material products stored during a period of time between fabrication and exposure/development process.

4) Evaluation

A relative sensitivity (ΔS) to a sample stored under the conditions of 25° C.-40% RH was determined.

A sensitivity variation between a sample stored under 40° C.-70% RH and a sample stored under 25° C.-40% RH was defined as a sensity variation ΔS1.

Further, a sensitivity variation between a sample stored under 50° C.-70% RH and a sample stored under 25° C.-40% RH was defined as a sensity variation ΔS2.

The measurement results of ΔS1 and ΔS2 are listed in Table 2.

TABLE 2

| | Fatty | | Sensitivity | | |
|---|---|---|---|---|---|
| Sample | Acid | Fluorine | Variation | | |
| No. | Silver | Compound | ΔS1 | ΔS2 | Note |
| 1 | A | FF-1 | −0.28 | −0.55 | Comparative |
| 2 | A | FF-2 | −0.24 | −0.45 | Comparative |
| 3 | A | FF-3 | −0.30 | −0.58 | Comparative |
| 4 | A | FF-4 | −0.16 | −0.35 | Comparative |
| 5 | A | F-3 | −0.08 | −0.18 | Invention |
| 6 | A | F-17 | −0.04 | −0.08 | Invention |
| 7 | A | F-26 | −0.07 | −0.12 | Invention |
| 8 | A | F-28 | −0.05 | −0.09 | Invention |
| 9 | A | F-29 | −0.02 | −0.05 | Invention |
| 10 | A | F-33 | −0.04 | −0.07 | Invention |
| 11 | A | FS-15 | −0.08 | −0.14 | Invention |
| 12 | A | FS-24 | −0.07 | −0.15 | Invention |
| 13 | A | FS-52 | −0.05 | −0.11 | Invention |
| 14 | A | FN-1 | −0.07 | −0.18 | Invention |
| 15 | A | FN-13 | −0.03 | −0.13 | Invention |
| 16 | A | FN-14 | −0.03 | −0.10 | Invention |
| 17 | A | F-57 | −0.11 | −0.22 | Invention |
| 18 | A | F-61 | −0.08 | −0.18 | Invention |
| 19 | A | FS-69 | −0.10 | −0.24 | Invention |
| 20 | A | FN-21 | −0.09 | −0.20 | Invention |

As apparent from Table 2, the use of the fluorine compound of the present invention results in the reduction of the sensitivity variations ΔS1 and ΔS2 of the photosensitive materials stored under high humidity/high temperature conditions. That is, the samples of the present invention are excellent in the storage stability.

### Example 2

Photothermographic materials 21 to 44 were each fabricated the same way as the photothermographic material-1, except that the organic silver salt and fluorine compound were changed as listed in Table 3.

TABLE 3

| | Organic | | Sensitivity | | |
|---|---|---|---|---|---|
| Sample | Silver | Fluorine | Variation | | |
| No. | Salt | Compound | ΔS1 | ΔS2 | Note |
| 21 | A | FF-1 | −0.18 | −0.34 | Comparative |
| 22 | A | FF-2 | −0.15 | −0.28 | Comparative |
| 23 | A | F-17 | −0.06 | −0.13 | Invention |
| 24 | A | F-28 | −0.08 | −0.15 | Invention |
| 25 | A | F-29 | −0.03 | −0.08 | Invention |
| 26 | A | F-33 | −0.05 | −0.11 | Invention |
| 27 | A | FS-52 | −0.07 | −0.16 | Invention |
| 28 | A | FN-13 | −0.04 | −0.09 | Invention |
| 29 | A | F-57 | −0.09 | −0.16 | Invention |
| 30 | A | F-61 | −0.07 | −0.14 | Invention |
| 31 | A | FS-69 | −0.09 | −0.21 | Invention |
| 32 | A | FN-21 | −0.08 | −0.18 | Invention |
| 33 | B | FF-1 | −0.24 | −0.42 | Comparative |
| 34 | B | FF-2 | −0.19 | −0.38 | Comparative |
| 35 | B | F-17 | −0.05 | −0.11 | Invention |
| 36 | B | F-28 | −0.06 | −0.12 | Invention |
| 37 | B | F-29 | −0.02 | −0.04 | Invention |
| 38 | B | F-33 | −0.03 | −0.06 | Invention |
| 39 | B | FS-52 | −0.05 | −0.09 | Invention |
| 40 | B | FN-13 | −0.03 | −0.07 | Invention |
| 41 | B | F-57 | −0.07 | −0.14 | Invention |
| 42 | B | F-61 | −0.05 | −0.11 | Invention |
| 43 | B | FS-69 | −0.08 | −0.17 | Invention |
| 44 | B | FN-21 | −0.07 | −0.16 | Invention |

These photosensitive materials were also evaluated the same way as those of Example 1.

In this example, as well, the use of the fluorine compound of the present invention results in the reduction of the sensitivity variations ΔS1 and ΔS2 of the photosensitive materials although the compositions of fatty acid are varied. In the case where the content of silver behenate in the organic silver salt is in the range of 80 to 99 mol %, favorable image stability is achieved. In the case where the organic silver salt contains silver behenate within a range of 55 to 85 mol %, good thermal development activity and high speed performance are achieved.

### Example 3

Photothermographic materials 45 to 62 were each fabricated the same way as the photothermographic material-1, except that the organic silver salt and fluorine compound were changed as listed in Table 4 and the reducing agent and antifoggant were changed as listed in Table 4. It is noted that in the photothermographic material using the reducing agent R-1 or R-2, the coated amount of the reducing agent was increased by a factor of 1.35 or 1.25 on a molar basis from that of the photothermographic material-2.

These photosensitive materials were also evaluated the same way as those of Example 1. The results are listed in Table 4.

TABLE 4

| Sam- | Organic | Fluorine | Reduc- | | Sensitivity | | |
|---|---|---|---|---|---|---|---|
| ple | Silver | Com- | ing | Anti- | Variation | | |
| No. | Salt | pound | Agent | foggant | ΔS1 | ΔS2 | Note |
| 45 | B | FF-1 | R-6 | H-1/H-8 | −0.21 | −0.31 | Compara- |
| | | | | | | | tive |
| 46 | B | F-50 | R-6 | H-1/H-8 | −0.10 | −0.19 | Invention |
| 47 | B | FS-51 | R-6 | H-1/H-8 | −0.12 | −0.18 | Invention |
| 48 | B | FN-17 | R-6 | H-1/H-8 | −0.11 | −0.15 | Invention |
| 49 | B | F-61 | R-6 | H-1/H-8 | −0.14 | −0.20 | Invention |
| 50 | B-1 | FF-1 | R-4 | H-1/H-8 | −0.25 | −0.38 | Compara- |
| | | | | | | | tive |
| 51 | B-1 | F-50 | R-4 | H-1/H-8 | −0.11 | −0.18 | Invention |
| 52 | B-1 | FS-51 | R-4 | H-1/H-8 | −0.13 | −0.22 | Invention |
| 53 | B-1 | FN-17 | R-4 | H-1/H-8 | −0.12 | −0.16 | Invention |
| 54 | B-1 | F-61 | R-4 | H-1/H-8 | −0.15 | −0.25 | Invention |
| 55 | B-2 | FF-1 | R-1 | H-3 | −0.29 | −0.40 | Compara- |
| | | | | | | | tive |
| 56 | B-2 | F-50 | R-1 | H-3 | −0.11 | −0.20 | Invention |
| 57 | B-2 | FS-51 | R-1 | H-3 | −0.14 | −0.21 | Invention |
| 58 | B-2 | FN-17 | R-1 | H-3 | −0.12 | −0.18 | Invention |
| 59 | B-2 | F-61 | R-1 | H-3 | −0.16 | −0.22 | Invention |
| 60 | B-2 | FF-1 | R-2 | H-4 | −0.35 | −0.52 | Compara- |
| | | | | | | | tive |
| 61 | B-2 | F-50 | R-2 | H-4 | −0.14 | −0.2S | Invention |
| 62 | B-2 | FS-51 | R-2 | H-4 | −0.16 | −0.31 | Invention |
| 63 | B-2 | FN-17 | R-2 | H-4 | −0.14 | −0.20 | Invention |
| 64 | B-2 | F-61 | R-2 | H-4 | −0.18 | −0.29 | Invention |

In this example, as well, the sensitivity variations ΔS1 and ΔS2 were reduced despite the change of the reducing agent and antifoggant. The use of the bisphenol reducing agent and the antifoggant of the polyhalogen compound represented by the formula (B) contributed favorable results with improvement in the image quality.

What is claimed is:

1. A photothermographic material comprising a photosensitive silver halide, a non-photosensitive organic silver salt, a reducing agent for thermal development, and a binder, and further comprising a fluorine compound containing a fluoroalkyl group having 2 or more carbon atoms and 13 or less fluorine atoms,
wherein the photosensitive silver halide contains silver iodide within a range of 40 mol % to 100 mol %.

2. A photothermographic material comprising a photosensitive silver halide, a non-photosensitive organic silver salt, a reducing agent for thermal development, and a binder, and further comprising a fluorine compound containing a fluoroalkyl group having 2 or more carbon atoms and 12 or less fluorine atoms,
wherein the photosensitive silver halide contains silver iodide within a range of 40 mol % to 100 mol %.

3. A photothermographic material according to claim 2, wherein the fluoroalkyl group of the fluorine compound is represented by the following formula (A):
—Rc—Re—W Formula (A)
wherein Rc represents an alkylene group having 1 to 4 carbon atoms; Re represents a perfluoroalkylene group having 2 to 6 carbon atoms; and W represents a hydrogen atom, a fluorine atom or an alkyl group.

4. A photothermographic material according to claim 3, wherein the fluorine compound contains 2 or more fluoroalkyl groups represented by formula (A).

5. A photothermographic material according to claim 2, wherein the fluorine compound has a cationic hydrophilic group.

6. A photothermographic material according to claim 2, wherein the fluorine compound has an anionic hydrophilic group.

7. A photothermographic material according to claim 2, wherein the fluorine compound has a nonionic hydrophilic group.

8. A photothermographic material according to claim 2, wherein the reducing agent is a bisphenol-based reducing agent.

9. A photothermographic material according to claim 2, further comprising a compound represented by the following formula (D): 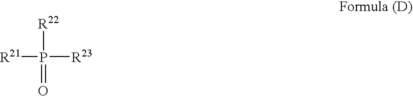
wherein R²¹ to R²³ each independently represent an alkyl group, an aryl group, an alkoxy group, an aryloxy group, an amino group or a heterocyclic group.

10. A photothermographic material according to claim 2, further comprising a compound represented by the following formula (B):
Q—(Y)n—C(Z₁)(Z₂)X Formula (B)
wherein Q represents an alkyl group, an aryl group or a heterocyclic group; Y represents a bivalent coupling group; n represents 0 or 1; Z¹ and Z² each represent a halogen atom; and X represents a hydrogen atom or an electron-attracting group.

11. A photothermographic material according to claim 2, further comprising a hydrazine-based or naphthol-based development accelerator.

12. A photothermographic material according to claim 2, wherein the non-photosensitive organic silver salt includes 40 mol % to 99 mol % of silver behenate.

13. A photothermographic material according to claim 3, wherein the fluorine compound is a compound represented by the following formula (1): 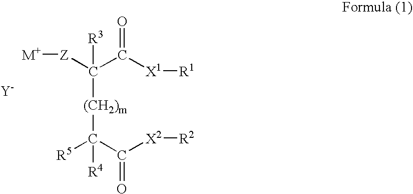
wherein R¹ and R² each independently represent an alkyl group; at least one of R¹ and R² is a fluoroalkyl group having 2 or more carbon atoms and 12 or less fluorine atoms or a fluoroalkyl group represented by formula (A); R³, R⁴ and R⁵ each independently represent a hydrogen atom or a substituent; X¹, X² and Z each independently represent a bivalent coupling group or a single bond; M⁺ represents a cationic substituent; Y⁻ represents a counter anion; and m represents 0 or 1.

14. A photothermographic material according to claim 3, wherein the fluorine compound is a compound represented by the following formula (1-a): 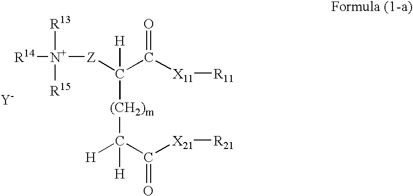
wherein R¹¹ and R¹² each independently represent an alkyl group; at least one of R¹¹ and R¹² is a fluoroalkyl group having 2 or more carbon atoms and 12 or less fluorine atoms or a fluoroalkyl group represented by formula (A); a total number of carbon atoms in R¹¹ and R²¹ is 19 or less; R¹³, R¹⁴ and R¹⁵ each independently represent an alkyl group; X¹¹ and X²¹ each independently represent —O—, —S—, or —NR³¹— in which R⁻represents a hydrogen atom or a substituent; Z represents a bivalent coupling group or a single bond; Y⁻ represents a counter anion; and m represents 0 or 1.

15. A photothermographic material according to claim 3, wherein the fluorine compound is a compound represented by the following formula (3): 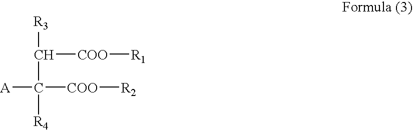
wherein R¹ and R² each independently represent an alkyl group; at least one of R¹ and R² is a fluoroalkyl group having 2 or more carbon atoms and 12 or less fluorine atoms or a fluoroalkyl group represented by the formula (A); R³ and R4 each independently represent a hydrogen atom or an alkyl group; and A represents —L_{b}—SO₃M in which M represents a hydrogen atom or a cation and L^{b} represents a single bond or an alkylene group.

16. A photothermographic material according to claim 3, wherein the fluorine compound is a compound represented by the following formula (4):
Rf—X((CH₂)ₙ—Oₘ(R Formula (4)
wherein Rf represents a fluoroalkyl group having 2 or more carbon atoms and 12 or less fluorine atoms or a fluoroalkyl group represented by formula (A); n represents 2 or 3; m represents 1 to 30; X represents a bivalent coupling group; R represents a hydrogen atom, an aryl group, a heterocyclic group, Rf, or a group having 1 or more of Rf as a substituent.

17. A photothermographic material according to claim 2, wherein the photosensitive silver halide is chemically sensitized by at least one selected from the group consisting of chalcogen sensitization, gold sensitization and reduction sensitization.

18. A photothermographic material according to claim 2, wherein the photosensitive silver halide contains silver iodide within a range of 80 mol % to 100 mol %.

19. A photothermographic material according to claim 2, wherein particles of the photosensitive silver halide have an epitaxially grown portion.

20. A photothermographic material according to claim 2, wherein a particle size of the photosensitive silver halide is 5 nm to 70 nm.

21. A photothermographic material according to claim 2, wherein particles of the photosensitive silver halide are formed in the absence of the organic silver salt.
